(19) United States
(12) Patent Application Publication
(10) Pub. No.: US 2023/0360627 A1
(43) Pub. Date: Nov. 9, 2023

(54) ACTIVE NOISE CONTROL SYSTEM

(71) Applicants: NITTO DENKO CORPORATION, Ibaraki-shi, Osaka (JP); THE SCHOOL CORPORATION KANSAI UNIVERSITY, Suita-shi, Osaka (JP)

(72) Inventors: Kohei OTO, Osaka (JP); Yusuke KOMOTO, Osaka (JP); Yoshinobu KAJIKAWA, Osaka (JP); Yusuke MAKIYAMA, Osaka (JP)

(21) Appl. No.: 18/245,287

(22) PCT Filed: Aug. 5, 2021
(86) PCT No.: PCT/JP2021/029238

§ 371 Date: Mar. 14, 2023

(30) Foreign Application Priority Data
Sep. 14, 2020 (JP) 2020-153725

(51) Int. Cl. G10K 11/178; H04R 17/00; H04R 1/02

(52) U.S. Cl. CPC G10K 11/17825; H04R 17/00; G10K 11/17881; H04R 1/025; G10K 2210/3046; G10K 2210/3044; G10K 2210/3026; G10K 2210/3028; G10K 2210/3027

(57) ABSTRACT

An active noise control system (500) includes a structure (80) and a plurality of piezoelectric speakers (10). The piezoelectric speakers (10) are disposed on a surface (80s) of the structure (80). The piezoelectric speakers (10) each have a radiation surface extending along a first direction (D1) and a second direction (D2). The first direction (D1) is a direction along which centers of the radiation surfaces of the piezoelectric speakers (10) are arranged so that the piezoelectric speakers (10) are adjacent to each other. The second direction (D2) is a direction orthogonal to the first direction (D1). The radiation surface of each of the piezoelectric speakers (10) is shorter in a dimension (L1) in the first direction (D1) than in a dimension (L2) in the second direction (D2).

### TECHNICAL FIELD

The present invention relates to an active noise control system.

### BACKGROUND ART

An active noise control system (hereinafter, referred to also as an ANC system) is known. In the ANC system, noise is reduced by opposite-phase sound. Patent Literature 1 describes an example of the ANC system.

### CITATION LIST

### Patent Literature

Patent Literature 1: WO 2019/103017 A1
Patent Literature 2: JP 2016-122187 A

### SUMMARY OF THE INVENTION

### Technical Problem

In the ANC system of Patent Literature 1, a plurality of piezoelectric speakers are attached to a partition. However, the technique of Patent Literature 1 has room for improvement in generating an increased region where sound can be reduced.

### Solution to Problem

The present invention provides an active noise control system including:
a structure; and
a plurality of piezoelectric speakers disposed on a surface of the structure, wherein
the piezoelectric speakers each have a radiation surface extending along a first direction and a second direction orthogonal to the first direction, the first direction being a direction along which centers of the radiation surfaces of the piezoelectric speakers are arranged so that the piezoelectric speakers are adjacent to each other, and
the radiation surface of each of the piezoelectric speakers is shorter in a dimension in the first direction than in a dimension in the second direction.

### Advantageous Effects of Invention

The above active noise control system is suitable for generating an increased region where sound can be reduced.

### BRIEF DESCRIPTION OF THE DRAWINGS

FIG. 1A is a top view of an ANC system.

FIG. 1B is a side view of the ANC system.

FIG. 1C is a front view of the ANC system.

FIG. 1D is a perspective view of the ANC system.

FIG. 1E is an enlarged view for illustrating the positions of radiation surfaces of piezoelectric speakers of the ANC system.

FIG. 1F is a diagram for illustrating the relationship between sound reduction and the interval between the centers of the radiation surfaces of the adjacent piezoelectric speakers.

FIG. 1G is an enlarged view for illustrating the dimensions of the radiation surfaces of the piezoelectric speakers of the ANC system.

FIG. 1H is an enlarged view for illustrating another example of the shape of the radiation surfaces of the piezoelectric speakers of the ANC system.

FIG. 1I is an enlarged view for illustrating regions of the radiation surfaces of the piezoelectric speakers of the ANC system.

FIG. 2A is a top view for illustrating diffracted waves.

FIG. 2B is a side view for illustrating the diffracted waves.

FIG. 2C is a perspective view for illustrating the diffracted waves.

FIG. 3A is a top view for illustrating wave fronts formed by the piezoelectric speakers of the ANC system.

FIG. 3B is a side view for illustrating the wave fronts formed by the piezoelectric speakers of the ANC system.

FIG. 3C is a perspective view for illustrating the wave fronts formed by the piezoelectric speakers of the ANC system.

FIG. 4 is a diagram illustrating a wave front formed by a conventional dynamic speaker.

FIG. 5 is a diagram illustrating a wave front formed by a conventional plane speaker.

FIG. 6A is a diagram illustrating vibration of the radiation surface of the piezoelectric speaker.

FIG. 6B is a diagram illustrating a supporting structure for a piezoelectric film.

FIG. 7 is a diagram illustrating the ANC system.

FIG. 8 is a diagram schematically illustrating a sound reducing effect.

FIG. 9 is a cross-sectional view taken along a section parallel to the thickness direction of a piezoelectric speaker.

FIG. 10 is a top view of the piezoelectric speaker when viewed from the opposite side to a fixing surface.

FIG. 11 shows a piezoelectric speaker according to another structure example.

FIG. 12 is a view for illustrating the structure of a produced sample.

FIG. 13 is a view for illustrating a sample measurement structure.

FIG. 14 is a view for illustrating a sample measurement structure.

FIG. 15 is a block diagram of an output system.

FIG. 16 is a block diagram of an evaluation system.

FIG. 17A is a table showing evaluation results of samples.

FIG. 17B is a table showing evaluation results of samples.

FIG. 18 is a graph showing the relationship between the holding degree of an interposed layer and the frequency at which emission of sound starts.

FIG. 19 is a graph showing the frequency characteristics of Sample E1 in terms of sound pressure level.

FIG. 20 is a graph showing the frequency characteristics of Sample E2 in terms of sound pressure level.

FIG. 21 is a graph showing the frequency characteristics of Sample R1 in terms of sound pressure level.

FIG. 22 is a graph showing the frequency characteristics of background noise in terms of sound pressure level.

FIG. 23 is a configuration diagram of a reference ANC evaluation system.

FIG. 24 is a diagram showing a sound pressure distribution at a speaker OFF time.

FIG. 25 is a diagram showing propagation of the wave front at the speaker OFF times.

FIG. 26 is a diagram showing a sound pressure distribution at a speaker OFF time.

FIG. 27 is a diagram showing propagation of the wave front at the speaker OFF times.

FIG. 28 is a diagram showing a sound pressure distribution derived from the piezoelectric speaker.

FIG. 29 is a diagram showing propagation of a wave front derived from the piezoelectric speaker.

FIG. 30 is a diagram showing a sound pressure distribution derived from the piezoelectric speaker.

FIG. 31 is a diagram showing propagation of a wave front derived from the piezoelectric speaker.

FIG. 32 is a diagram showing a sound pressure distribution derived from a dynamic speaker.

FIG. 33 is a diagram showing propagation of a wave front derived from the dynamic speaker.

FIG. 34 is a diagram showing a sound pressure distribution derived from the dynamic speaker.

FIG. 35 is a diagram showing propagation of a wave front derived from the dynamic speaker.

FIG. 36 is a diagram showing a sound pressure distribution derived from a plane speaker.

FIG. 37 is a diagram showing propagation of a wave front derived from the plane speaker.

FIG. 38 is a diagram showing a sound pressure distribution derived from the plane speaker.

FIG. 39 is a diagram showing propagation of a wave front derived from the plane speaker.

FIG. 40A is diagram illustrating the sound reducing effect.

FIG. 40B is diagram illustrating the sound reducing effect.

FIG. 40C is diagram illustrating the sound reducing effect.

FIG. 41A is diagram illustrating the sound reducing effect.

FIG. 41B is diagram illustrating the sound reducing effect.

FIG. 41C is diagram illustrating the sound reducing effect.

FIG. 42A is a configuration diagram of an ANC evaluation system.

FIG. 42B is a top view for illustrating the positions of the piezoelectric speakers.

FIG. 42C is a side view for illustrating the positions of the piezoelectric speakers.

FIG. 42D is a front view for illustrating the positions of the piezoelectric speakers.

FIG. 42E is a perspective view for illustrating the positions of the piezoelectric speakers.

FIG. 42F is a diagram illustrating a measurement horizontal cross section and a measurement sagittal cross section.

FIG. 43A is diagram illustrating the sound reducing effect.

FIG. 43B is diagram illustrating the sound reducing effect.

FIG. 44A is diagram illustrating the sound reducing effect.

FIG. 44B is diagram illustrating the sound reducing effect.

FIG. 45A is diagram illustrating the sound reducing effect.

FIG. 45B is diagram illustrating the sound reducing effect.

FIG. 46A is diagram illustrating the sound reducing effect.

FIG. 46B is diagram illustrating the sound reducing effect.

### DESCRIPTION OF EMBODIMENT

An embodiment of the present invention will be described below with reference to the accompanying drawings. The following description is only illustrative of the embodiment of the present invention and has no intention to limit the present invention. In the following description, the terms such as “up”, “down”, “left”, “right”, “height”, and the like are used to designate the positions of the elements relative to each other, and are not intended to limit the posture of these elements in use of the ANC system. Further, in the following description, the same or similar components are denoted by the same reference numerals, and the description thereof may be omitted.

[Active Noise Control System]

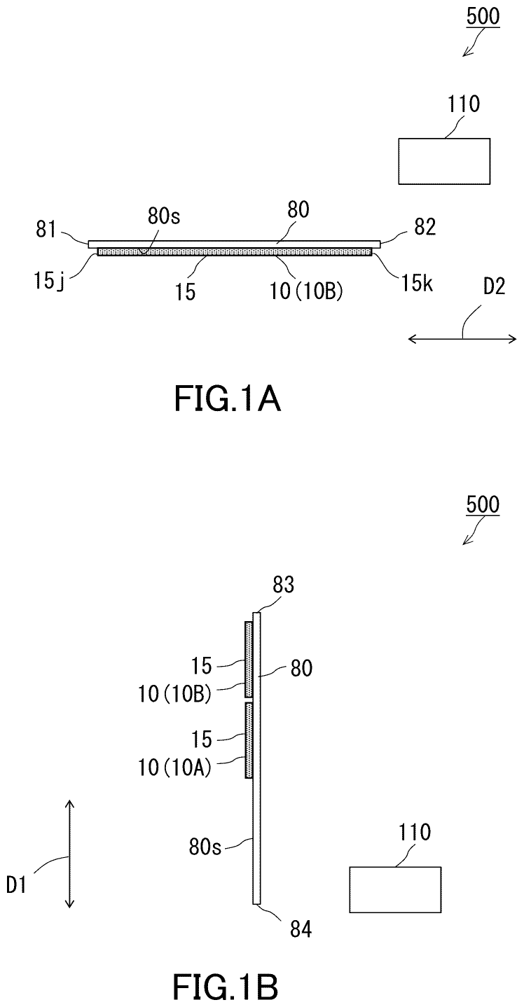

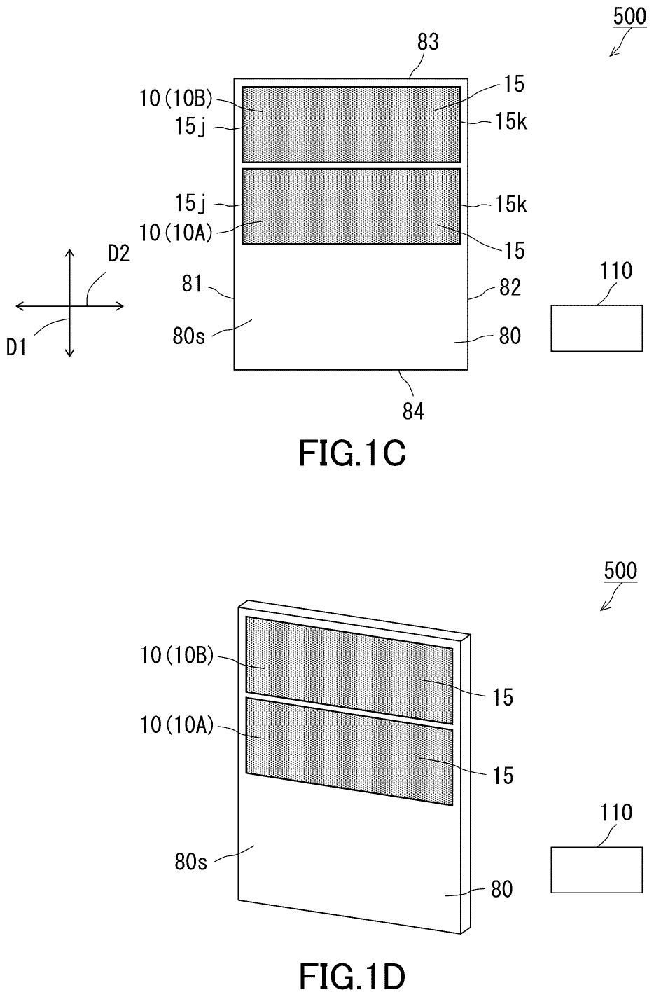

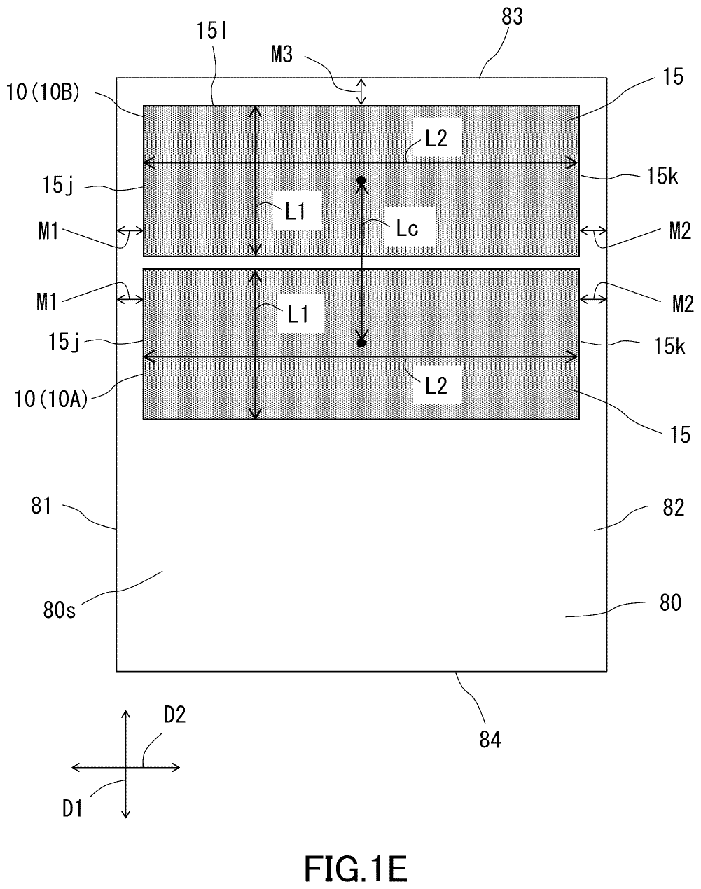

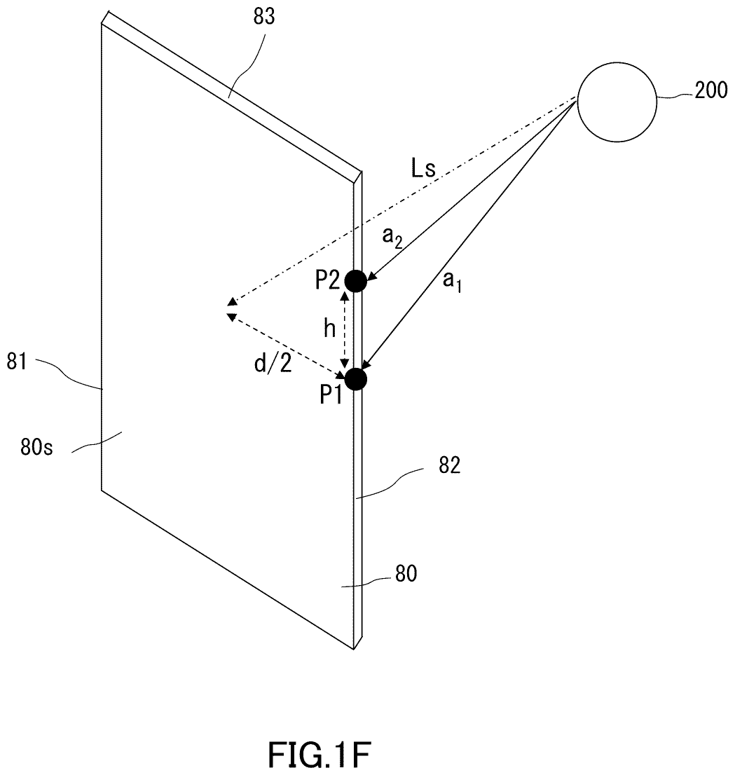

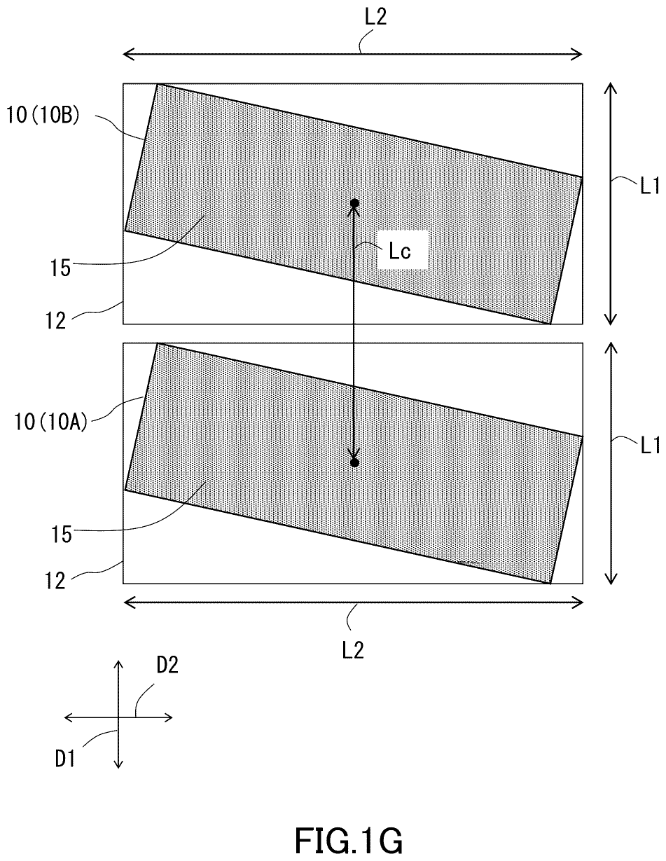

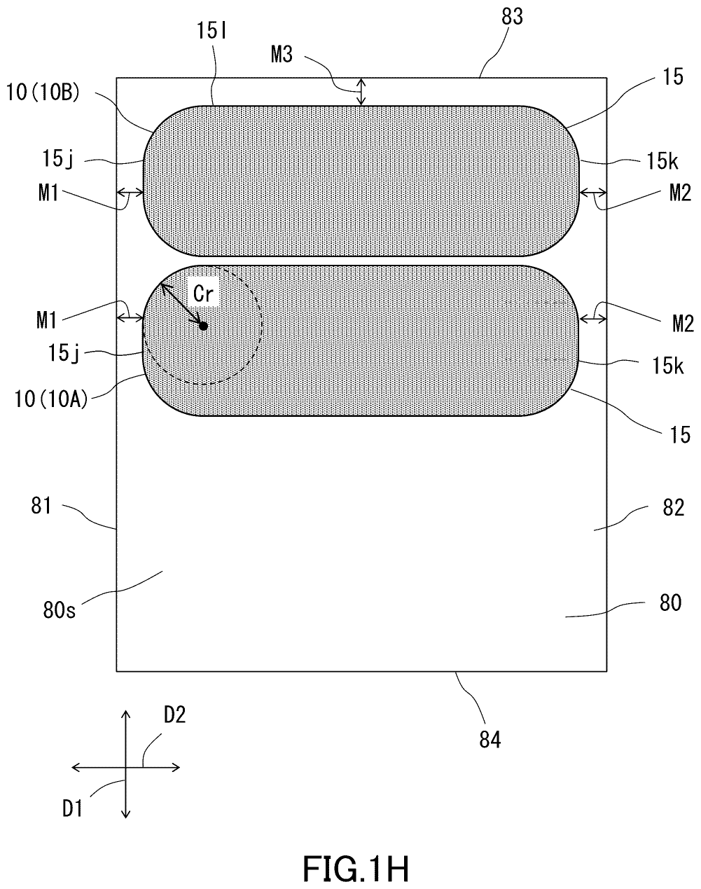

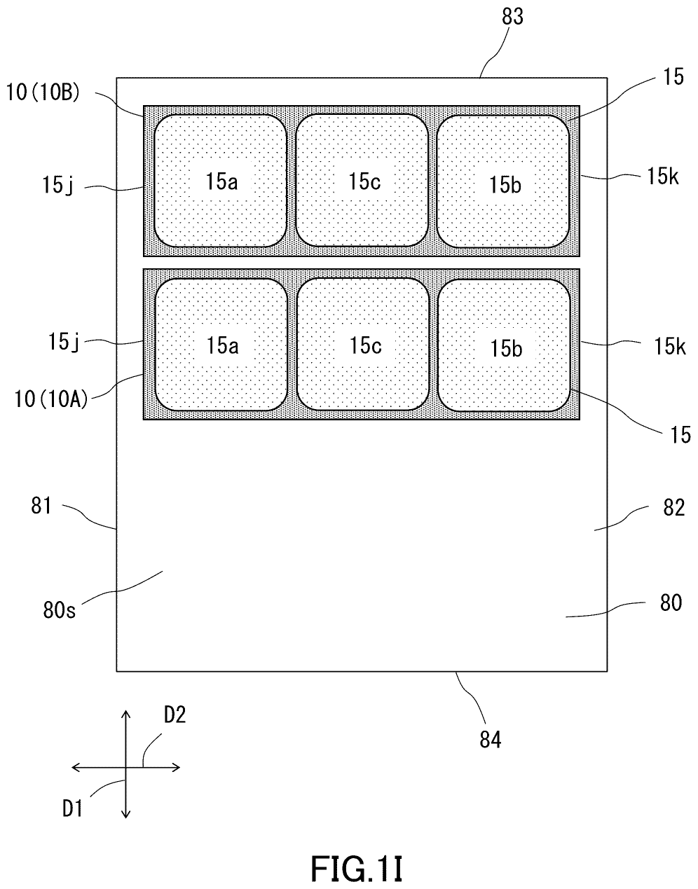

As shown in FIG. 1A to FIG. 1I, an active noise control system (ANC system) 500 includes a structure 80 and a plurality of piezoelectric speakers 10. The piezoelectric speakers 10 are disposed on a surface 80s of the structure 80. In the present embodiment, the piezoelectric speakers 10 include a first piezoelectric speaker 10A and a second piezoelectric speaker 10B.

In the present embodiment, the structure 80 is a plate-like body. The structure 80, which is a plate-like body, has, for example, a dimension of 20 cm to 400 cm (20 cm to 200 cm in a specific example) in the up-down direction, a dimension of 25 cm to 200 cm (50 cm to 120 cm in a specific example) in the right-left direction, and a dimension of 0.1 cm to 15 cm in the thickness direction. Here, the up-down direction, the right-left direction, and the thickness direction are orthogonal to each other. The dimension in the up-down direction and the dimension in the right-left direction may be the same or different from each other.

In the present embodiment, the structure 80 is a partition.

The piezoelectric speakers 10 each have a radiation surface 15. The radiation surface 15 radiates a sound wave by vibrating. This sound wave reduces noise. In the present embodiment, the radiation surface 15 is a continuous radiation surface.

The structure 80 has a left end portion 81, a right end portion 82, an upper end portion 83, and a lower end portion 84. The left end portion 81 and the right end portion 82 face each other in the right-left direction. The upper end portion 83 and the lower end portion 84 face each other in the up-down direction. In the illustrated example, the lower end portion 84 is an end portion in contact with the floor.

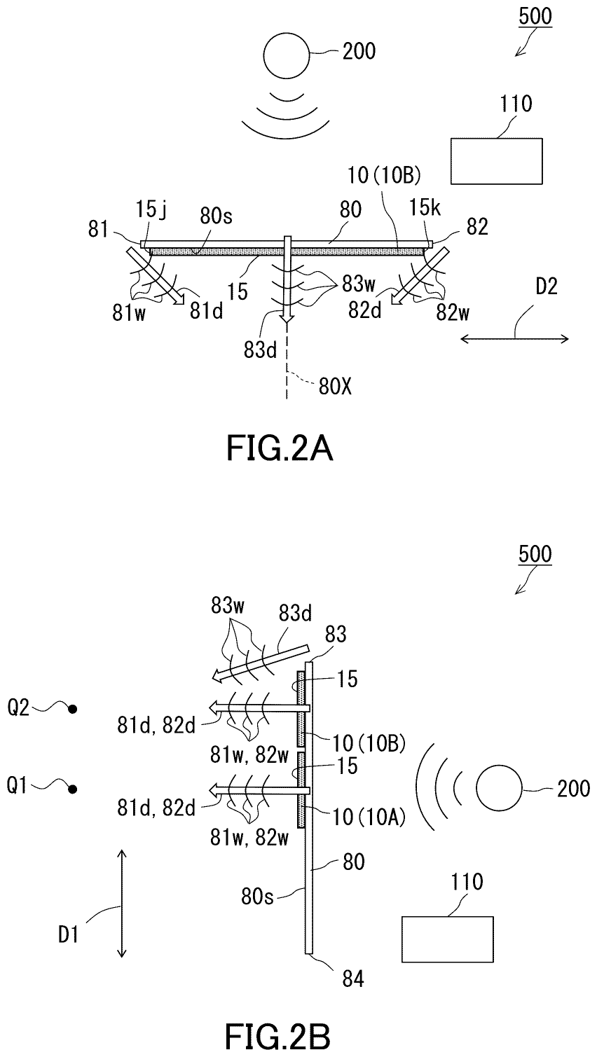

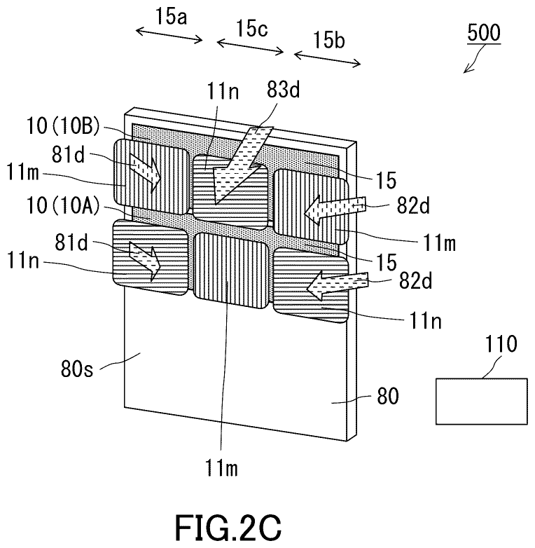

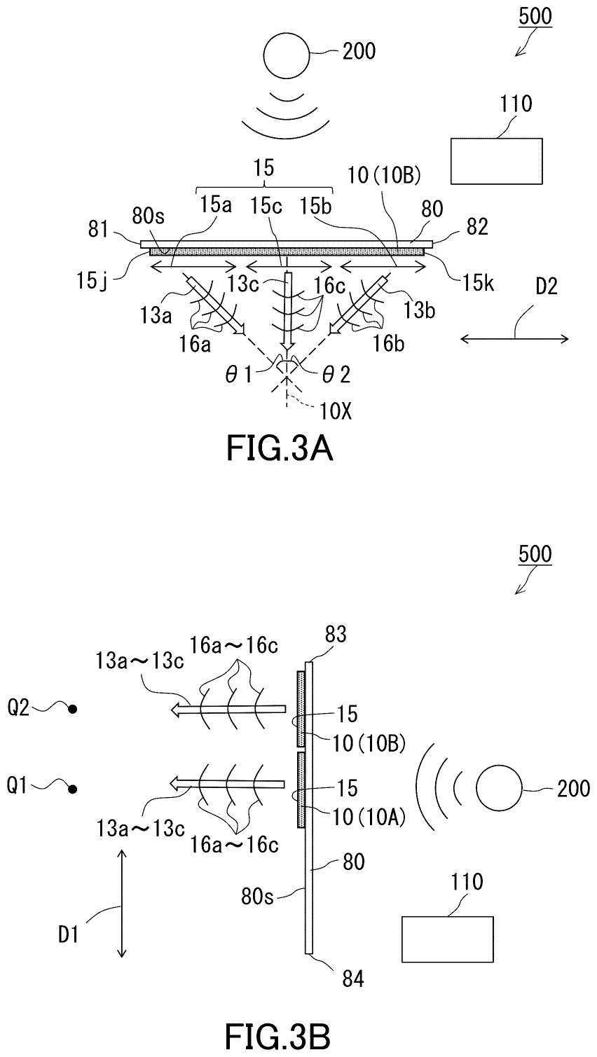

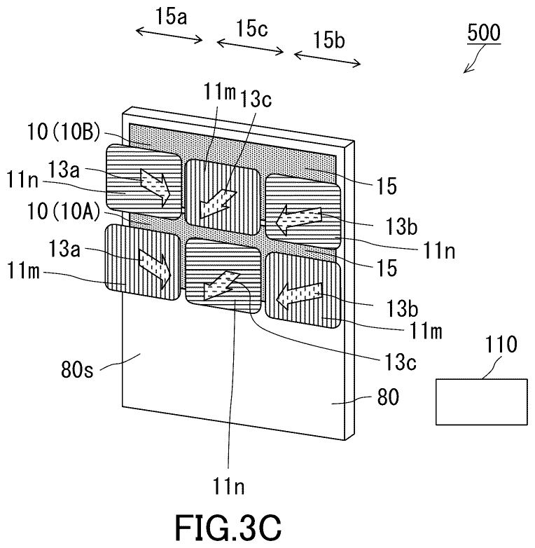

The ANC system 500 is suitable for reducing diffracted sound generated at the ends 81, 82, and 83. This point will be described below with reference to FIG. 2A to FIG. 3C. It should be noted that, in the following description, a wave front refers to a surface composed of linked points having the same wave phase.

In FIG. 2A and FIG. 2B, reference numeral 200 represents a noise source. The distance between the noise source 200 and the structure 80 in the thickness direction of the structure 80 is, for example, 0.3 to 5 m. Further, the height of the noise source 200 is, for example, 0 to 4 m. In this context, the height refers to the position in the up-down direction.

As shown in FIG. 2A and FIG. 2B, noise from the noise source 200 is assumed to have propagated toward the structure 80. In this case, diffraction may occur at the left end portion 81 and the right end portion 82. Wave fronts generated by diffraction at the end portions 81 and 82 propagate so as to go around behind the structure 80.

With respect to this point, the ANC system 500 is suitable for reducing diffracted sound generated in this manner at the end portions 81 and 82. This is because the number of the piezoelectric speakers 10 in the ANC system 500 is more than one and this can contribute to generation of an increased region where sound can be reduced.

As shown in FIG. 1E, an interval Lc between the centers of the radiation surfaces 15 of the adjacent piezoelectric speakers 10 is, for example, 160 mm to 3760 mm. Setting the interval Lc to 160 mm to 3760 mm is suitable for generating an increased region where sound can be reduced.

The interval Lc may be 2610 mm or less, 660 mm or less, 590 mm or less, 430 mm or less, or 380 mm or less. The interval Lc may be 200 mm or more.

Specifically, the number of the piezoelectric speakers 10 being more than one and the interval Lc being 160 mm to 3760 mm are suitable for generating an increased region in a direction along the interval Lc where sound can be reduced. Accordingly, for example, even when a person behind the structure 80 changes his posture, the sound reducing effect perceived by the person hardly changes.

Here, a detailed description will be given of the expression that the interval Lc between the centers of the radiation surfaces 15 of the adjacent piezoelectric speakers 10 is 160 mm to 3760 mm. This expression means that the following relationship holds for the piezoelectric speakers 10 referred to in the expression, where the relationship is that the distance between the geometric center of the radiation surface 15 of a certain piezoelectric speaker 10 and the geometric center of the radiation surface 15 of a piezoelectric speaker 10 adjacent to the certain piezoelectric speaker 10 is 160 mm to 3760 mm.

Further, the above expression is intended to allow variation in the interval Lc for the case where the number of the piezoelectric speakers 10 referred to in the expression is three or more. Specifically, for the case where the piezoelectric speakers 10 include a second piezoelectric speaker, a first piezoelectric speaker, and a third piezoelectric speaker in this order, the interval Lc between the center of the radiation surface of the second piezoelectric speaker and the center of the radiation surface of the first piezoelectric speaker is referred to as a first interval, and the interval Lc between the center of the radiation surface of the first piezoelectric speaker and the center of the radiation surface of the third piezoelectric speaker is referred to as a second interval. In this case, the above expression means that the first interval and the second interval are each 160 mm to 3760 mm, and means that the first interval and the second interval may be the same or different from each other. An embodiment in which the first interval and the second interval are the same can facilitate the design of the sound reducing system 500. An embodiment in which the first interval and the second interval are different from each other can increase the design flexibility of the sound reducing system 500.

A specific description will be given of the relationship between the interval Lc and the noise reduction with reference to FIG. 1F. In the following description, the “height” refers to the position in the up-down direction. The quantitative description with reference to FIG. 1F is illustrative and should not be used in a limited interpretation of the ANC system 500.

The following considers, in the example in FIG. 1F, a point P1 and a point P2 that are included in the right end portion 82 of the structure 80 and have a height difference h therebetween. A distance a₁ from the noise source 200 to the point P1 and a distance a₂ from the noise source 200 to the point P2 are different from each other. Owing to the difference between the distance a₁ and the distance a₂, the point P1 and the point P2 are different from each other in terms of phase of noise derived from the noise source 200. The height of the point P1 is equal to the height of the noise source 200. The center position of the structure 80 in the right-left direction is the same as the center position of the noise source 200 in the right-left direction. In FIG. 1F, d represents the dimension of the structure 80 in the right-left direction, and Ls represents the distance between the structure 80 and the noise source 200 in the thickness direction of the structure 80.

Here, only one piezoelectric speaker 10 is assumed to be disposed on the surface 80s of the structure 80 so that the point P1 is the center of the radiation surface 15 in terms of position in the up-down direction, namely, in terms of height. In this way, good sound reduction can be achieved in a region behind the structure 80 where the height is equal to the height of the point P1. However, it is sometimes difficult to achieve good sound reduction in a region behind the structure 80 where the height is equal to the height of the point P2. This is because, as described above, the point P2 is different from the point P1 in terms of phase of noise derived from the noise source 200, and this phase difference is shown also in the regions behind the structure 80. In particular, under the condition that this phase difference is 180°, the above difficulty is likely to be significant. This problem can occur not only by diffraction of noise at the right end portion 82 of the structure 80 but also by diffraction of noise at the left end portion 81 of the structure 80.

With respect to this point, in the present embodiment, the number of the piezoelectric speakers 10 disposed on the surface 80s of the structure 80 is not one but more than one. Accordingly, even with the above phase difference of 180°, good sound reduction can be achieved not only in the region behind the structure 80 where the height is equal to the height of the point P1 but also in the region behind the structure 80 where the height is equal to the height of the point P2. In a specific example, the first piezoelectric speaker 10A is disposed on the surface 80s of the structure 80 so that its radiation surface 15 has a center height that is equal to the height of the point P1, and the first piezoelectric speaker 10A is caused to perform sound reduction in the region behind the structure 80 where the height is equal to the height of the point P1. Further, the second piezoelectric speaker 10B is disposed on the surface 80s of the structure 80 so that its radiation surface 15 has a center height that is equal to the height of the point P2, and the second piezoelectric speaker 10B is caused to perform sound reduction in the region behind the structure 80 where the height is equal to the height of the point P2. Thus, good sound reduction can be achieved both in the region behind the structure 80 where the height is equal to the height of the point P1 and in the region behind the structure 80 where the height is equal to the height of the point P2.

A description will be given of numerical examples for the ANC system 500 that can achieve good sound reduction with reference to FIG. 1F.

In the example in FIG. 1F, the noise source 200 emits noise having a frequency of 50 to 3000 Hz. The ANC system 500 is configured to emit a sound wave for sound reduction for the band of 50 to 3000 Hz. The structure 80 is a plate-like body. A dimension d of the structure 80 in the right-left direction is 0.25 m. A distance Ls between the noise source 200 and the structure 80 in the thickness direction of the structure 80 is 0.3 m.

The distance a₁ is calculated by the following Mathematical Equation 1.

a₁=\sqrt{Lₛ²+(d/2)²} Equation 1

The distance a₂ is calculated by the following Mathematical Equation 2.

a₂=\sqrt{Lₛ²+(d/2)²+h²} Equation 2

The dimension d, the distance a₁, and the distance a₂ satisfy the relationship of Mathematical Equation 3.

a₂=\sqrt{a₁²+h²} Equation 3

The following Mathematical Equation 4 holds true. In Mathematical Equation 4, φ is the difference between the phase at the point P1 and the phase at the point P2 of noise derived from the noise source 200 as of the same time, and λ is the wavelength of the noise derived from the noise source 200.

ϕ=360×(a₂−a₁)/λ Equation 4

The member (a₁²+h²)^{1/2} of Mathematical Equation 3 is substituted for a₂ of Mathematical Equation 4, and the resultant mathematical equation is transformed to obtain the following Mathematical Equation 5.

$$h = \sqrt{{( \frac{ϕ λ}{360} )}^{2} + \frac{ϕ λ}{180} {a}_{1}} \qquad Equation 5$$

The phase difference φ=180° is substituted into Mathematical Equation 5 to obtain the following Mathematical Equation 6.

h=\sqrt{a₁λ+λ²/4} Equation 6

The phase difference φ=120° is substituted into Mathematical Equation 5 to obtain the following Mathematical Equation 7.

$$h = \sqrt{\frac{2 λ}{3} {a}_{1} + {( \frac{λ}{3} )}^{2}} \qquad Equation 7$$

A speed V, a frequency F, and the wavelength A of noise derived from the noise source 200 satisfy the relationship of Mathematical Equation 8.

λ=V/F Equation 8

For the distance Ls of 0.3 m and the dimension d of 0.25 m in the right-left direction of the structure 80, the distance a₁ is obtained as 0.33 m by Mathematical Equation 1.

When the speed V of the noise is approximated to 345 m/sec, the wavelength A of the noise is obtained as 0.115 m for the frequency F of the noise of 3000 Hz by Mathematical Equation 8. The distance a₁=0.33 m and the wavelength λ=0.115 m are substituted into Mathematical Equation 6 to obtain the height difference h as 0.20 m for the frequency F=3000 Hz and the phase difference φ=180°.

Further, when the speed V is approximated to 345 m/sec, the wavelength A of the noise is obtained as 6.9 m for the frequency F of the noise of 50 Hz by Mathematical Equation 8. The distance a₁=0.33 m and the wavelength λ=6.9 m are substituted into Mathematical Equation 6 to obtain the height difference h as 3.76 m for the frequency F=50 Hz and the phase difference φ=180°.

A consideration is conducted, for the distance Ls of 0.3 m and the dimension d of 0.25 m, on setting the center position of the radiation surface of the first piezoelectric speaker 10A to the point P1 and setting the center position of the radiation surface of the second piezoelectric speaker 10B to the point P2. A further consideration is conducted on setting the interval Lc between the centers of the radiation surfaces of the piezoelectric speakers 10A and 10B on the basis of the height difference h obtained by the above calculation. In this case, the following can be said.
(x1) Setting the interval Lc to 3.76 m or less makes it difficult to generate, within a region behind the structure 80 where the height is larger than that of the point P1 and smaller than that of the point P2, a region where diffracted sound of noise having the frequency F of 50 Hz is difficult to reduce.
(y1) Setting the interval Lc to 0.20 m or more makes it easy to reduce diffracted sound of noise having the frequency F of 50 to 3000 Hz while avoiding an unnecessary decrease of the interval Lc. This is advantageous in view of generating a large region where sound can be reduced.

In the above description, the numerical value for the phase difference φ=180° has been discussed. In view of reducing diffracted sound of noise, discussing the numerical value for the phase difference φ=120° is also beneficial. This is because of the following. In the case where only one piezoelectric speaker 10 is disposed on the surface 80s of the structure 80 so that the point P1 is the center of the radiation surface 15 in terms of height, it can be difficult to achieve good sound reduction in the region behind the structure 80 where the height is equal to the height of the point P2 even under the condition of the phase difference φ=120°.

The distance a₁=0.33 m and the wavelength λ=0.115 m are substituted into Mathematical Equation 7 to obtain the height difference h as 0.16 m for the frequency F=3000 Hz and the phase difference φ=120°. The distance a₁=0.33 m and the wavelength λ=6.9 m are substituted into Mathematical Equation 7 to obtain the height difference h as 2.61 m for the frequency F=50 Hz and the phase difference φ=120°.

As in the items (x1) and (y1) based on the phase difference φ=180°, the following can be said from the above numerical values obtained on the basis of the phase difference φ=120°.
(x2) Setting the interval Lc to 2.61 m or less makes it difficult to generate, within a region behind the structure 80 where the height is larger than the point P1 and smaller than that of the point P2, a region where diffracted sound of noise having the frequency F of 50 Hz is difficult to reduce.
(y2) Setting the interval Lc to 0.16 m or more makes it easy to reduce diffracted sound of noise having the frequency F of 50 to 3000 Hz while avoiding an unnecessary decrease of the interval Lc. This is advantageous in view of generating a large region where sound can be reduced.

With respect to the items (x1) and (x2), 50 Hz belongs to a low frequency domain in the human audible range. Accordingly, by setting the upper limit for the interval Lc to 3.76 m or 2.61 m, it is easy to reduce, in a region behind the structure 80 higher than the point P1 and lower than the point P2, at least noise of the low frequency domain in the human audible range.

In the above calculation, the condition of a₁=0.33 m is used to calculate upper limits, 3.76 m and 2.61 m. When the condition of a₁>0.33 m is adopted, a larger upper limit is calculated. This means that not only in the case of a₁=0.33 m but also in the case of a₁>0.33 m, by setting the upper limit for the interval Lc to 3.76 m or 2.61 m, the above effect of easily reducing noise of the low frequency domain in the human audible range is achieved. For example, for the distance Ls of 5 m and the dimension d of 2 m, the distance a₁ is obtained as 5.10 m by Mathematical Equation 1. The above effect is also achieved in this case by setting the upper limit for the interval Lc to 3.76 m or 2.61 m.

Good sound reduction for noise of a higher frequency domain in the audible range may also be desired. In that case, it is conceivable to further decrease the interval Lc. However, excessively decreasing the interval Lc makes it difficult to generate a large region where sound can be reduced. Accordingly, as in the items (y1) and (y2), it is beneficial to set the lower limit for the interval Lc to 0.16 m or 0.20 m.

In fact, in the case where good reduction is desired for even noise having a frequency higher than 50 Hz, it is possible to set the interval Lc in consideration of the frequency. For example, the ANC system 500 is sometimes desired to exercise its capability not maximally but only partially in consideration of the scale, calculation load, and the like of the ANC system 500. In that case, in consideration of the capability to be exerted, it is possible to select the frequency band of noise to be reduced and set the interval Lc on the basis of the frequency band.

For example, when the speed V of the noise is approximated to 345 m/sec, the wavelength λ of the noise is obtained as 0.69 m for the frequency F of the noise of 500 Hz by Mathematical Equation 8. The distance a₁=0.33 m and the wavelength λ=0.69 m are substituted into Mathematical Equation 6 to obtain the height difference h as 0.59 m for the frequency F=500 Hz and the phase difference φ=180°. Setting the interval Lc to 0.59 m or less makes it difficult to generate, within a region behind the structure 80 where the height is larger than that of the point P1 and smaller than that of the point P2, a region where diffracted sound of noise having the frequency F of 50 to 500 Hz is difficult to reduce.

In addition, when the speed V of the noise is approximated to 345 m/sec, the wavelength λ of the noise is obtained as 0.35 m for the frequency F of the noise of 1000 Hz by Mathematical Equation 8. The distance a₁=0.33 m and the wavelength λ=0.35 m are substituted into Mathematical Equation 6 to obtain the height difference h as 0.38 m for the frequency F=1000 Hz and the phase difference φ=180°. Setting the interval Lc to 0.38 m or less makes it difficult to generate, within a region behind the structure 80 where the height is larger than that of the point P1 and smaller than that of the point P2, a region where diffracted sound of noise having the frequency F of 50 to 1000 Hz is difficult to reduce.

From a viewpoint different from the sound reduction performance of the ANC system 500, it is also possible to set a range of the interval Lc. For example, it is also possible to determine the upper limit for the interval Lc on the basis of the dimension in the up-down direction of the structure 80. In this case, the upper limit for the interval Lc can be set to, for example, 4000 mm.

As shown in FIG. 1E, the radiation surface 15 of each of the piezoelectric speakers 10 extends along a first direction D1 and a second direction D2 orthogonal to the first direction D1. The first direction D1 is along the interval Lc. The radiation surface 15 of each of the piezoelectric speakers 10 is shorter in a dimension L1 in the first direction D1 than in a dimension L2 in the second direction D2.

Satisfying L1<L2 is suitable for generating an increased region where sound can be reduced. Specifically, the dimension L1 is the dimension in the first direction D1, and the piezoelectric speakers 10 are arranged so as to have the radiation surfaces 15 whose center positions (specifically, geometric center positions) in the first direction D1 are different from each other. Accordingly, a large region where sound can be reduced can be generated in the first direction D1 by arranging the piezoelectric speakers 10 even when each of the individual radiation surfaces 15 has a small dimension L1. On the other hand, a large region where sound can be reduced can be generated in the second direction D2 by increasing the dimension L2 of each of the individual radiation surfaces 15. Further, under the design of L1<L2, decreasing the dimension L1 facilitates an increase in the upper limit for the frequency of sound that can be reduced.

The ratio of the dimension L2 to the dimension L1, L2/L1, is 1.2 to 6. In the case where the ratio L2/L1 falls within this range, a large region where sound can be reduced is easily generated in both the first direction D1 and the second direction D2. The ratio L2/L1 may be 1.5 to 4.

In the present embodiment, the first direction D1 is the vertical direction. The second direction D2 is the horizontal direction orthogonal to the vertical direction. In this case, since the piezoelectric speakers 10 are arranged in the first direction D1, variation in the sound reducing effect can be suppressed between a tall person and a short person who are behind the structure 80. Further, in this case, since the piezoelectric speakers 10 are arranged in the first direction D1, variation in the sound reducing effect can be suppressed between when a person behind the structure 80 is sitting and when the person is standing.

Here, the dimension L1 and the dimension L2 of the radiation surface 15 will be described in detail. The following considers a rectangle 12 shown in FIG. 1G. The rectangle 12 has sides extending in the first direction D1 and sides extending in the second direction D2, and is the minimum rectangle surrounding the radiation surface 15. The dimension L1 is the length of the sides of the rectangle 12 extending in the first direction D1. The dimension L2 is the length of the sides of the rectangle 12 extending in the second direction D2.

In the example in FIG. 1E, the first direction D1 and the second direction D2 are each the direction along the sides of the rectangle 12. However, as shown in FIG. 1G, the first direction D1 and the second direction D2 may be directions deviated from the respective directions along the sides of the rectangle 12.

In the example in FIG. 1E, the first direction D1 is the up-down direction, and the second direction D2 is the right-left direction. In the example in FIG. 1E, the first direction D1 is the short direction of the radiation surface 15 of each of the piezoelectric speakers 10, and the second direction D2 is the long direction of the radiation surface 15 of each of the piezoelectric speakers 10. In the example in FIG. 1E, the shape of the radiation surface 15 is a rectangle having short sides extending in the first direction D1 and long sides extending in the second direction D2.

The dimension L1 of the radiation surface 15 of each of the piezoelectric speakers 10 in the first direction D1 may be equal to the interval Lc between the centers of the radiation surfaces 15 of the adjacent piezoelectric speakers 10, or may be smaller than the interval Lc. In the present embodiment, the dimension L1 is 160 mm to 3760 mm. The dimension L1 may be 159 to 3759 mm.

The dimension L1 may be 4000 mm or less, 3999 mm or less, 2610 mm or less, 2609 mm or less, 660 mm or less, 659 mm or less, 590 mm or less, 589 mm or less, 430 mm or less, 429 mm or less, 380 mm or less, or 379 mm or less. The dimension L1 may be 199 mm or more or 200 mm or more.

By adjusting the dimension L1 of the radiation surface 15 of each of the piezoelectric speakers 10 in the first direction D1, it is also possible to adjust the frequency of sound that can be reduced. In view of this, the upper limit for the dimension L1 may be set. The dimension L1 is, for example, 500 mm or less. In this case, it is easy to reduce noise having a high frequency. The dimension L1 may be 400 mm or less.

The lower limit for the dimension L1 of the radiation surface 15 of each of the piezoelectric speakers 10 in the first direction D1 may be set. The dimension L1 is, for example, 150 mm or more. The dimension L1 may be 200 mm or more.

In the present embodiment, the radiation surface 15 of each of the piezoelectric speakers 10 has the dimension L2 in the second direction D2 longer than the interval Lc. This is advantageous in view of generating a large region where sound can be reduced in the second direction D2.

The dimension L2 of the radiation surface 15 of each of the piezoelectric speakers 10 in the second direction D2 is, for example, 250 mm or more. The dimension L2 may be 500 mm or more.

The upper limit for the dimension L2 of the radiation surface 15 of each of the piezoelectric speakers 10 in the second direction D2 is not particularly limited. The dimension L2 is, for example, 2000 mm or less. The dimension L2 may be 1200 mm or less.

The shape of the radiation surface 15 is not limited to a rectangle as shown in FIG. 1E and the like. For example, the shape of the radiation surface 15 may be a rounded rectangle as shown in FIG. 1H. A radius of curvature Cr of the corner portion of the rounded rectangle is, for example, more than 0 and equal to or less than half of the length of the rounded rectangle in the short direction.

A further description will be given of the suitability of the ANC system 500 for diffracted sound reduction while mentioning the propagation direction and phase of sound wave.

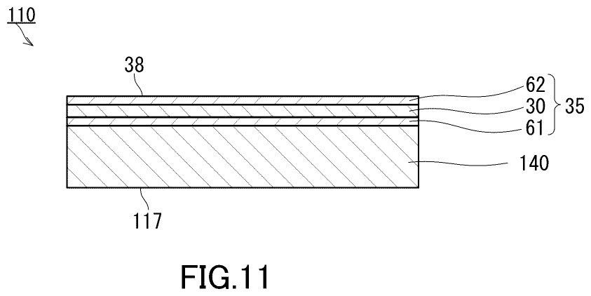

It is understood from FIG. 11, FIG. 2A, and FIG. 3A that the ANC system 500 can reduce diffracted sound generated by diffraction at the left end portion 81 and the right end portion 82.

Specifically, as shown in FIG. 2A, a wave front 81w generated by diffraction at the left end portion 81 and a wave front 82w generated by diffraction at the right end portion 82 propagate so as to approach an axis 80X. In FIG. 2A, the propagation direction of the wave front 81w is represented by reference numeral 81d, and the propagation direction of the wave front 82w is represented by reference numeral 82d. The axis 80X is an axis passing between the left end portion 81 and the right end portion 82 and extending in a direction away from the structure 80. Specifically, in the example in FIG. 2A, the axis 80X is orthogonal to the surface 80s of the structure 80 and passes through the center of the surface 80s.

On the other hand, as shown in FIG. 11, the radiation surface 15 of each of the piezoelectric speakers 10 has a first region 15a, a third region 15c, and a second region 15b in this order along the second direction D2. Specifically, on the radiation surface 15 of each of the piezoelectric speakers 10, the first region 15a, the third region 15c, and the second region 15b are arranged in this order along the second direction D2. The first regions 15a of the adjacent piezoelectric speakers 10 are adjacent to each other along the first direction D1. The second regions 15b of the adjacent piezoelectric speakers 10 are adjacent to each other along the first direction D1. The third regions 15c of the adjacent piezoelectric speakers 10 are adjacent to each other along the first direction D1.

As shown in FIG. 3A, each of the piezoelectric speakers 10 forms a first wave front 16a propagating from the first region 15a so as to approach a reference axis 10X and a second wave front 16b propagating from the second region 15b so as to approach the reference axis 10X. Specifically, in the present embodiment, such first wave front 16a and second wave front 16b are formed by vibration of the radiation surface 15. In FIG. 3A, the propagation direction of the first wave front 16a is represented by reference numeral 13a, and the propagation direction of the second wave front 16b is represented by reference numeral 13b. The reference axis 10X is an axis passing through the third region 15c and extending away from the radiation surface 15.

In a typical example, under the control of a controller 110, each of the piezoelectric speakers 10 forms the first wave front 16a propagating from the first region 15a so as to approach the reference axis 10X and the second wave front 16b propagating from the second region 15b so as to approach the reference axis 10X. In a specific example, under the control of the controller 110, a state is maintained where each of the piezoelectric speakers 10 forms the first wave front 16a propagating from the first region 15a so as to approach the reference axis 10X and the second wave front 16b propagating from the second region 15b so as to approach the reference axis 10X.

In the present embodiment, the left end portion 81 and the right end portion 82 face each other in the second direction D2, and the radiation surface 15 has the first region 15a, the third region 15c, and the second region 15b in this order along the second direction D2. Accordingly, in the present embodiment, it can also be said that the wave front 81w derived from diffraction at the left end portion 81 and the wave front 82w derived from diffraction at the right end portion 82 propagate so as to approach the reference axis 10X shown in FIG. 3A. Thus, the wave front 81w derived from diffraction at the left end portion 81 and the wave front 82w derived from diffraction at the right end portion 82 have common propagation directions with the first wave front 16a and the second wave front 16b derived from the ANC system 500. This is suitable for reducing diffracted sound generated by diffraction of noise at the left end portion 81 and the right end portion 82.

In the present embodiment, the reference axis 10X is orthogonal to the third region 15c in a state where the third region 15c does not vibrate. A deviation angle 81 of the first wave front 16a relative to the reference axis 10X in the propagation direction falls within a range of, for example, 5° to 85°, and may fall within a range of 15° to 75° or a range of 25° to 65°. A deviation angle 82 of the second wave front 16b relative to the reference axis 10X in the propagation direction falls within a range of, for example, 5° to 85°, and may fall within a range of 15° to 75° or a range of 25° to 65°. The third region 15c may be plane in a state where the third region 15c does not vibrate. Also, the entire radiation surface 15 may be plane in a state where the entire radiation surface 15 does not vibrate. The reference axis 10X may be an axis passing through the center of the radiation surface 15.

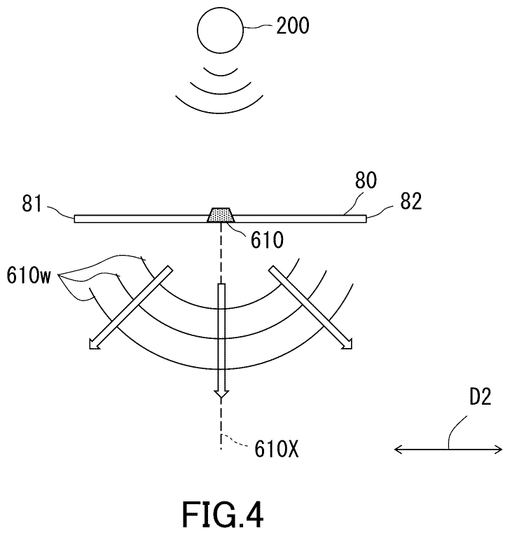

FIG. 4 is a diagram illustrating a conventional dynamic speaker 610. The dynamic speaker 610 radiates a substantially hemispherical wave from its radiation surface. The substantially hemispherical wave has a wave front 610w that is also substantially hemispherical. In FIG. 4, an axis 610X is an axis passing through the radiation surface of the dynamic speaker 610 and extending away from the radiation surface.

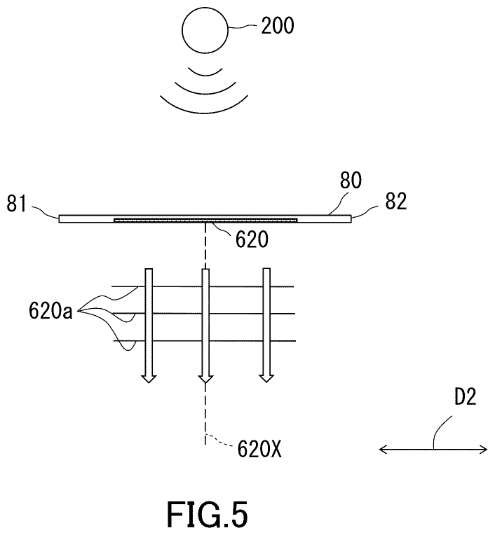

FIG. 5 is a diagram illustrating a conventional plane speaker 620. The plane speaker 620 radiates a substantially plane wave from its radiation surface. The substantially plane wave has a wave front 620w that is also substantially plane. In FIG. 5, an axis 620X is an axis passing through the radiation surface of the plane speaker 620 and extending away from the radiation surface.

As can be understood from FIG. 3A, FIG. 4, and FIG. 5, the conventional speakers 610 and 710 cannot achieve the combination according to the present embodiment composed of the first wave front 16a propagating from the first region 15a so as to approach the reference axis 10X and the second wave front 16b propagating from the second region 15b so as to approach the reference axis 10X.

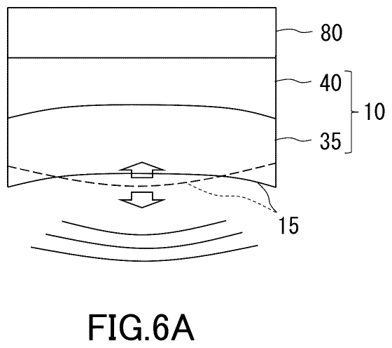

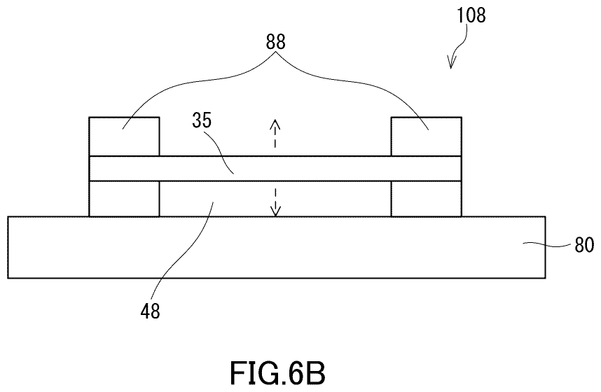

FIG. 6A is diagram illustrating vibration of the radiation surface 15 of each of the piezoelectric speakers 10 of the present embodiment. As shown in FIG. 6A, the speaker 10 of the present embodiment is configured to vibrate well even at the end portions of the radiation surface 15. The radiation surface 15 as a whole has a high degree of freedom of vibration. This may contribute to formation of the first wave front 16a and the second wave front 16b, although the details need to be studied in the future. In addition, the radiation surface 15 may vibrate in a mode that is somewhat close to a free-end vibration mode. Specifically, the radiation surface 15 may vibrate in a mode that is somewhat close to a primary free-end vibration mode.

An advantage of a sound reducing effect by the speaker 10 compared with those of the conventional speakers 610 and 710 tends to be exhibited when noise from the noise source 200 has a high frequency.

A consideration is conducted on generating a large region where sound can be reduced in the second direction D2 by using the conventional speaker 610 or 710. In this case, it is necessary to arrange the speakers 610 at an interval of half of the wavelength of sound to be output from the speakers 610 or the speakers 710 at an interval of half of the wavelength of sound to be output from the speakers 710. Compared with this, to generate a large region where sound can be reduced in the second direction D2 by using the piezoelectric speaker 10, it is sufficient to increase the dimension L2 of the piezoelectric speaker 10 in the second direction D2. Using the piezoelectric speaker 10 exhibits another advantage of requiring fewer speakers.

In a specific example, a portion of an end portion of the radiation surface 15 is formed in the first region 15a, and a portion of an end portion of the radiation surface 15 is formed in the second region 15b.

Here, a situation is considered in which the piezoelectric speakers 10 each do not vibrate and the ANC system 500 does not exhibit its sound reducing function (hereinafter referred to as a non-sound-reducing situation). In the non-sound-reducing situation, as schematically shown in FIG. 2C, depending on the size of the structure 80 and the wavelength of noise from the noise source 200, diffraction of the noise from the noise source 200 at the structure 80 can cause appearance of a period, in each of the piezoelectric speakers 10, during which a sound wave in the first region 15a and a sound wave in the second region 15b have the same phase in terms of whether positive or negative, the sound wave in the first region 15a and a sound wave in the third region 15c have the phases opposite to each other in terms of whether positive or negative, and the sound wave in the second region 15b and the sound wave in the third region 15c have the phases opposite to each other in terms of whether positive or negative. In FIG. 2C, hatching 11m is associated with the third region 15c of the first piezoelectric speaker 10A, the first region 15a of the second piezoelectric speaker 10B, and the second region 15b of the second piezoelectric speaker 10B. This schematically represents that the phases of the sound waves in these regions are one of positive and negative. Further, in FIG. 2C, hatching 11n is associated with the first region 15a of the first piezoelectric speaker 10A, the second region 15b of the first piezoelectric speaker 10A, and the third region 15c of the second piezoelectric speaker 10B. This schematically represents that the phases of the sound waves in these regions are the other of positive and negative.

With respect to this point, according to the present embodiment, noise derived from the noise source 200 having such a phase distribution as above in the first region 15a, the second region 15b, and the third region 15c can be reduced by sound derived from the ANC system 500, as described below.

The sound wave in the first region 15a formed by each of the piezoelectric speakers 10 is defined as a first sound wave. The sound wave in the second region 15b formed by each of the piezoelectric speakers 10 is defined as a second sound wave. The sound wave in the third region 15c formed by each of the piezoelectric speakers 10 is defined as a third sound wave. In the present embodiment, as schematically shown in FIG. 3C, a period appears, in each of the piezoelectric speakers 10, during which the first sound wave and the second sound wave have the same phase in terms of whether positive or negative, the first sound wave and the third sound wave have the phases opposite to each other in terms of whether positive or negative, and the second sound wave and the third sound wave have the phases opposite to each other in terms of whether positive or negative. According to the present embodiment, noise derived from the noise source 200 having such a phase distribution as above in the first region 15a, the second region 15b, and the third region 15c can be reduced by sound derived from the ANC system 500. In FIG. 3C, the hatching 11m is associated with the first region 15a of the first piezoelectric speaker 10A, the second region 15b of the first piezoelectric speaker 10A, and the third region 15c of the second piezoelectric speaker 10B. This schematically represents that the phases of the sound waves derived from the ANC system 500 in these regions are one of positive and negative. Further, in FIG. 3C, the hatching 11n is associated with the third region 15c of the first piezoelectric speaker 10A, the first region 15a of the second piezoelectric speaker 10B, and the second region 15b of the second piezoelectric speaker 10B. This schematically represents that the phases of the sound waves derived from the ANC system 500 in these regions are the other of positive and negative.

In a typical example, under the control of the controller 110, a period T1 can appear, in each of the piezoelectric speakers 10, during which the first sound wave and the second sound wave have the same phase in terms of whether positive or negative, the first sound wave and the third sound wave have the phases opposite to each other in terms of whether positive or negative, and the second sound wave and the third sound wave have the phases opposite to each other in terms of whether positive or negative.

When one period of the first sound wave, the second sound wave, or the third sound wave is defined as Tp, T1/Tp is, for example, 0.01 to 1, depending on the noise source 200. Further, in the case where the noise source 200 radiates a sine wave, the period T1 can continue or can appear periodically. T1/Tp may be 0.1 to 1, 0.5 to 1, 0.7 to 1, or 0.9 to 1.

As described above, the first sound wave is a sound wave in the first region 15a formed by the speaker 10. The first sound wave conceptually includes a sound wave at a position infinitely close to the first region 15a in a space facing the first region 15a. Accordingly, measurement of the first sound wave can be achieved by measuring the sound wave at this “infinitely close position”. The same applies to the second sound wave and the third sound wave.

The fact that the phase distribution as above of the first sound wave, the second wave, and the third sound wave is obtained is consistent with the assumption that the radiation surface 15 is vibrating in the mode close to the primary free-end vibration mode to a certain extent.

In addition, in the non-sound-reducing situation, depending on the size of the structure 80 and the wavelength of noise from the noise source 200, diffraction of the noise from the noise source 200 at the structure 80 can cause appearance of a period during which the sound waves in the first regions 15a of the adjacent piezoelectric speakers 10 have the phases opposite to each other in terms of whether positive or negative. Specifically, a period can appear during which the sound waves in the first regions 15a of the adjacent piezoelectric speakers 10 have the phases opposite to each other in terms of whether positive or negative, the sound waves in the second regions 15b of the piezoelectric speakers 10 have the phases opposite to each other in terms of whether positive or negative, and the sound waves in the third regions 15c of the adjacent piezoelectric speakers 10 have the phases opposite to each other in terms of whether positive or negative.

With respect to this point, in the present embodiment, as schematically shown in FIG. 3C, a period can appear during which the first sound waves of the adjacent piezoelectric speakers 10 have the phases opposite to each other in terms of whether positive or negative. Specifically, a period can appear during which the first sound waves of the adjacent piezoelectric speakers 10 have the phases opposite to each other in terms of whether positive or negative, the second sound waves of the adjacent piezoelectric speakers 10 have the phases opposite to each other in terms of whether positive or negative, and the third sound waves of the adjacent piezoelectric speakers 10 have the phases opposite to each other in terms of whether positive or negative. According to the present embodiment, noise derived from the noise source 200 having such a phase distribution as above in the first region 15a, the second region 15b, and the third region 15c can be reduced by sound derived from the ANC system 500.

In a typical example, under the control of the controller 110, a period T2 can appear during which the first sound waves of the adjacent piezoelectric speakers 10 have the phases opposite to each other in terms of whether positive or negative. Specifically, under the control of the controller 110, the period T2 can appear during which the first sound waves of the adjacent piezoelectric speakers 10 have the phases opposite to each other in terms of whether positive or negative, the second sound waves of the adjacent piezoelectric speakers 10 have the phases opposite to each other in terms of whether positive or negative, and the third sound waves of the adjacent piezoelectric speakers 10 have the phases opposite to each other in terms of whether positive or negative. When one period of the first sound wave, the second sound wave, or the third sound wave is defined as Tp, T2/Tp is, for example, 0.01 to 1, depending on the noise source 200. Further, in the case where the noise source 200 radiates a sine wave, the period T2 can continue or can appear periodically. T2/Tp may be 0.1 to 1, 0.5 to 1, 0.7 to 1, or 0.9 to 1.

It is understood from FIG. 2B and FIG. 3B that the ANC system 500 can reduce diffracted sound generated by diffraction at the upper end portion 83.

Specifically, FIG. 2B schematically shows a wave front 83w generated by diffraction at the upper end portion 83 and a propagation direction 83d of the wave front 83w. As shown in FIG. 2B, a consideration is given to a point Q1 and a point Q2 behind the structure 80 that are apart from the surface 80s of the structure 80 by the same distance and are at different positions in the up-down direction. The distance from the upper end portion 83 to the point Q1 and the distance from the upper end portion 83 to the point Q2 are different from each other. This causes a shift in phase of the wave front 83w between the point Q1 and the point Q2. In the case where such a phase shift is present, it is not always easy to achieve good sound reduction at both the point Q1 and the point Q2 by a single piezoelectric speaker 10.

With respect to this point, in the present embodiment, the first direction D1 is the up-down direction. The piezoelectric speakers 10 are arranged so as to have the radiation surfaces 15 whose center positions (specifically, geometric center positions) in the first direction D1 are different from each other. This enables achievement of good sound reduction at both the point Q1 and the point Q2. Specifically, as schematically shown in FIG. 3B, it is possible to achieve sound reduction in a region centered on the point Q1 by the first piezoelectric speaker 10A and to achieve sound reduction in a region centered on the point Q2 by the second piezoelectric speaker 10B. More generally, according to the present embodiment, it is possible to achieve good sound reduction at different positions in the first direction D1.

In the present embodiment, the ANC system 500 includes the controller 110. The controller 110 is configured to control the speaker 10 to output sound in a first frequency range FR1. The frequency range FR1 is, for example, 50 Hz to 3000 Hz, and may be 100 to 2000 Hz.

In a specific example, a second frequency range FR2 can be set for the controller 110. The controller 110 controls the frequency of sound to be output from the speaker 10 to have a value within the second frequency range FR2. The second frequency range FR2 is narrower than the first frequency range FR1. In reality, the ANC system 500 is sometimes desired to exercise its capability not maximally but only partially in consideration of the scale, calculation load, and the like of the ANC system 500. This specific example is adoptable to such a case. Specifically, in this specific example, a desired band can be selected as the second frequency range FR2.

As shown in FIG. 1E, in the present embodiment, when the surface 80s of the structure 80 is viewed in plan, the radiation surface 15 has a left end portion 15j and a right end portion 15k facing each other. When the surface 80s of the structure 80 is viewed in plan, a left margin M1 between the left end portion 15j and one of the end portions of the structure 80 is 0 or more and 1/10 or less of a reference wavelength. When the surface 80s of the structure 80 is viewed in plan, a right margin M2 between the right end portion 15k and the other end portion of the structure 80 is 0 or more and 1/10 or less of the reference wavelength. Here, the reference wavelength is the wavelength of sound having the upper frequency limit of the first frequency range FR1 or the second frequency range FR2. This is suitable for reducing diffracted sound generated by diffraction of noise at the left end portion 81 and the right end portion 82. The ratio 1/10 is derived from the fact that the region where sound can be reduced by a typical ANC is 1/10 of the wavelength of noise to be controlled.

In fact, there are cases where the left margin M1 and the right margin M2 should be increased to a certain extent for the sake of commercialization. Taking this into consideration, the upper limits for the left margin M1 and the right margin M2 may be increased to exceed 1/10 of the reference wavelength. In view of performing a reasonable commercialization while achieving an effect of reducing diffracted sound, the left margin M1 can be set to 0 or more and ⅓ or less of the reference wavelength, for example. Also, the right margin M2 can be set to 0 or more and ⅓ or less of the reference wavelength when the surface 80s of the structure 80 is viewed in plan.

The left margin M1 is, for example, 0 cm to 50 cm, and may be 0 cm to 10 cm. The right margin M2 is, for example, 0 cm to 50 cm, and may be 0 cm to 10 cm.

The left margin M1 is the distance (specifically, the shortest distance) between the left end portion 15j and the left end portion 81 in a plan view of the radiation surface 15. In the present embodiment, the right margin M2 is the distance (specifically, the shortest distance) between the right end portion 15k and the right end portion 82 in a plan view of the radiation surface 15.

In the present embodiment, when the surface 80s of the structure 80 is viewed in plan, an upper margin M3 between an upper end portion 15l of the radiation surface 15 of the piezoelectric speaker 10 disposed uppermost among the piezoelectric speakers 10 and the end portion of the structure 80 is 0 or more and 1/10 or less of the reference wavelength. The upper margin M3 may be 0 or more and ⅓ or less of the reference wavelength. The upper margin M3 is, for example, 0 cm to 50 cm, and may be 0 cm to 10 cm.

The upper margin M3 is the distance (specifically, the shortest distance), in a plan view of the surface 80s, between the upper end portion 83 and the upper end portion 15l of the radiation surface 15 of the piezoelectric speaker 10 disposed uppermost among the piezoelectric speakers 10.

In the present embodiment, on the surface 80s of the structure 80, the piezoelectric speakers 10 constitute a row extending in the first direction D1. In the illustrated example, the number of the rows is one. This is advantageous in view of generating a large region where sound can be reduced while avoiding complicated control. The number of the rows may be more than one.

In an ANC system employing piezoelectric speakers, as compared with an ANC system employing the point sound source or the line sound source, it is easy to reduce even noise having a frequency higher than the frequency of noise having a wavelength that is twice as long as the interval. This is because the radiation surfaces of the piezoelectric speakers extend two dimensionally.

In an example, the ANC system 500 is configured to have an upper frequency limit that is the upper limit for the frequency of sound to be output from the piezoelectric speakers 10. The upper frequency limit is higher than the frequency of sound having a wavelength that is twice as long as the interval Lc. This example takes advantage of an ANC system employing piezoelectric speakers, namely, easy reduction of even high-frequency noise. In a specific example, the upper frequency limit is the upper limit for the above second frequency range FR2. In another specific example, the upper frequency limit is the frequency determined by the dimension of the piezoelectric speaker 10, and is, for example, the upper limit for the first frequency range FR1.

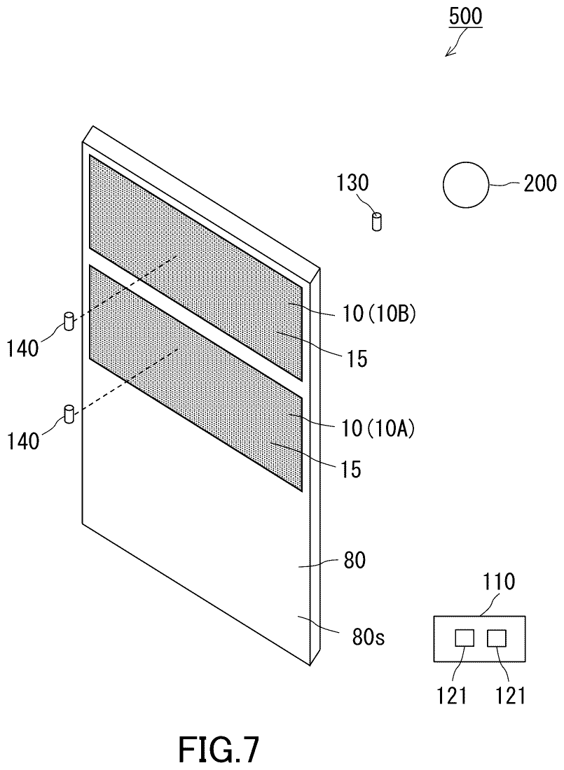

In the present embodiment, as shown in FIG. 7, the ANC system 500 includes a plurality of error microphones 140 and the controller 110. The controller 110 controls sound to be output from the piezoelectric speakers 10 by using the error microphones 140. This configuration is suitable for generating an increased region where sound can be reduced.

Specifically, in the present embodiment, the piezoelectric speakers 10 and the error microphones 140 are associated one-to-one with each other. The controller 110 may control sound to be output from each of the piezoelectric speakers 10 by using the error microphone 140 associated with the piezoelectric speaker 10. This configuration is suitable for generating an increased region where sound can be reduced while suppressing the number of the error microphones 140.

In the present embodiment, the controller 110 of the ANC system 500 has a plurality of noise control filters 121. The piezoelectric speakers 10 and the noise control filters 121 are associated one-to-one with each other. The controller 110 controls sound to be output from each of the piezoelectric speakers 10 by using the noise control filter 121 associated with the piezoelectric speaker 10. According to this configuration, the controller 110 can control each of the piezoelectric speakers 10 independently. This is advantageous in view of achieving good sound reduction in a large region.

In the present embodiment, the piezoelectric speakers 10, the error microphones 140, and the noise control filters 121 are associated one-to-one with each other. The noise control filters 121 each operate to control the piezoelectric speaker 10 associated with the noise control filter 121 to emit sound so that the sound to be detected by the error microphone 140 associated with the noise control filter 121 is reduced, specifically so that the magnitude of the sound approaches a local minimum value, and more specifically so that the magnitude of the sound converges to the local minimum value.

The number of the error microphones 140 may be larger than the number of the piezoelectric speakers 10. In this case, a multi-channel ANC system can be configured as described later.

The number of the error microphones 140 may be smaller than the number of the piezoelectric speakers 10. In this case, at least two of the piezoelectric speakers 10 can share the same error microphone 140.

In the present embodiment, the ANC system 500 includes at least one reference microphone 130. The controller 110 controls sound to be output from each of the piezoelectric speakers 110 by using at least one reference microphone 130. According to the reference microphone 130, it is possible to reduce non-periodic signal.

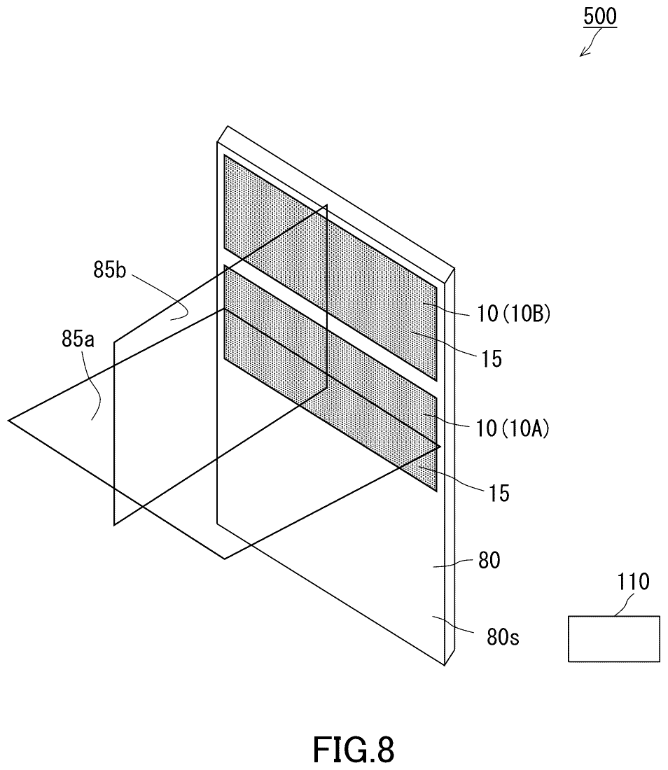

The sound reducing effect of the present embodiment will be described with reference to FIG. 8. In FIG. 8, reference numeral 85a represents a reference plane perpendicular to the up-down direction. Reference numeral 85b represents a perpendicular plane perpendicular to the right-left direction. According to the present embodiment, both sound reduction in the reference plane 85a and sound reduction in the perpendicular plane 85b can be achieved. Specifically, in the example in FIG. 8, the up-down direction is the vertical direction. The reference plane 85a is a horizontal plane. The perpendicular plane 85b is a sagittal plane.

In the example in FIG. 1A to FIG. 11, the number of the piezoelectric speakers 10 in the ANC system 500 is two. However, the number of the piezoelectric speakers 10 in the ANC system 500 may be three or more, for example, four.

In the example in FIG. 1A to FIG. 11, the lower end portion 84 is in contact with the floor. However, it is also possible to dispose the structure 80 so that a space is formed under the lower end portion 84. In this case, the ANC system 500 can be configured to reduce diffracted sound generated at the lower end portion 84.

In an example, when the surface 80s of the structure 80 is viewed in plan, a lower margin between the lower end portion of the radiation surface 15 of the piezoelectric speaker 10 disposed lowermost among the piezoelectric speakers 10 and the end portion of the structure 80 is 0 or more and 1/10 or less of the reference wavelength. The lower margin may be 0 or more and ⅓ or less of the reference wavelength. The lower margin is, for example, 0 cm to 50 cm, and may be 0 cm to 10 cm.

The lower margin is the distance (specifically, the shortest distance), in a plan view of the surface 80s, between the lower end portion 84 and the lower end portion of the radiation surface 15 of the piezoelectric speaker 10 disposed lowermost among the piezoelectric speakers 10.

No particular limitation is imposed on the portion of the surface 80s of the structure 80 where the piezoelectric speakers 10 are to be disposed.

[Feedforward ANC System]

In a specific example, the ANC system 500 performs feedforward control. The ANC system 500 performing feedforward control is hereinafter referred to also as a feedforward ANC system 500.

The feedforward ANC system 500 includes one reference microphone 130, the error microphones 140, and the controller 110. The controller 110 has the noise control filters 121. The piezoelectric speakers 10, the error microphones 140, and the noise control filters 121 are associated one-to-one with each other.

A sound wave to be cancelled out is assumed to have reached a position of a certain error microphone 140 in a predetermined region from the noise source 200 and have a waveform X at the position of the error microphone 140. The piezoelectric speaker 10 associated with the error microphone 140 radiates a sound wave that is to have, upon reaching the position of the error microphone 140, a waveform Y opposite in phase to the waveform X. These sound waves cancel out each other at the position of the error microphone 140. In other words, these sound waves are synthesized at the position of the error microphone 140 to generate a synthetic sound wave having a waveform Z whose amplitude is reduced to 0 or a low level. A similar phenomenon also occurs for any other combination of the piezoelectric speaker 10 and the error microphone 140 that are associated with each other. In the feedforward ANC system 500, sound reduction is achieved in this manner.

In the feedforward ANC system 500, feedforward control is performed by using the reference microphone 130, the error microphones 140, and the controller 110. Specifically, the reference microphone 130 is disposed on the noise source 200 side when viewed from the piezoelectric speaker 10. The reference microphone 130 detects sound from the noise source 200. The error microphones 140 are disposed in the above predetermined region and detects sound in the above predetermined region. On the basis of the sound detected by the reference microphone 130 and the error microphones 140, the controller 110 adjusts sound waves to be radiated from the piezoelectric speakers 10.

In the feedforward ANC system 500, the piezoelectric speakers 10 are each associated with a different one of the error microphones 140. Such a feedforward ANC system 500 may be referred to as a single-channel ANC system 500.

In the feedforward ANC system 500, the piezoelectric speakers 10 each may be associated with different two or more of the error microphones 140. Such a feedforward ANC system 500 may be referred to as a multi-channel ANC system 500.

The single-channel ANC system 500 is advantageous in view of achieving simple control. In the multi-channel ANC system 500, noise at a point of each of the two or more error microphones 140 can be reduced. Providing two or more points at which noise can be reduced (control points) by the two or more error microphones 140 is advantageous in view of achieving sound reduction in a large space.

The controller 110 has a first preamplifier (hereinafter, an amplifier is referred to also as an amp), a first low-pass filter, a first analog-to-digital converter (hereinafter, referred to also as an AD converter), a second preamp, a second low-pass filter, a second AD converter, a power amp, a third low-pass filter, a digital-to-analog converter (hereinafter, referred to also as a DA converter), and an operation unit.

Specifically, the first preamp, the first low-pass filter, the first AD converter, the second preamp, the second low-pass filter, the second AD converter, the power amp, the third low-pass filter, the DA converter, and the operation unit are shared for controlling sound to be output from the piezoelectric speakers 10. On the other hand, as in the case of the error microphone 140, one noise control filter 121 is provided for each of the piezoelectric speakers 10.

The first preamp amplifies an output signal of the reference microphone 130. The first low-pass filter passes a low-pass component of an output signal of the first preamp. The first AD converter converts an output signal of the first low-pass filter into a digital signal. As a result, a reference signal x(n) as of a time n is output from the first AD converter.

The second preamp amplifies an output signal of the error microphone 140. The second low-pass filter passes a low-pass component of an output signal of the second preamp. The second AD converter converts an output signal of the second low-pass filter into a digital signal. As a result, an error signal e(n) as of the time n is output from the second AD converter.

The operation unit generates a control signal y(n) as of the time n from the reference signal x(n) and the error signal e(n). The operation unit includes, for example, a digital signal processor (DSP) or a field-programmable gate array (FPGA). The operation unit operates on the basis of, for example, the filtered-x algorithm.

Specifically, the operation unit has the noise control filter 121. The operation unit updates the filter coefficient of the noise control filter 121 so that the error signal e(n) decreases, specifically so that the error signal e(n) approaches a local minimum value, and more specifically so that the error signal e(n) converges to the local minimum value.

The DA converter converts the control signal y(n) into an analog signal. The third low-pass filter passes a low-pass component of an output signal of the DA converter. The power amp amplifies an output signal of the third low-pass filter. A signal output from the power amp is transmitted as a control signal to the piezoelectric speaker 10. On the basis of this signal, sound is output from the radiation surface 15.

As can be understood from the above description, the feedforward ANC system 500 includes the error microphones 140, the at least one reference microphone 130, and the controller 110. The at least one reference microphone 130, the structure 80, the piezoelectric speakers 10, and the error microphones 140 are arranged in this order. The controller 110 performs feedforward control of controlling sound to be output from the piezoelectric speakers 10 on the basis of an output signal of the reference microphone 130 and output signals of the error microphones 140. Feedforward control enables reduction of not only a periodic signal but also a non-periodic signal.

[Feedback ANC System]

In a specific example, the ANC system 500 performs feedback control. Hereinafter, the ANC system 500 performing feedback control is referred to also as a feedback ANC system 500.

The feedback ANC system 500 includes the error microphones 140 and the controller 110. The controller 110 has the noise control filters 121. The piezoelectric speakers 10, the error microphones 140, and the noise control filters 121 are associated one-to-one with each other.

A sound wave to be cancelled out is assumed to have reached a position of a certain error microphone 140 in a predetermined region from the noise source 200 and have a waveform X at the position of the error microphone 140. The piezoelectric speaker 10 associated with the error microphone 140 radiates a sound wave that is to have, upon reaching the position of the error microphone 140, a waveform Y opposite in phase to the waveform X. These sound waves cancel out each other at the position of the error microphone 140. In other words, these sound waves are synthesized at the position of the error microphone 140 to generate a synthetic sound wave having a waveform Z whose amplitude is reduced to 0 or a low level. A similar phenomenon also occurs for any other combination of the piezoelectric speaker 10 and the error microphone 140 that are associated with each other. In the feedback ANC system 500, sound reduction is achieved in this manner.

In the feedback ANC system 500, feedback control is performed by using the error microphones 140 and the controller 110. Specifically, the error microphones 140 are disposed in the above predetermined region and detects sound in the above predetermined region. On the basis of the sound detected by the error microphones 140, the controller 110 adjusts a sound wave to be radiated from the piezoelectric speakers 10.

In the feedback ANC system 500, the piezoelectric speakers 10 are each associated with a different one of the error microphones 140. Such a feedback ANC system 500 may be referred to as a single-channel ANC system 500.

In the feedback ANC system 500, the piezoelectric speakers 10 each may be associated with different two or more of the error microphones 140. Such a feedback ANC system 500 may be referred to as a multi-channel ANC system 500.

The single-channel ANC system 500 is advantageous in view of achieving simple control. In the multi-channel ANC system 500, noise at a point of each of the two or more error microphones 140 can be reduced. Providing two or more control points by the two or more error microphones 140 is advantageous in view of achieving sound reduction in a large space.

The controller 110 has the second preamp, the second low-pass filter, the second AD converter, the power amp, the third low-pass filter, the DA converter, and the operation unit.

Specifically, the second preamp, the second low-pass filter, the second AD converter, the power amp, the third low-pass filter, the DA converter, and the operation unit are shared for controlling sound to be output from the piezoelectric speakers 10. On the other hand, as in the case of the error microphone 140, one noise control filter 121 is provided for each of the piezoelectric speakers 10.

The second preamp amplifies an output signal of the error microphone 140. The second low-pass filter passes a low-pass component of an output signal of the second preamp. The second AD converter converts an output signal of the second low-pass filter into a digital signal. As a result, an error signal e(n) as of the time n is output from the second AD converter.

The operation unit generates a control signal y(n) as of the time n from the error signal e(n). The operation unit includes, for example, a DSP or an FPGA. The operation unit operates on the basis of, for example, the filtered-x algorithm.

Specifically, the operation unit has the noise control filter 121. The operation unit updates the filter coefficient of the noise control filter 121 so that the error signal e(n) decreases, specifically so that the error signal e(n) approaches a local minimum value, and more specifically so that the error signal e(n) converges to the local minimum value.

The DA converter converts the control signal y(n) into an analog signal. The third low-pass filter passes a low-pass component of an output signal of the DA converter. The power amp amplifies an output signal of the third low-pass filter. A signal output from the power amp is transmitted as a control signal to the piezoelectric speaker 10. On the basis of this signal, sound is output from the radiation surface 15.

As can be understood from the above description, the feedback ANC system 500 includes the error microphones 140 and the controller 110. The structure 80, the piezoelectric speakers 10, and the error microphones 140 are arranged in this order. The controller 110 performs feedback control of controlling sound to be output from the piezoelectric speakers 10 on the basis of output signals of the error microphones 140. Feedback control enables reduction of a periodic signal with no need for the reference microphone 130.

As can be understood from the description on the feedforward ANC system 500 and the feedback ANC system 500, the controller 110 of the ANC system 500 can have at least one amp. The controller 110 can have at least one low-pass filter. The controller 110 can have at least one AD converter. The controller 110 can have at least one DA converter. These elements can contribute to control on sound to be output from the piezoelectric speaker 10.

The ANC system 500 can be provided in an office and the like. In a specific example, the piezoelectric speaker 10 is attached to the structure 80 that is a partition. The noise source 200 is a person in a certain conference space. The above predetermined region is another conference space.

### First Structure Example of Piezoelectric Speaker 10

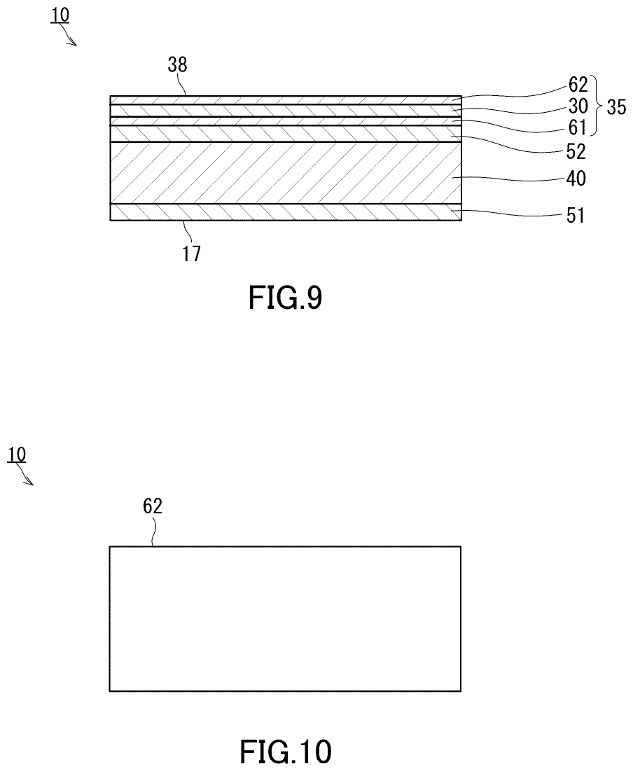

A piezoelectric speaker 10 according to a first structure example will be described with reference to FIG. 9 and FIG. 10.

The piezoelectric speaker 10 includes a piezoelectric film 35, a first joining layer 51, an interposed layer 40, and a second joining layer 52. The first joining layer 51, the interposed layer 40, the second joining layer 52, and the piezoelectric film 35 are laminated in this order.

The piezoelectric film 35 includes a piezoelectric body 30, a first electrode 61, and a second electrode 62.

The piezoelectric body 30 has the shape of a film. The piezoelectric body 30 is vibrated by application of voltage. A ceramic film, a resin film, and the like can be used as the piezoelectric body 30. Examples of the material of the piezoelectric body 30 that is a ceramic film include lead zirconate, lead zirconate titanate, lead lanthanum zirconate titanate, barium titanate, Bi-layered compounds, compounds having a tungsten bronze structure, and solid solutions of barium titanate and bismuth ferrite. Examples of the material of the piezoelectric body 30 that is a resin film include polyvinylidene fluoride and polylactic acid. The material of the piezoelectric body 30 that is a resin film may be a polyolefin such as polyethylene or polypropylene. The piezoelectric body 30 may be a non-porous body or may be a porous body.

The thickness of the piezoelectric body 30 falls within a range of, for example, 10 μm to 300 μm, and may fall within a range of 30 μm to 110 μm.

The first electrode 61 and the second electrode 62 are in contact with the piezoelectric body 30 so as to sandwich the piezoelectric body 30 therebetween. The first electrode 61 and the second electrode 62 each have the shape of a film. The first electrode 61 and the second electrode 62 are each connected to a lead wire which is not illustrated. The first electrode 61 and the second electrode 62 can be formed on the piezoelectric body 30 by vapor deposition, plating, sputtering, or the like. A metal foil can be used as each of the first electrode 61 and the second electrode 62. A metal foil can be stuck to the piezoelectric body 30 by using a double-faced tape, a pressure-sensitive adhesive, an adhesive, or the like. Examples of the materials of the first electrode 61 and the second electrode 62 include metals, and specific examples thereof include gold, platinum, silver, copper, palladium, chromium, molybdenum, iron, tin, aluminum, and nickel. Examples of the materials of the first electrode 61 and the second electrode 62 also include carbon and electrically conductive polymers. Examples of the materials of the first electrode 61 and the second electrode 62 also include alloys of the above metals. The first electrode 61 and the second electrode 62 may include, for example, a glass component.

The thickness of the first electrode 61 and that of the second electrode 62 each may fall within a range of, for example, 10 nm to 150 μm, and may fall within a range of 20 nm to 100 μm.

In the example in FIG. 9 and FIG. 10, the first electrode 61 covers entirely one of principal surfaces of the piezoelectric body 30. The first electrode 61 may cover only partially the one principal surface of the piezoelectric body 30. The second electrode 62 covers entirely the other principal surface of the piezoelectric body 30. The second electrode 62 may cover only partially the other principal surface of the piezoelectric body 30.

In the first structure example, the interposed layer 40 is disposed between the piezoelectric film 35 and the first joining layer 51. The interposed layer 40 may be a layer other than an adhesive layer and a pressure-sensitive adhesive layer, or may be an adhesive layer or a pressure-sensitive adhesive layer. In the first structure example, the interposed layer 40 is a porous body layer and/or a resin layer. Here, the resin layer conceptually includes a rubber layer and an elastomer layer. Accordingly, the interposed layer 40 that is a resin layer may be a rubber layer or an elastomer layer. Examples of the interposed layer 40 that is a resin layer include an ethylene propylene rubber layer, a butyl rubber layer, a nitrile rubber layer, a natural rubber layer, a styrene-butadiene rubber layer, a silicone layer, a urethane layer, and an acrylic resin layer. Examples of the interposed layer 40 that is a porous body layer include foam layers. Specifically, examples of the interposed layer 40 that is a porous body layer and a resin layer include an ethylene propylene rubber foam layer, a butyl rubber foam layer, a nitrile rubber foam layer, a natural rubber foam layer, a styrene-butadiene rubber foam layer, a silicone foam layer, and a urethane foam layer. Examples of the interposed layer 40 that is not a porous body layer and is a resin layer include acrylic resin layers. Examples of the interposed layer 40 that is not a resin layer and is a porous body layer include porous metal body layers. Here, the resin layer refers to a layer containing a resin, and refers to a layer that may contain a resin in an amount of 30% or more, in an amount of 45% or more, in an amount of 60% or more, or in an amount of 80% or more. The same applies to, for example, a rubber layer, an elastomer layer, an ethylene propylene rubber layer, a butyl rubber layer, a nitrile rubber layer, a natural rubber layer, a styrene-butadiene rubber layer, a silicone layer, a urethane layer, an acrylic resin layer, and a metal layer. Further, the same applies to a resin film, a ceramic film, and the like that can be employed as the piezoelectric body 30. The interposed layer 40 may be a blended layer including two or more materials.

The elastic modulus of the interposed layer 40 is, for example, 10000 N/m² to 20000000 N/m², and may be 20000 N/m² to 100000 N/m².

In an example, the pore diameter of the interposed layer 40 that is a porous body layer is 0.1 mm to 7.0 mm, and may be 0.3 mm to 5.0 mm. In another example, the pore diameter of the interposed layer 40 that is a porous body layer is, for example, 0.1 mm to 2.5 mm, and may be 0.2 mm to 1.5 mm or 0.3 mm to 0.7 mm. The porosity of the interposed layer 40 that is a porous body layer is, for example, 70% to 99%, and may be 80% to 99% or 90% to 95%.

A known foam (for example, the foam used in Patent Literature 2) can be used as the interposed layer 40 that is a foam layer. The interposed layer 40 that is a foam layer may have an open-cell structure, a closed-cell structure, or a semi-open-/semi-closed-cell structure. The term “open-cell structure” refers to a structure having an open cell rate of 100%. The term “closed-cell structure” refers to a structure having an open cell rate of 0%. The term “semi-open-/semi-closed-cell structure” refers to a structure having an open cell rate of greater than 0% and less than 100%. The open cell rate can be calculated, for example, by using the following equation after a test in which a foam layer is sunk in water: open cell rate (%)={(volume of absorbed water)/(volume of cell part)}×100. In a specific example, the “volume of absorbed water” can be obtained by sinking and leaving a foam layer in water under a reduced pressure of −750 mmHg for 3 minutes, measuring the mass of water having replaced the air in cells of the foam layer, and converting the mass of water in the cells into volume on the assumption that the density of water is 1.0 g/cm³. The term “volume of cell part” refers to a value calculated by using the following equation: volume of cell part (cm³)={(mass of foam layer)/(apparent density of foam layer)}−{(mass of foam layer)/(density of material)}. The term “density of material” refers to the density of a matrix (solid, or non-hollow, body) forming the foam layer.

The foaming factor (the ratio between the density before foaming and that after foaming) of the interposed layer 40 that is a foam layer is, for example, 5 to 40, and may be 10 to 40.

The interposed layer 40 in an uncompressed state has a thickness of, for example, 0.1 mm to 30 mm, and may have a thickness of 1 mm to 30 mm, 1.5 mm to 30 mm, or 2 mm to 25 mm. The interposed layer 40 in an uncompressed state is typically thicker than the piezoelectric film 35 in an uncompressed state. The thickness of the interposed layer 40 in an uncompressed state is, for example, 3 or more times the thickness of the piezoelectric film 35 in an uncompressed state, and may be 10 or more times or 30 or more times the thickness of the piezoelectric film 35 in an uncompressed state. The interposed layer 40 in an uncompressed state is typically thicker than the first joining layer 51 in an uncompressed state.

A surface of the first joining layer 51 forms the fixing surface 17. The first joining layer 51 is a layer to be joined to the structure 80. In the example in FIG. 9, the first joining layer 51 is joined to the interposed layer 40.

In the first structure example, the first joining layer 51 is a layer having pressure-sensitive adhesiveness or adhesiveness. In other words, the first joining layer 51 is an adhesive layer or a pressure-sensitive adhesive layer. The fixing surface 17 is an adhesive surface or a pressure-sensitive adhesive surface. The first joining layer 51 can be stuck to the structure 80. In the example in FIG. 1, the first joining layer 51 is in contact with the interposed layer 40.

Examples of the first joining layer 51 include a double-faced tape including a substrate and a pressure-sensitive adhesive applied to the both sides of the substrate. Examples of the substrate of the double-faced tape used as the first joining layer 51 include non-woven fabric. Examples of the pressure-sensitive adhesive of the double-faced tape used as the first joining layer 51 include pressure-sensitive adhesives including an acrylic resin. The first joining layer 51 may be a layer including no substrate and formed of a pressure-sensitive adhesive.

The thickness of the first joining layer 51 is, for example, 0.01 mm to 1.0 mm, and may be 0.05 mm to 0.5 mm.

The second joining layer 52 is disposed between the interposed layer 40 and the piezoelectric film 35. In the first structure example, the second joining layer 52 is a layer having pressure-sensitive adhesiveness or adhesiveness. In other words, the second joining layer 52 is an adhesive layer or a pressure-sensitive adhesive layer. Specifically, the second joining layer 52 is joined to the interposed layer 40 and the piezoelectric film 35.

Examples of the second joining layer 52 include a double-faced tape including a substrate and a pressure-sensitive adhesive applied to the both sides of the substrate. Examples of the substrate of the double-faced tape used as the second joining layer 52 include non-woven fabric. Examples of the pressure-sensitive adhesive of the double-faced tape used as the second joining layer 52 include pressure-sensitive adhesives including an acrylic resin. The second joining layer 52 may be a layer including no substrate and formed of a pressure-sensitive adhesive.

The thickness of the second joining layer 52 is, for example, 0.01 mm to 1.0 mm, and may be 0.05 mm to 0.5 mm.

In the first structure example, the piezoelectric film 35 is integrated with the layers on the fixing surface 17 side by bringing an adhesive surface or a pressure-sensitive adhesive surface into contact with the piezoelectric film 35. Specifically, in the first structure example, the adhesive surface or the pressure-sensitive adhesive surface is a face formed of a surface of the second pressure-sensitive adhesive or adhesive layer 52.

It is possible to configure the ANC system 500 by employing a plurality of the piezoelectric speakers 10 according to the first structure example. Compared with dynamic speakers, the piezoelectric speaker 10 requires a short time from reach of an electric signal to the speaker to output of sound (hereinafter, this time is referred to also as delay time). Accordingly, the piezoelectric speaker 10 is suitable for configuring a compact ANC system because of not only being small in size but also being able to reduce the distance between the reference microphone 130 and the piezoelectric speaker 10. It is also possible, for example, to attach the reference microphone 130, the controller 110, and the piezoelectric speaker 10 to a single partition.

While the piezoelectric speaker 10 is fixed to the structure 80, a voltage is applied to the piezoelectric film 35 through a lead wire. This vibrates the piezoelectric film 35, and thus a sound wave is radiated from the piezoelectric film 35.

The piezoelectric speaker 10 and the ANC system 500 to which the piezoelectric speaker 10 is applied will be further described.

The piezoelectric speaker 10 can be fixed to the structure 80 by the fixing surface 17. In such a manner, the ANC system 500 employing the piezoelectric speaker 10 can be configured. In the ANC system 500, the interposed layer 40 is disposed between the piezoelectric film 35 and the structure 80. In the illustrated example, the interposed layer 40 holds only one of two principal surfaces of the piezoelectric film 35.

It is likely that lower-frequency sound in the audible range is easily generated from the piezoelectric film 35 owing to the interposed layer 40 adequately holding one of the principal surfaces of the piezoelectric film 35, although the detail of the effect needs to be studied in the future. Given this, the piezoelectric speaker 10 can be configured so that the interposed layer 40 is disposed on a region accounting for 25% or more of the area of the piezoelectric film 35 when the piezoelectric film 35 is viewed in plan. The piezoelectric speaker 10 may be configured so that the interposed layer 40 is disposed on a region accounting for 50% or more of the area of the piezoelectric film 35, on a region accounting for 75% or more of the area of the piezoelectric film 35, or on the entire region of the piezoelectric film 35 when the piezoelectric film 35 is viewed in plan. Also, 50% or more of a principal surface 38 can be formed of the piezoelectric film 35. The principal surface 38 is one of principal surfaces of the piezoelectric speaker 10 and is opposite to the fixing surface 17 that is the other principal surface. 75% or more of the principal surface 38 may be formed of the piezoelectric film 35, or the entire principal surface 38 may be formed of the piezoelectric film 35.

In the first structure example, the second joining layer 52 prevents the piezoelectric film 35 and the interposed layer 40 from separating from each other. In view of adequate holding, which is mentioned above, the piezoelectric speaker 10 can be configured so that the second joining layer 52 and the interposed layer 40 are disposed on a region accounting for 25% or more of the area of the piezoelectric film 35 when the piezoelectric film 35 is viewed in plan. The piezoelectric speaker 10 may be configured so that the second joining layer 52 and the interposed layer 40 are disposed on a region accounting for 50% or more of the area of the piezoelectric film 35, on a region accounting for 75% or more of the area of the piezoelectric film 35, or on the entire region of the piezoelectric film 35 when the piezoelectric film 35 is viewed in plan.

In the case where the interposed layer 40 is a porous body, the rate of the region where the interposed layer 40 is disposed is defined not from a microscopical perspective in consideration of pores in the porous structure of the interposed layer 40, but rather from a relatively macroscopic perspective. For example, in the case where the piezoelectric film 35, the interposed layer 40 that is a porous body, and the second joining layer 52 are plate-like bodies having the same outline in plan, the second joining layer 52 and the interposed layer 40 are described as being disposed on a region accounting for 100% of the area of the piezoelectric film 35.

In the first structure example, the interposed layer 40 has a holding degree of 5×10⁹ N/m³ or less. The interposed layer 40 has a holding degree of, for example, 1×10⁴ N/m³ or more. The interposed layer 40 has a holding degree of preferably 5×10⁸ N/m³ or less, more preferably 2×10⁸ N/m³ or less, and even more preferably 1×10⁵ to 5×10⁷ N/m³. The holding degree (N/m³) of the interposed layer 40 is a value obtained by dividing a product of the elastic modulus (N/m²) of the interposed layer 40 and the surface filling area ratio of the interposed layer 40 by the thickness (m) of the interposed layer 40, as represented by the following equation. The surface filling area ratio of the interposed layer 40 is the filling area ratio (a value obtained by subtracting the porosity from 1) of the principal surface on the piezoelectric film 35 side of the interposed layer 40. In the case where pores of the interposed layer 40 are evenly distributed, the surface filling area ratio can be regarded as equal to a three-dimensionally determined filling area ratio of the interposed layer 40.

Holding degree (N/m³)=Elastic modulus (N/m²)×Surface filling area ratio÷Thickness (m)

The holding degree can be considered to be a parameter representing the degree of holding the piezoelectric film 35 by means of the interposed layer 40. The above equation indicates that the greater the elastic modulus of the interposed layer 40 is, the greater the degree of holding becomes. The above equation indicates that the greater the surface filling area ratio of the interposed layer 40 is, the greater the degree of holding becomes. The above equation indicates that the smaller the thickness of the interposed layer 40 is, the greater the degree of holding becomes. Although the relationship between the holding degree of the interposed layer 40 and sound generated from the piezoelectric film 35 needs to be studied in the future, it is likely that an excessively great holding degree prevents the piezoelectric film 35 from deforming, which is necessary to emit lower-frequency sound. On the other hand, in the case where the holding degree is excessively small, it is likely that the piezoelectric film 35 does not sufficiently deform in its thickness direction and extends and contracts only in its in-plane direction (the direction perpendicular to the thickness direction) and thus generation of lower-frequency sound is prevented. It is thought that since the holding degree of the interposed layer 40 is set within an adequate range, extension and contraction of the piezoelectric film 35 in the in-plane direction is adequately converted into deformation thereof in the thickness direction and that results in appropriate bending of the piezoelectric film 35 as a whole and makes it easy to generate lower-frequency sound.

As can be understood from the above description, there may be a layer other than the interposed layer 40 between the piezoelectric film 35 and the fixing surface 17. The other layer is, for example, the second pressure-adhesive layer 52.

The structure 80 may have a greater holding degree than that of the interposed layer 40. In this case as well, lower-frequency sound can be generated from the piezoelectric film 35 because of the contribution by the interposed layer 40. The structure 80 may have the same holding degree as that of the interposed layer 40, or may have a smaller holding degree than that of the interposed layer 40. The holding degree (N/m³) of the structure 80 is a value obtained by dividing a product of the elastic modulus (N/m²) of the structure 80 and the surface filling area ratio of the structure 80 by the thickness (m) of the structure 80. The surface filling area ratio of the structure 80 is the filling area ratio (a value obtained by subtracting the porosity from 1) of the principal surface on the piezoelectric film 35 side of the structure 80.

The structure 80 typically has a high stiffness (the product of Young's modulus and the second moment of area), a high Young's modulus, and/or a great thickness, compared to the interposed layer 40. The structure 80 may have the same stiffness, Young's modulus, and/or thickness as that of the interposed layer 40, or may have a lower stiffness, a lower Young's modulus, and/or a smaller thickness than that of the interposed layer 40. The Young's modulus of the structure 80 is, for example, 1 GPa or more, and may be 10 GPa or more, or 50 GPa or more. The upper limit of the Young's modulus of the structure 80 is not particularly limited, and is, for example, 1000 GPa.

In the illustrated example, the piezoelectric film 35 is not completely surrounded by the interposed layer 40. In the illustrated example, a virtual straight line passes through the interposed layer 40 and the piezoelectric film 35 in this order, and then reaches the outside of the speaker 10 without passing through the interposed layer 40. Here, the phrase “virtual straight line passes” means that such a straight line can be drawn. In the illustrated example, the interposed layer 40 extends only toward the fixing surface 17 when viewed from the piezoelectric film 35.

In the illustrated example, the principal surface 38, which is opposite to the fixing surface 17, of the piezoelectric film 35, forms the radiation surface 15. That is, the principal surface 38 is one of principal surfaces of the piezoelectric film 35 which is more distant from the interposed layer 40 than the other is, and forms the radiation surface 15. In this structure, since the principal surface of the piezoelectric film 35 on the interposed layer 40 side is held by the interposed layer 40, extension and contraction of the piezoelectric film 35 in the in-plane direction can be adequately converted into deformation thereof in the thickness direction. Other embodiments may be employed.

Specifically, a first layer may be provided on the opposite side of the piezoelectric film 35 from the interposed layer 40. For example, the first layer is used for protecting the piezoelectric film 35. In this case, a principal surface of the first layer can form the radiation surface 15. Alternatively, a second layer other than the first layer can form the radiation surface 15.

The thickness of the first layer is, for example, 0.05 mm to 5 mm. The material of the first layer is, for example, a polyester-based material. Here, the polyester-based material refers to a material containing polyester, and refers to a material that may contain 30% or more polyester, 45% or more polyester, 60% or more polyester, or 80% or more polyester. In an example, the material of the interposed layer 40 is different from the material of the first layer. In the case where the material of the interposed layer 40 is different from the material of the first layer, it is possible to make a difference between the degree to which the principal surface on the interposed layer 40 side of the piezoelectric film 35 is held and the degree to which the principal surface on the first layer side of the piezoelectric film 35 is held. This can allow to adequately convert extension and contraction of the piezoelectric film 35 in the in-plane direction into deformation thereof in the thickness direction. The holding degree of the interposed layer 40 may be different from the holding degree of the first layer. Here, the holding degree (N/m³) of the first layer is a value obtained by dividing the product of the elastic modulus (N/m²) of the first layer and the surface filling area ratio of the first layer by the thickness (m) of the first layer. The surface filling area ratio of the first layer is the filling area ratio (a value obtained by subtracting the porosity from 1) of the principal surface on the piezoelectric film 35 side of the first layer. The interposed layer 40 and the first layer differing from each other in holding degree can allow to adequately convert extension and contraction of the piezoelectric film 35 in the in-plane direction into deformation thereof in the thickness direction. In a specific example, the interposed layer 40 has a higher holding degree than the first layer has. The first layer may have the shape of a film. The first layer may be non-woven fabric.

In the first structure example, the fixing surface 17 is disposed so that at least a portion of the piezoelectric film 35 overlaps the fixing surface 17 (the first joining layer 51 in the example in FIG. 9) when the piezoelectric film 35 is viewed in plan. In view of stably fixing the piezoelectric speaker 10 to the structure 80, the piezoelectric speaker 10 can be configured so that the fixing surface 17 is disposed on a region accounting for 50% or more of the area of the piezoelectric film 35 when the piezoelectric film 35 is viewed in plan. The piezoelectric speaker 10 may be configured so that the fixing surface 17 is disposed on a region accounting for 75% or more of the area of the piezoelectric film 35 or on the entire region of the piezoelectric film 35 when the piezoelectric film 35 is viewed in plan.

In the first structure example, adjacent layers between the piezoelectric film 35 and the fixing surface 17 are joined to each other. Here, the phrase “between the piezoelectric film 35 and the fixing surface 17” includes the piezoelectric film 35 and the fixing surface 17. Specifically, the first joining layer 51 and the interposed layer 40 are joined to each other, the interposed layer 40 and the second joining layer 52 are joined to each other, and the second joining layer 52 and the piezoelectric film 35 are joined to each other. This allows the piezoelectric film 35 to be stably disposed regardless of the orientation in which the piezoelectric film 35 is attached to the structure 80. This also makes it easy to attach the piezoelectric film 35 to the structure 80. Moreover, because of the contribution of the interposed layer 40, sound is emitted from the piezoelectric film 35 regardless of the orientation in which the piezoelectric film 35 is attached. Thus, in the first structure example, the combination of these allows achievement of a piezoelectric speaker of high usability. The phrase “adjacent layers are joined to each other” means that the adjacent layers are entirely or partially joined to each other. In the illustrated examples, the adjacent layers are joined to each other in a predetermined region extending along the thickness direction of the piezoelectric film 35 and passing through the piezoelectric film 35, the interposed layer 40, and the fixing surface 17 in this order.

In the first structure example, the piezoelectric film 35 and the interposed layer 40 each have a substantially uniform thickness. This is often advantageous from various points of view, for example, in view of storage of the piezoelectric speaker 10, the usability thereof, and control of sound emitted from the piezoelectric film 35. Having a “substantially uniform thickness” refers to, for example, having the smallest thickness which is 70% or more and 100% or less of the largest thickness. The smallest thickness of each of the piezoelectric film 35 and the interposed layer 40 may be 85% or more and 100% or less of the largest thickness.

Resin is a material less likely to be cracked than, for example, ceramics. In a specific example, the piezoelectric body 30 of the piezoelectric film 35 is a resin film and the interposed layer 40 is a resin layer not functioning as a piezoelectric film. This specific example is advantageous in view of cutting the piezoelectric speaker 10, for example, with scissors or by hand without cracking the piezoelectric body 30 or the interposed layer 40 (the fact that the piezoelectric speaker 10 is cuttable, for example, with scissors or by hand contributes to greater design flexibility of the ANC system 500 and facilitates to configure the ANC system 500). Additionally, in this specific example, the piezoelectric body 30 or the interposed layer 40 is less likely to be cracked even when the piezoelectric speaker 10 is bent. Moreover, the piezoelectric body 30 being a resin film and the interposed layer 40 being a resin layer are advantageous in view of fixing the piezoelectric speaker 10 onto a curved surface without cracking the piezoelectric body 30 or the interposed layer 40.

In the example in FIG. 9, the piezoelectric film 35, the interposed layer 40, the first joining layer 51, and the second joining layer 52 share the same outline when viewed in plan. Their outlines may be misaligned.

In the example in FIG. 9, the piezoelectric film 35, the interposed layer 40, the first joining layer 51, and the second joining layer 52 are each a rectangle having a short side and a long side when viewed in plan. The piezoelectric film 35, the interposed layer 40, the joining layer 51, and the second joining layer 52 each may be, for example, a square, a circle, or an oval.

The piezoelectric speaker 10 may also include a layer other than the layers shown in FIG. 9. The layer other than the layer layers shown in FIG. 9 is, for example, the first layer and the second layer described above.

### Second Structure Example of Piezoelectric Speaker 10

A piezoelectric speaker 110 according to a second structure example will be described with reference to FIG. 11. The features the same as or similar to those of the first structure example may not be described hereinafter.

The piezoelectric speaker 110 includes the piezoelectric film 35, a fixing surface 117, and an interposed layer 140. The fixing surface 117 can be used to fix the piezoelectric film 35 to the structure 80.

The interposed layer 140 is disposed between the piezoelectric film 35 and the fixing surface 117. (The phrase “between the piezoelectric film 35 and the fixing surface 117” includes the fixing surface 117. The same applies to the first structure example.) The fixing surface 117 is formed of a surface (principal surface) of the interposed layer 140.

The interposed layer 140 is a porous body layer and/or a resin layer. The interposed layer 140 is a pressure-sensitive adhesive layer or an adhesive layer. A pressure-sensitive adhesive including an acrylic resin can be used as the interposed layer 140. Another pressure-sensitive adhesive, for example, a pressure-sensitive adhesive including rubber, silicone, or urethane may be used as the interposed layer 140. The interposed layer 140 may be a blended layer including two or more materials.

The elastic modulus of the interposed layer 140 is, for example, 10000 N/m² to 20000000 N/m², and may be 20000 N/m² to 100000 N/m².

The interposed layer 140 in an uncompressed state has a thickness of, for example, 0.1 mm to 30 mm, and may have a thickness of 1 mm to 30 mm, 1.5 mm to 30 mm, or 2 mm to 25 mm. The interposed layer 140 in an uncompressed state is typically thicker than the piezoelectric film 35 in an uncompressed state. The thickness of the interposed layer 140 in an uncompressed state is, for example, 3 or more times the thickness of the piezoelectric film 35 in an uncompressed state, and may be 10 or more times or 30 or more times the thickness of the piezoelectric film 35 in an uncompressed state.

In the second structure example, the interposed layer 140 has a holding degree of 5×10⁹ N/m³ or less. The interposed layer 140 has a holding degree of, for example, 1×10⁴ N/m³ or more. The interposed layer 140 has a holding degree of preferably 5×10⁸ N/m³ or less, more preferably 2×10⁸ N/m³ or less, and even more preferably 1×10⁵ to 5×10⁷ N/m³. The definition of the holding degree is as described previously.

In the second structure example, the piezoelectric film 35 is integrated with the layer on the fixing surface 117 side by bringing an adhesive surface or a pressure-sensitive adhesive surface into contact with the piezoelectric film 35. Specifically, in the second structure example, the adhesive surface or the pressure-sensitive adhesive surface is a face formed of the interposed layer 140.

The piezoelectric speaker 110 can also be fixed to the structure 80 by the fixing surface 117. In such a manner, it is possible to configure the ANC system 500 employing a plurality of the piezoelectric speakers 110 according to the second structure example.

The ANC system 500 may be configured by using at least one piezoelectric speaker 10 according to the first structure example and at least one piezoelectric speaker 10 according to the second structure example.

### Experimental Examples

The present invention will be described in detail with use of experimental examples. It should be noted that the experimental examples given below are only illustrative of the present invention and do not limit the present invention.

(Sample E1)

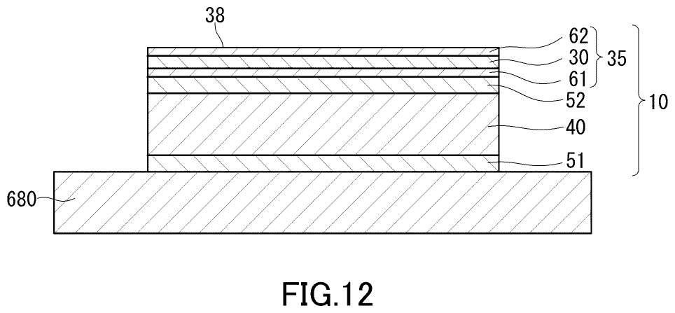

The fixing surface 17 of the piezoelectric speaker 10 was stuck to a supporting member 680 fixed. A structure shown in FIG. 12 was thus produced. Specifically, a 5-mm-thick stainless steel plate (SUS plate) was used as the supporting member 680. A 0.16-mm-thick pressure-sensitive adhesive sheet (double-faced tape) including non-woven fabric both sides of which were impregnated with an acrylic pressure-sensitive adhesive was used as the first joining layer 51. A 3-mm-thick closed-cell foam obtained by foaming a mixture including ethylene propylene rubber and butyl rubber by a foaming factor of about 10 was used as the interposed layer 40. A 0.15-mm-thick pressure-sensitive adhesive sheet (double-faced tape) including non-woven fabric as a substrate having both sides to which a pressure-sensitive adhesive including a solventless acrylic resin was applied was used as the second joining layer 52. A polyvinylidene fluoride film (total thickness of 33 μm) having both sides on which copper electrodes (including nickel) were vapor-deposited was used as the piezoelectric film 35. The first joining layer 51, the interposed layer 40, the second joining layer 52, and the piezoelectric film 35 of Sample E1 each have a dimension of 37.5 mm in the lateral direction and a dimension of 37.5 mm in the longitudinal direction when viewed in plan, each have the shape of a plate which is neither divided nor frame-shaped, and have outlines overlapping when viewed in plan. (The same applies to Samples E2 to E17 and R1 described later.) The supporting member 680 has a dimension of 50 mm in the lateral direction and a dimension of 50 mm in the longitudinal direction when viewed in plan and covers the entire first joining layer 51. Sample E1 having the structure shown in FIG. 12 was produced in this manner.

(Sample E2)

A 3-mm-thick semi-open-/semi-closed-cell foam obtained by foaming a mixture including ethylene propylene rubber by a foaming factor of about 10 was used as an interposed layer 40. This foam includes sulfur. Sample E2 that is the same as Sample E1 except the above was produced.

(Sample E3)

A 5-mm-thick foam formed of the same material and having the same structure as those of the interposed layer 40 of Sample E2 was used as an interposed layer 40 in Sample E3. Sample E3 that is the same as Sample E2 except the above was produced.

(Sample E4)

A 10-mm-thick foam formed of the same material and having the same structure as those of the interposed layer 40 of Sample E2 was used as an interposed layer 40 in Sample E4. Sample E4 that is the same as Sample E2 except the above was produced.

(Sample E5)

A 20-mm-thick foam formed of the same material and having the same structure as those of the interposed layer 40 of Sample E2 was used as an interposed layer 40 in Sample E5. Sample E5 that is the same as Sample E2 except the above was produced.

(Sample E6)

A 20-mm-thick semi-open-/semi-closed-cell foam obtained by foaming a mixture including ethylene propylene rubber by a foaming factor of about 10 was used as an interposed layer 40. This foam does not include sulfur and is more flexible than the foams used as the interposed layers 40 of Samples E2 to E5. Sample E6 that is the same as Sample E1 except the above was produced.

(Sample E7)

A 20-mm-thick semi-open-/semi-closed-cell foam obtained by foaming a mixture including ethylene propylene rubber by a foaming factor of about 20 was used as an interposed layer 40. Sample E7 that is the same as Sample E1 except the above was produced.

(Sample E8)

A porous metal body was used as an interposed layer 40. This porous metal body is made of nickel and has a pore diameter of 0.9 mm and a thickness of 2.0 mm. A pressure-sensitive adhesive layer that is the same as a first joining layer 51 as used in Sample E1 was used as a second joining layer 52. Sample E8 that is the same as Sample E1 except the above was produced.

(Sample E9)

A first joining layer 51 and a second joining layer 52 as used in Sample E1 were omitted, and only an interposed layer 140 was interposed between a piezoelectric film 35 and a structure 80 as used in Sample E1. A 3-mm-thick substrate-less pressure-sensitive adhesive sheet formed of an acrylic pressure-sensitive adhesive was used as the interposed layer 140. Sample E9 was produced that is the same as Sample E1 except the above, which has the structure in which the laminate of FIG. 11 is attached to the supporting member 680 of FIG. 12.

(Sample E10)

An interposed layer that is the same as an interposed layer 140 as used in Sample E9 was used as an interposed layer 40. Sample E10 that is the same as Sample E8 except the above was produced.

(Sample E11)

A 5-mm-thick urethane foam was used as an interposed layer 40. Sample E11 that is the same as Sample E8 except the above was produced.

(Sample E12)

A 10-mm-thick urethane foam was used as an interposed layer 40. This urethane foam has a smaller pore diameter than that of the urethane foam used as the interposed layer 40 of Sample E11. Sample E12 that is the same as Sample E8 except the above was produced.

(Sample E13)

A 5-mm-thick closed-cell acrylonitrile butadiene rubber foam was used as an interposed layer 40. Sample E13 that is the same as Sample E8 except the above was produced.

(Sample E14)

A 5-mm-thick closed-cell ethylene propylene rubber foam was used as an interposed layer 40. Sample E14 that is the same as Sample E8 except the above was produced.

(Sample E15)

A 5-mm-thick closed-cell foam in which natural rubber and styrene-butadiene rubber are blended was used as an interposed layer 40. Sample E15 that is the same as Sample E8 except the above was produced.

(Sample E16)

A 5-mm-thick closed-cell silicone foam was used as an interposed layer 40. Sample E16 that is the same as Sample E8 except the above was produced.

(Sample E17)

A 10-mm-thick foam formed of the same materials and having the same structure as those of the interposed layer 40 of Sample E1 was used as an interposed layer 40. A pressure-sensitive adhesive sheet that is the same as that in Sample E1 was used as a second joining layer 52. A 35-μm-thick resin sheet including a corn-derived polylactic acid as a main raw material was used as a piezoelectric body 30 of a piezoelectric film 35. A first electrode 61 and a second electrode 62 of the piezoelectric film 35 are each formed of a 0.1-μm-thick aluminum film and were formed by vapor deposition. The piezoelectric film 35 having a total thickness of 35.2 μm was thus obtained. Sample E17 that is the same as Sample E1 except the above was produced.

(Sample R1)

A piezoelectric film 35 as used in Sample E1 was employed as Sample R1. In Sample R1, the sample was placed on a board parallel to the ground without being adhered to the board.

The methods for evaluation of Samples E1 to E17 and R1 are as follows.

<Thickness of Interposed Layer (Uncompressed State)>

The thickness of each of the interposed layers was measured by using a thickness gauge.

<Elastic Modulus of Interposed Layer>

A small piece was cut out from each of the interposed layers. The small piece was subjected to a compression test at ordinary temperature by using a tensile tester (“RSA-G2” manufactured by TA Instruments). A stress-strain curve was thus obtained. The elastic modulus was calculated from the initial slope of the stress-strain curve.

<Pore Diameter of Interposed Layer>

An enlarged image of each of the interposed layers was obtained by using a microscope. The average of the pore diameters of the interposed layer was determined by image analysis of the enlarged image. The average thus determined was employed as the pore diameter of the interposed layer.

<Porosity of Interposed Layer>

A small rectangular cuboid piece was cut out from each of the interposed layers. The apparent density was determined from the volume and the mass of the small rectangular cuboid piece. The apparent density was divided by the density of a matrix (solid, or non-hollow, body) forming the interposed layer. The filling area ratio was thus calculated. Then, the filling area ratio was subtracted from 1. The porosity was thus obtained.

<Surface Filling Area Ratio of Interposed Layer>

For Samples E2 to E16, the filling area ratio calculated as above is employed as the surface filling area ratio. For Samples E1 and E17, the surface filling area ratio is 100% because the interposed layers have a surface skin layer.

<Frequency Characteristics of Sample in Terms of Sound Pressure Level>

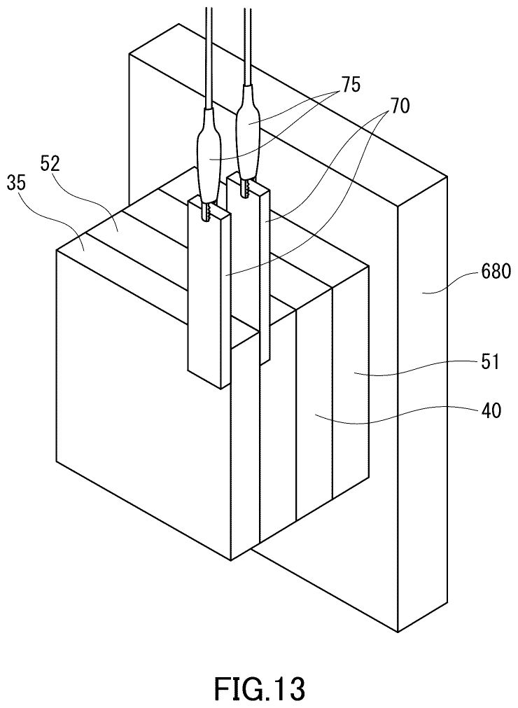

A measurement structure for Samples E1 to E8 and E10 to E17 is shown in FIG. 13. An electrically conductive copper foil tape 70 (CU-35C manufactured by 3M) having a dimension of 70 μm in the thickness direction, a dimension of 70 mm in the lateral direction and a dimension of 5 mm in the longitudinal direction was attached to a corner of each side of the piezoelectric film 35. An alligator clip 75 with a cover was attached to each of the electrically conductive copper foil tapes 70. The electrically conductive copper foil tapes 70 and the alligator clips 75 with covers compose a portion of an electrical pathway used for application of AC voltage to the piezoelectric film 35.

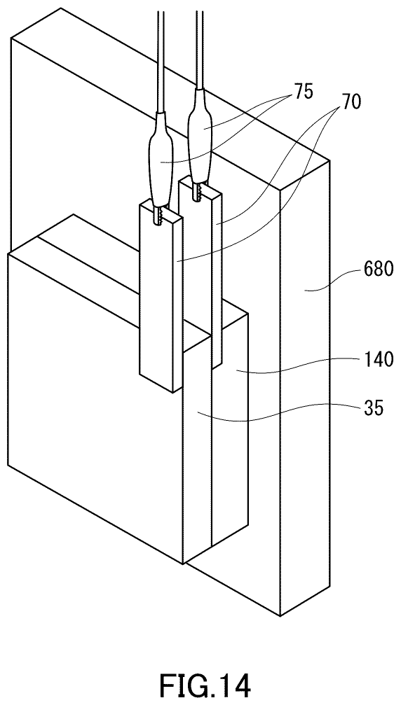

A measurement structure for Sample E9 is shown in FIG. 14. The structure in FIG. 14 lacks the first joining layer 51 and the second joining layer 52 of FIG. 13. The structure in FIG. 14 includes the interposed layer 140.

A measurement structure for Sample R1 is based on the structures of FIG. 13 and FIG. 14. Specifically, as in FIG. 13 and FIG. 14, an electrically conductive copper foil tape 70 was attached to a corner of each side of the piezoelectric film 35, and an alligator clip 75 with a cover was attached to each of the tapes 70. The resulting assembly was placed on a board parallel to the ground without being adhered to the board.

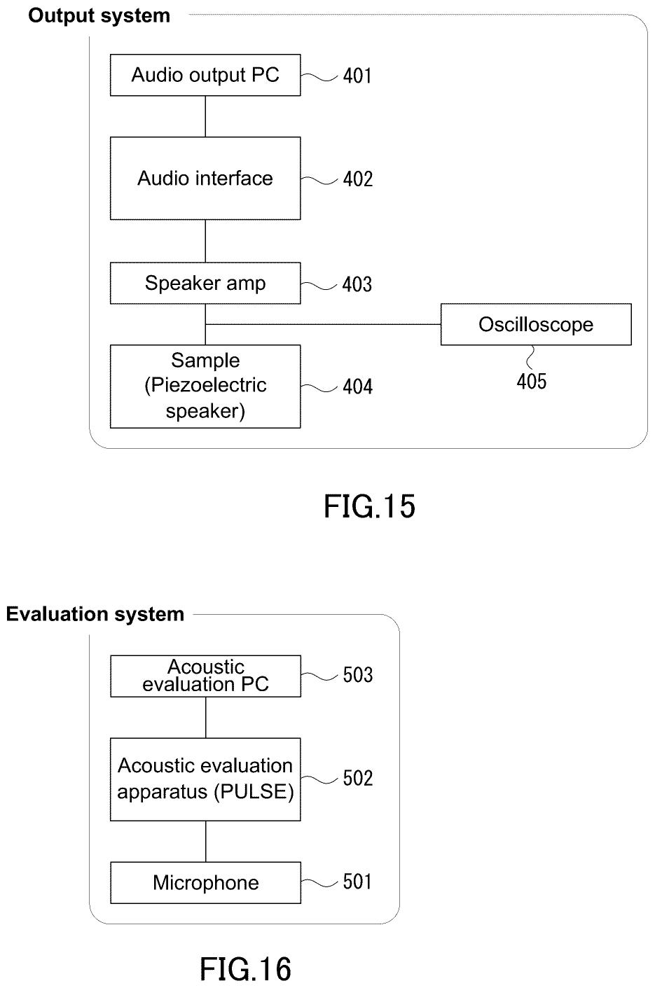

Block diagrams for measurement of the acoustic characteristics of the samples are shown in FIG. 15 and FIG. 16. Specifically, an output system is shown in FIG. 15, and an evaluation system is shown in FIG. 16.

In the output system shown in FIG. 15, an audio output personal computer (hereinafter, a personal computer is also referred to simply as a PC) 401, an audio interface 402, a speaker amp 403, a sample 404 (any of the piezoelectric speakers of Samples E1 to E17 and R1) were connected in this order. The speaker amp 403 was also connected to an oscilloscope 405 so that output from the speaker amp 403 to the sample 404 could be monitored.

WaveGene was installed in the audio output PC 401. WaveGene is free software for generation of a test audio signal. QUAD-CAPTURE manufactured by Roland Corporation was used as the audio interface 402. The sampling frequency of the audio interface 402 was set to 192 kHz. A-924 manufactured by Onkyo Corporation was used as the speaker amp 403. DPO2024 manufactured by Tektronix, Inc. was used as the oscilloscope 405.

In the evaluation system shown in FIG. 16, a microphone 501, an acoustic evaluation apparatus (PULSE) 502, and an acoustic evaluation PC 503 were connected in this order.

Type 4939-C-002 manufactured by Bruel & Kjaer Sound & Vibration Measurement NS was used as the microphone 501. The microphone 501 was disposed 1 m away from the sample 404. Type 3052-A-030 manufactured by Bruel & Kjaer Sound & Vibration Measurement NS was used as the acoustic evaluation apparatus 502.

The output system and the evaluation system were configured in the above manners. AC voltage was applied from the audio output PC 401 to the sample 404 via the audio interface 402 and the speaker amp 403. Specifically, a test audio signal whose frequency sweeps from 100 Hz to 100 kHz in 20 seconds was generated by using the audio output PC 401. During this, voltage output from the speaker amp 403 was monitored by using the oscilloscope 405. Additionally, sound generated from the sample 404 was evaluated by using the evaluation system. A test for measurement of the sound pressure frequency characteristics was performed in this manner.

The details of the output system and evaluation system settings are as follows.

[Output System Settings]
Frequency range: 100 Hz to 100 kHz
Sweep time: 20 seconds
Effective voltage: 10 V
Output waveform: sine curve

[Evaluation System Settings]
Measurement time: 22 seconds
Peak hold
Measurement range: 4 Hz to 102.4 kHz
Number of lines: 6400

<Determination of Frequency at which Emission of Sound Starts>

The lower end of a frequency domain (exclusive of a sharp peak portion in which a frequency range where the sound pressure level is maintained higher than that of background noise by +3 dB or more falls within ±10% of a peak frequency (a frequency at which the sound pressure level reaches a peak)) where the sound pressure level is higher than that of background noise by 3 dB or more was determined as a frequency at which emission of sound starts.

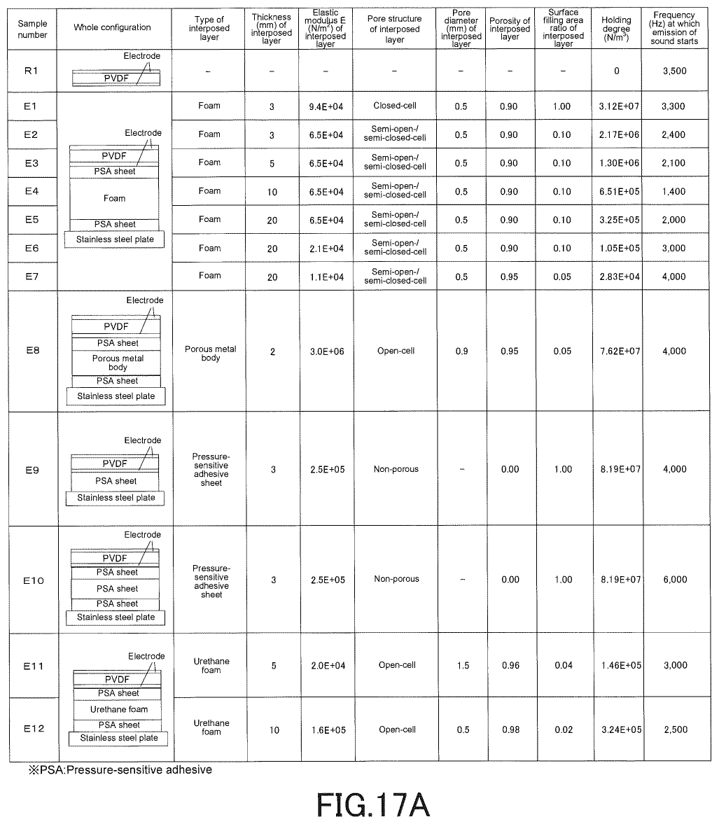

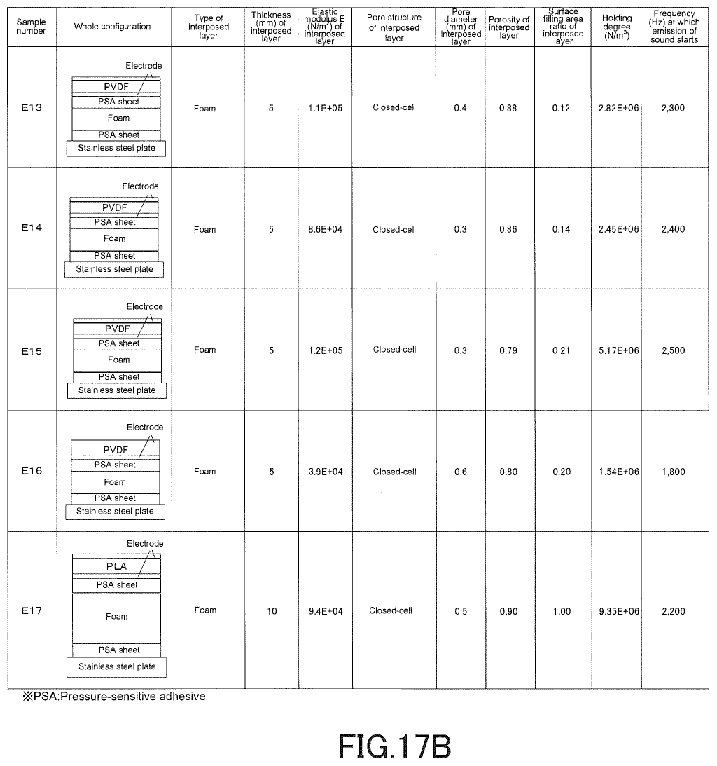

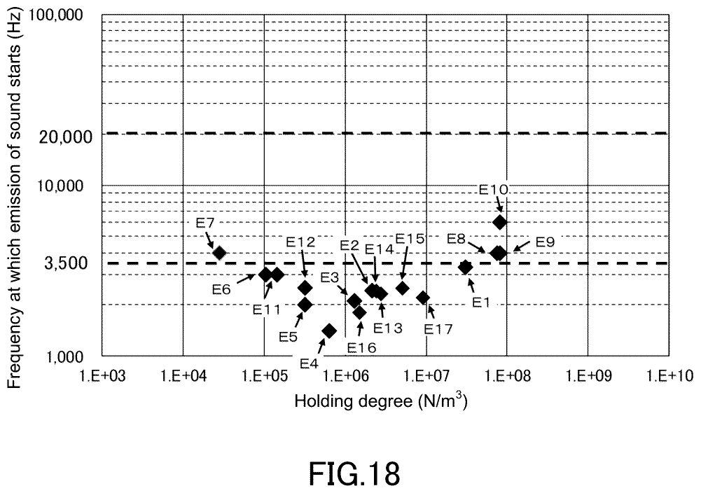

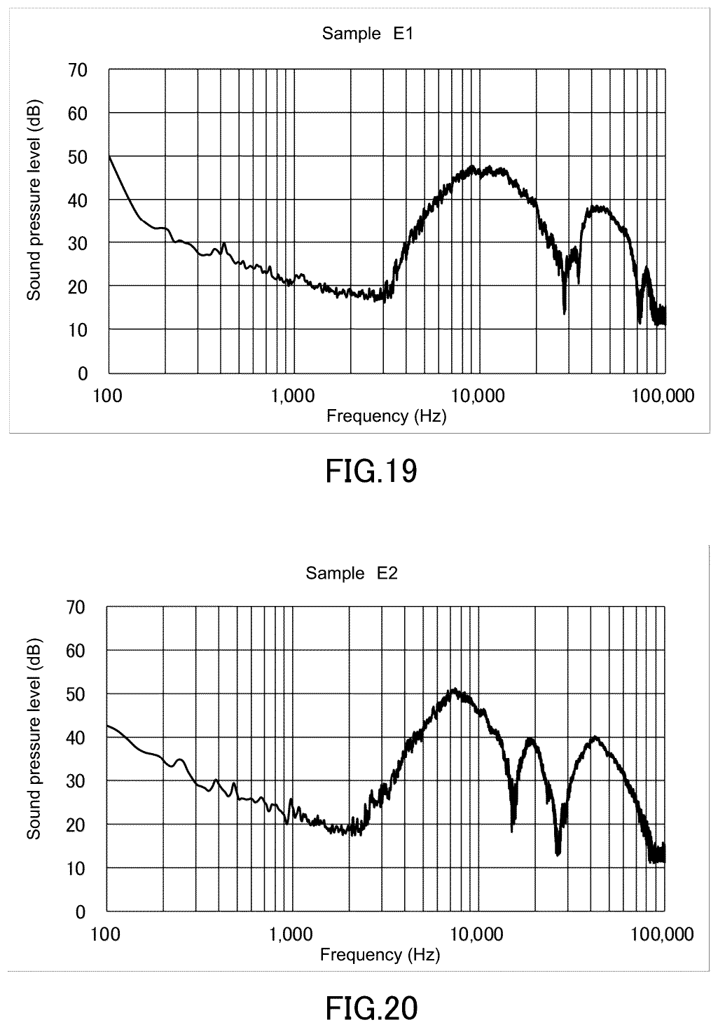

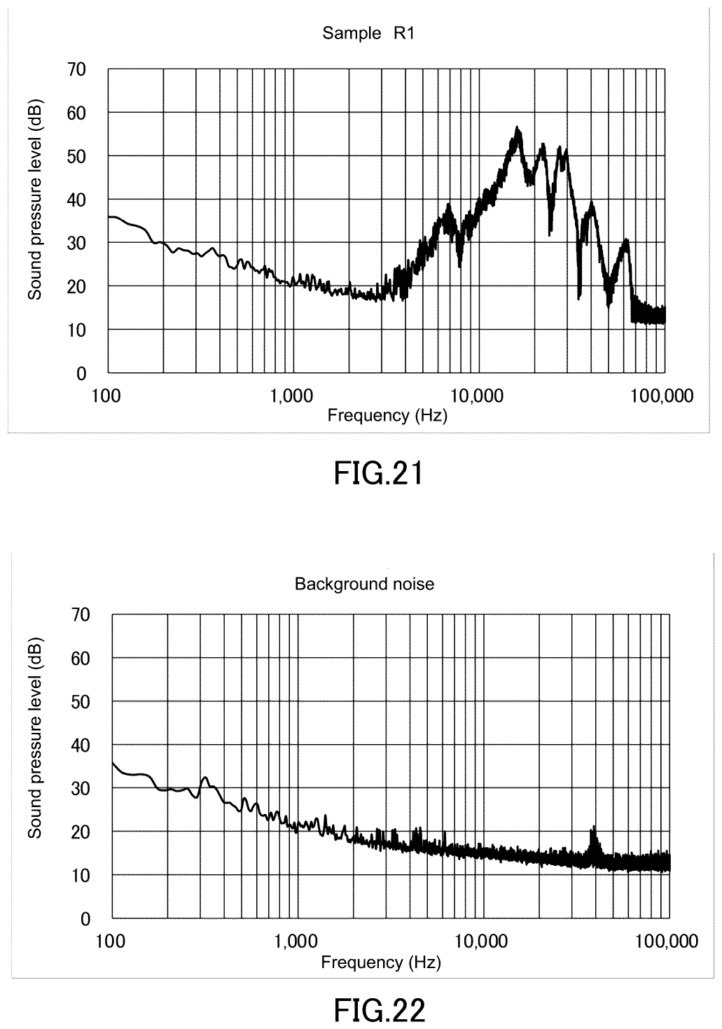

FIG. 17A and FIG. 17B show the evaluation results for Samples E1 to E17 and R1. FIG. 18 shows the relationship between the holding degree and the frequency at which emission of sound starts for Samples E1 to E17. In FIG. 18, reference numerals E1 to E17 respectively correspond to Samples E1 to E17. FIG. 19, FIG. 20, and FIG. 21 show the frequency characteristics of Samples E1, E2, and R1 in terms of sound pressure level. FIG. 22 shows the frequency characteristics of background noise in terms of sound pressure level.

[Evaluation of Reference ANC System]

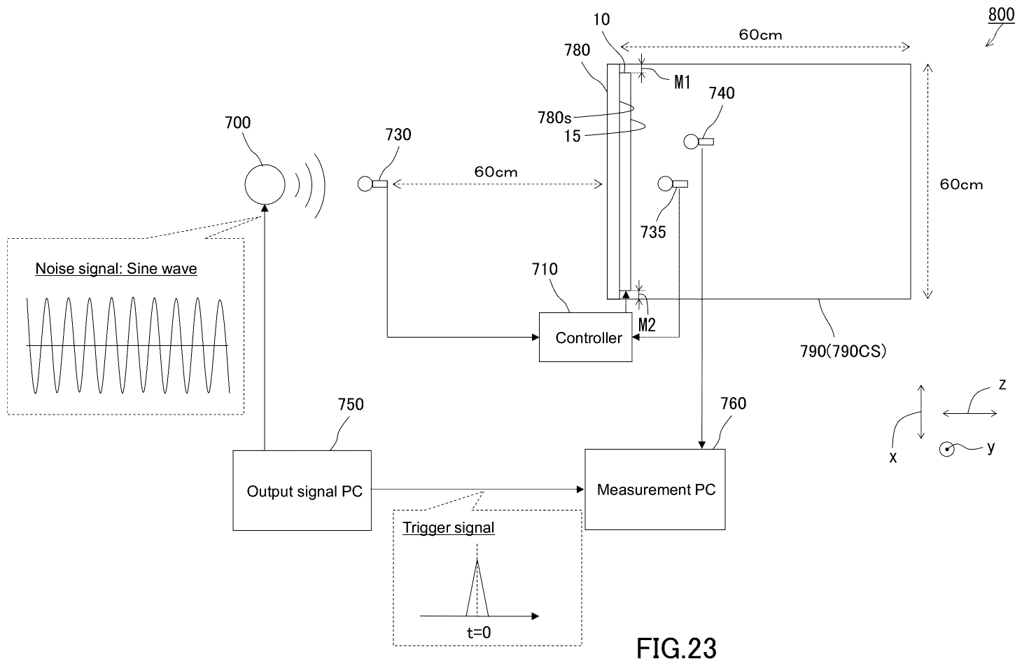

An ANC evaluation system 800 shown in FIG. 23 was configured by using a piezoelectric speaker 10 the same as the piezoelectric speaker 10 of Sample E1 except that the plan view dimensions of the piezoelectric speaker 10 were set to 50 cm in the lateral direction and 35 cm in the longitudinal direction. The number of the piezoelectric speakers 10 used in the reference ANC evaluation system 800 is one.

The piezoelectric speaker 10 was attached to a surface 780s of a partition 780. A noise source 700, a reference microphone 730, the partition 780, the piezoelectric speaker 10, and an error microphone 735 were disposed so that the noise source 700, the reference microphone 730, the center of the partition 780, the center of the piezoelectric speaker 10, and the error microphone 735 were arranged in this order on a straight line. A control region 790 was set on the piezoelectric speaker 10 side when viewed from the partition 780. A measurement microphone 740 was disposed in the control region 790.

In FIG. 23, the x direction is the lateral direction of the control region 790, the y direction is the longitudinal direction of the control region 790, and the z direction is the depth direction of the control region 790. The x direction, the y direction, and the z direction are directions orthogonal to each other.

The z direction is also the direction along which the noise source 700, the reference microphone 730, the center of the partition 780, the center of the piezoelectric speaker 10, and the error microphone 735 are arranged. The z direction is further the direction in which the radiation surface 15 of the piezoelectric speaker 10 faces.

The noise source 700 used was Eclipse TD508MK3 manufactured by Fujitsu Ten Limited. The partition 780 used was Desk side screen R manufactured by Mihashi kougei, Inc. The reference microphone 730 used was ECM-PC60 manufactured by Sony Corporation. The error microphone 735 used was ECM-PC60 manufactured by Sony Corporation. The measurement microphone 740 used was ECM-PC60 manufactured by Sony Corporation.

The distance between the noise source 700 and the reference microphone 730 is 5 cm. The distance between the reference microphone 730 and the partition 780 is 60 cm. The distance between the radiation surface 15 of the piezoelectric speaker 10 and the error microphone 735 is 17.5 cm. These distances are the dimensions in the z direction.

The partition 780 has a rectangular plate-like shape in plan view. The partition 780 has a dimension of 60 cm in the lateral direction, a dimension of 45 cm in the longitudinal direction, and a dimension of 0.5 cm in the thickness direction. The control region 790 has a dimension of 60 cm in the lateral direction, a dimension of 45 cm in the longitudinal direction, and a dimension of 60 cm in the depth direction. These lateral directions are the x direction. These longitudinal directions are the y direction. These thickness direction and depth directions are the z direction.

Further, the lateral direction of the piezoelectric speaker 10, namely, the direction along the 50-cm length of the piezoelectric speaker 10 is the x direction. The longitudinal direction of the piezoelectric speaker 10, namely, the direction along the 35-cm length of the piezoelectric speaker 10 is the y direction. The thickness direction of the piezoelectric speaker 10 is the z direction.

The left margin M1 is 5 cm and the right margin M2 is 5 cm. The margins M1 and M2 are the dimensions in the x direction.

In the ANC evaluation system 800, an output signal personal computer (PC) 750, a measurement PC 760, and a controller 710 were used. The output signal PC 750 was connected to the noise source 700 and the measurement PC 760.

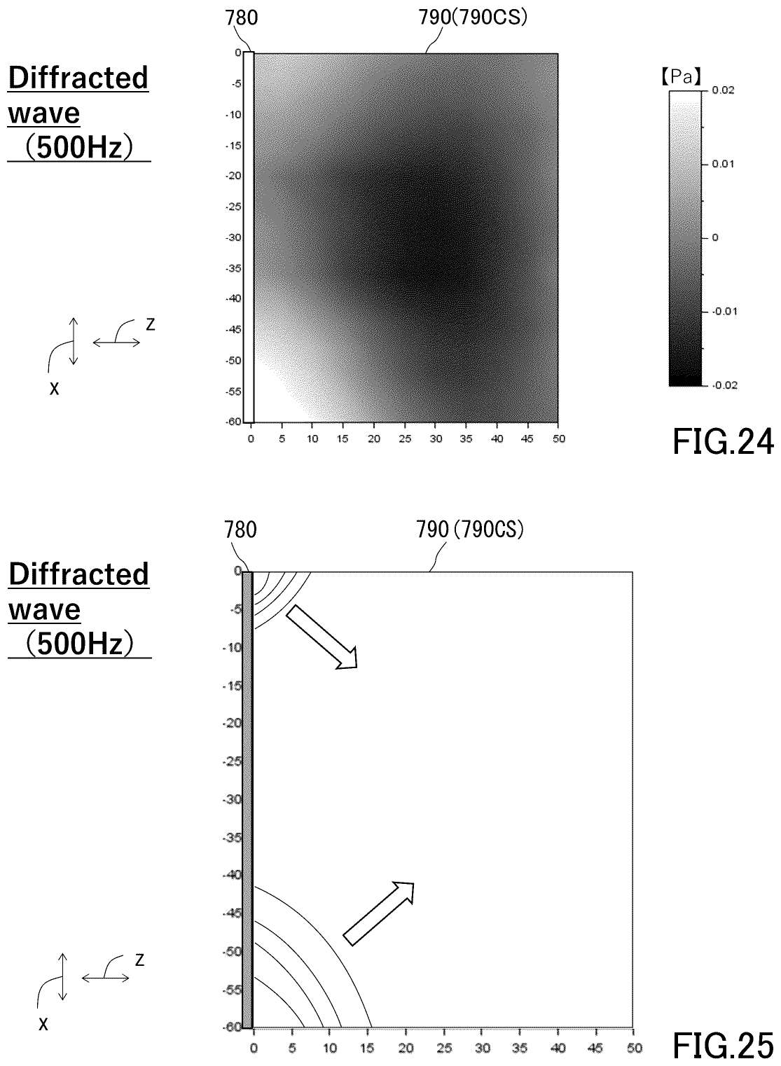

The output signal PC 750 transmits a noise signal to the noise source 700. The output signal PC 750 thus causes the noise source 700 to radiate a sine wave. Also, the output signal PC 750 transmits a trigger signal to the measurement PC 760. The trigger signal enables to give a common reference time to each measurement data piece. Specifically, sound pressure data pieces with the uniform time axis can be obtained for 176 measurement points described later. This enables mapping of sound pressure distributions shown in FIG. 24 to FIG. 39 described later.

The reference microphone 730 detects sound from the noise source 700. An output signal of the reference microphone 730 is transmitted to the controller 710.

The error microphone 735 detects sound in the control region 790. An output signal of the error microphone 735 is transmitted to the controller 710.

On the basis of the output signals of the reference microphone 730 and the error microphone 735, the controller 710 transmits a control signal to the piezoelectric speaker 10. The controller 710 thus controls a sound wave to be radiated from the piezoelectric speaker 10.

The measurement microphone 740 detects sound at a position where the measurement microphone 740 is disposed. An output signal of the measurement microphone 740 is transmitted to the measurement PC 760.

The measurement PC 760 receives the trigger signal from the output signal PC 750 and the output signal of the measurement microphone 740.

The control region 790 has a measurement cross section 790CS extending in the x direction and the z direction. In the ANC evaluation system 800, 176 measurement points are provided on the measurement cross section 790CS. Specifically, the measurement cross section 790CS is divided equally into 11 pieces in the x direction and is divided equally into 16 pieces in the z direction. The number of measurement points, 176, is the product of 11, which is the number of divisions in the x direction, and 16, which is the number of divisions in the z direction. The position of the measurement cross section 790CS in the y direction is the same as the center position of the radiation surface 15 in they direction. The error microphone 735 is provided on the measurement cross section 790CS.

In the ANC evaluation system 800, the measurement microphone 740 is successively moved to the 176 measurement points. Thus, in cooperation with the measurement PC 760, the microphone 740 measures the sound pressures at the 176 measurement points. Specifically, the measurement PC 760 maps the distribution of the sound pressures at the 176 measurement points. This mapping visualizes the sound field of the measurement cross section 790CS.

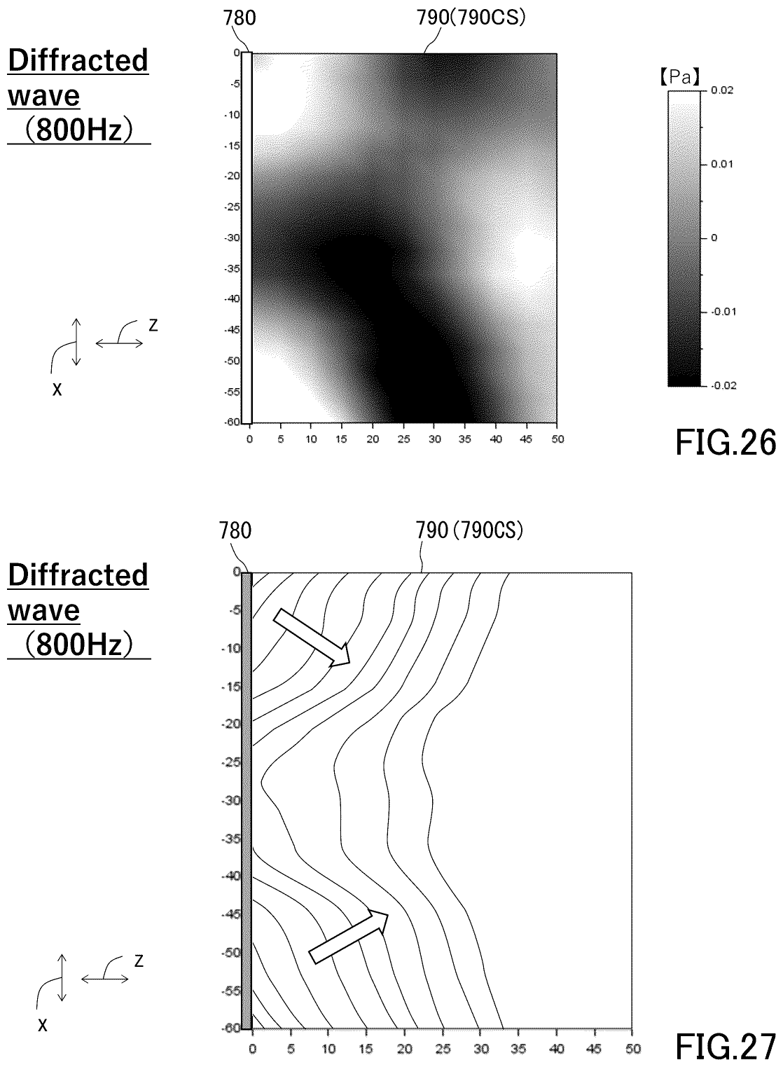

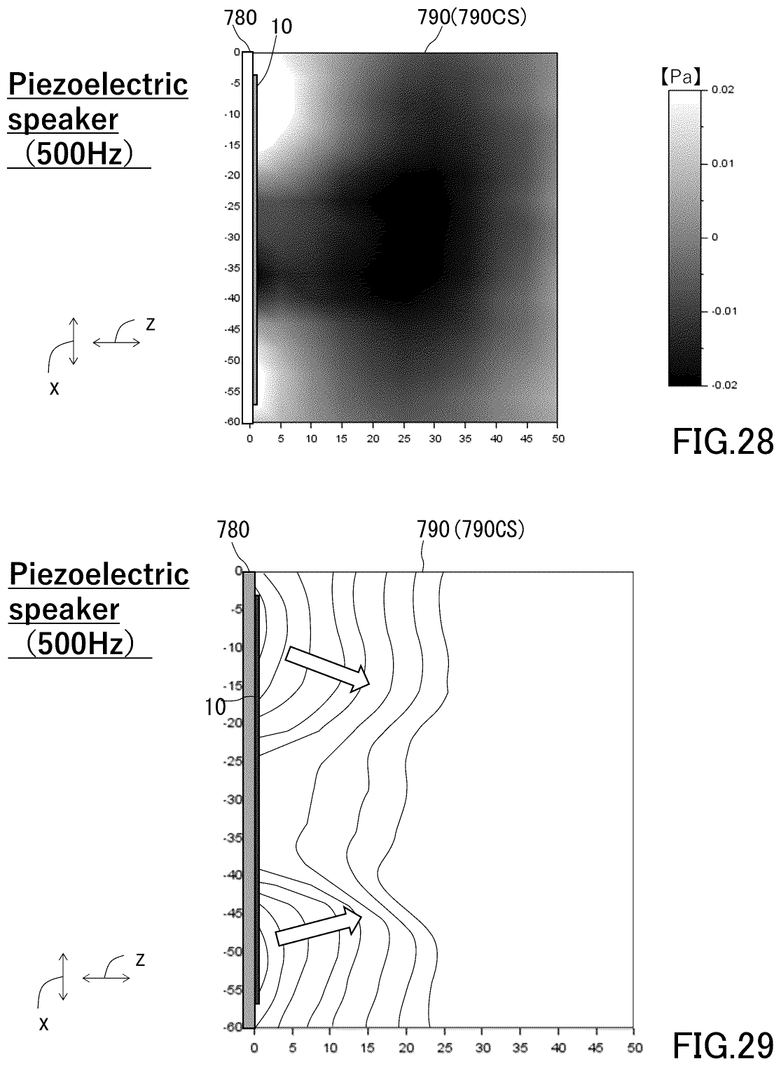

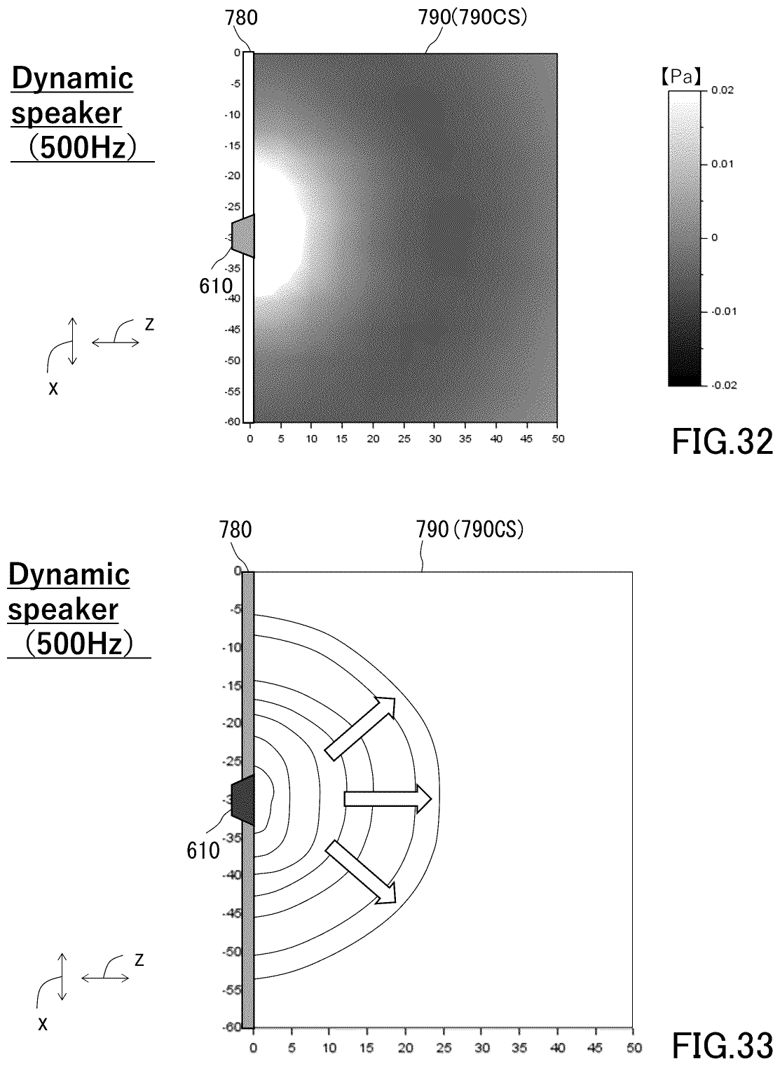

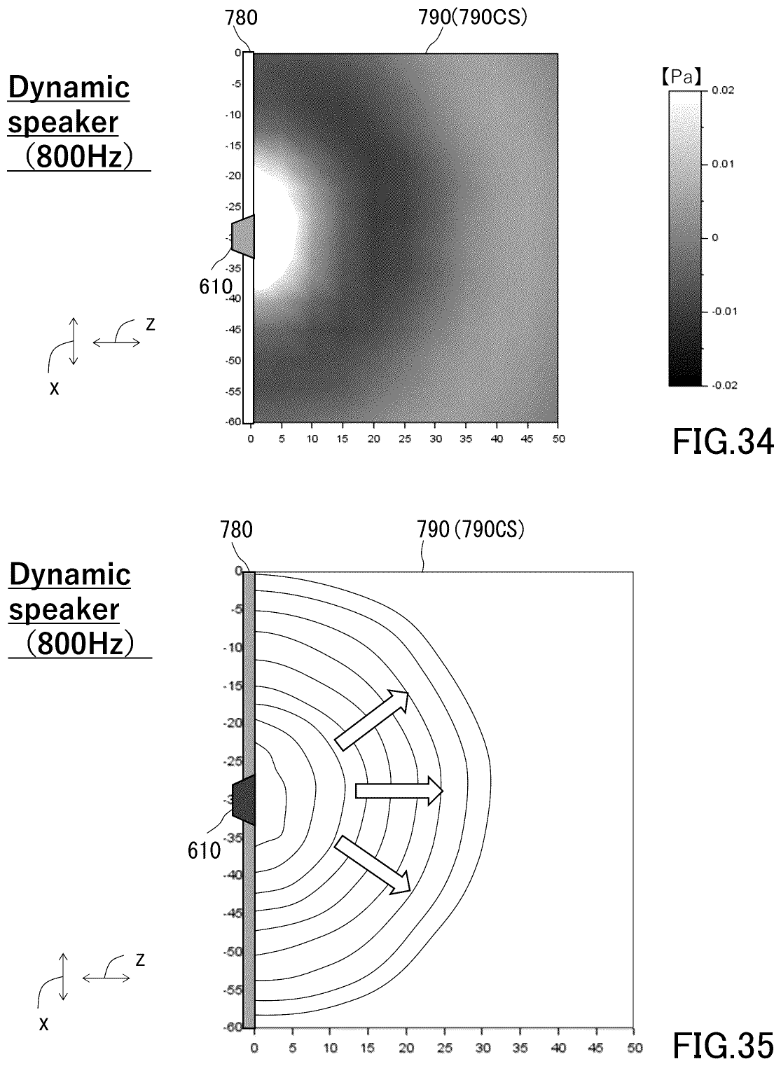

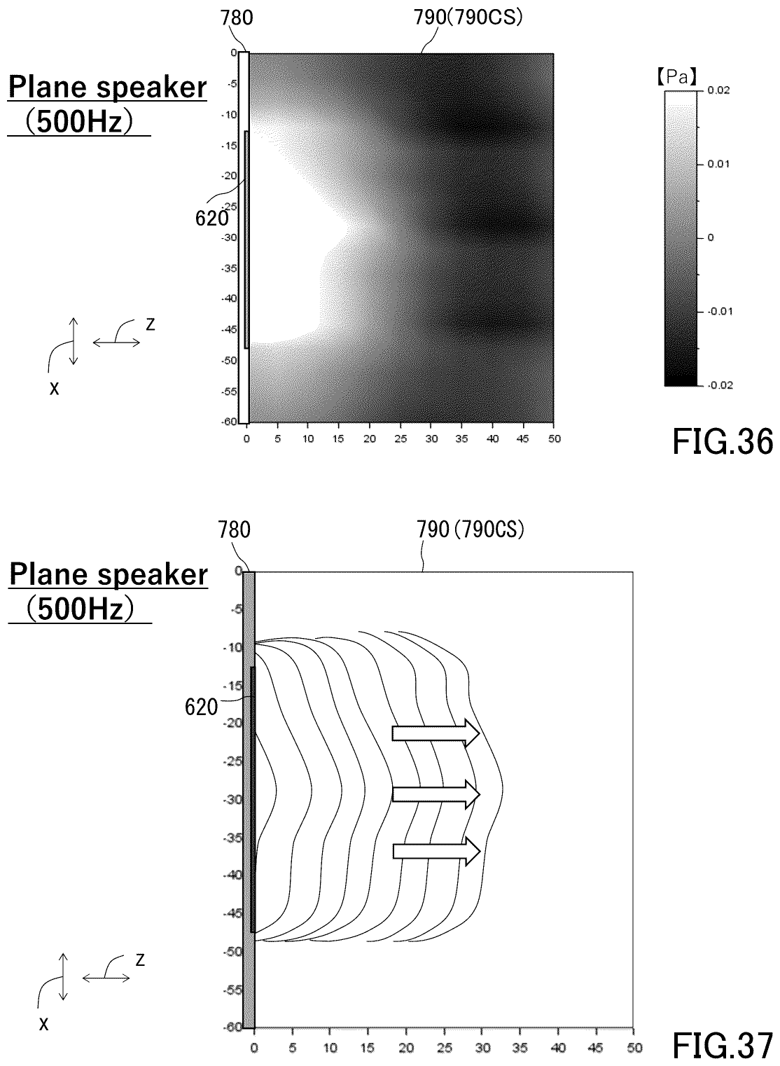

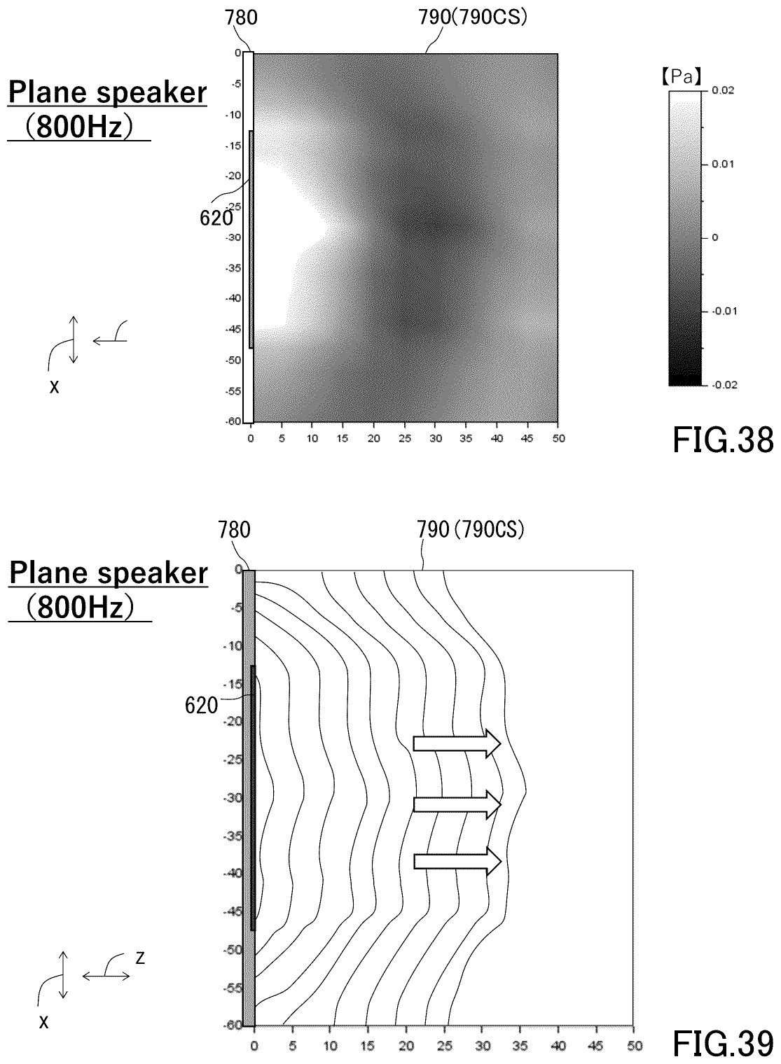

Hereinafter, a description will be given based on actual measurement data with reference to FIG. 24 to FIG. 41C. FIG. 24 to FIG. 41C omit a portion of the control region 790 shown in FIG. 23 that is distant from the partition 780. In FIG. 24, FIG. 26, FIG. 28, FIG. 30, FIG. 32, FIG. 34, FIG. 36, and FIG. 38, the numerical value on the color bar indicates the sound pressure level in units of Pascal (Pa). While the numerical value being positive means that the sound pressure is positive, the numerical value being negative means that the sound pressure is negative.

### First Reference Example: Measurement of Diffracted Sound

In a state where the piezoelectric speaker 10 radiated no sound and the noise source 700 radiated a sine wave, sound pressures at the 176 measurement points on the measurement cross section 790CS were measured for mapping. FIG. 24 to FIG. 27 show the sound pressure distributions obtained by the mapping. In FIG. 24 to FIG. 27, the piezoelectric speaker 10 is not shown so as to facilitate an intuitive understanding that diffracted sound is measured. However, the measurement of a first reference example was performed while the piezoelectric speaker 10 was attached to the partition 780, in the same manner as that in a second reference example described later.

Specifically, FIG. 24 shows the sound pressure distribution derived from the noise source 700 relating to a certain time for the case where the frequency of the sine wave radiated from the noise source 700 is 500 Hz. A series of lines in FIG. 25 represent propagation over time of a certain wave front generated by the noise source 700 radiating the sine wave of 500 Hz. FIG. 26 shows the sound pressure distribution from the noise source 700 relating to a certain time for the case where the frequency of the sine wave radiated from the noise source 700 is 800 Hz. A series of lines in FIG. 27 represent propagation over time of a certain wave front generated by the noise source 700 radiating the sine wave of 800 Hz.

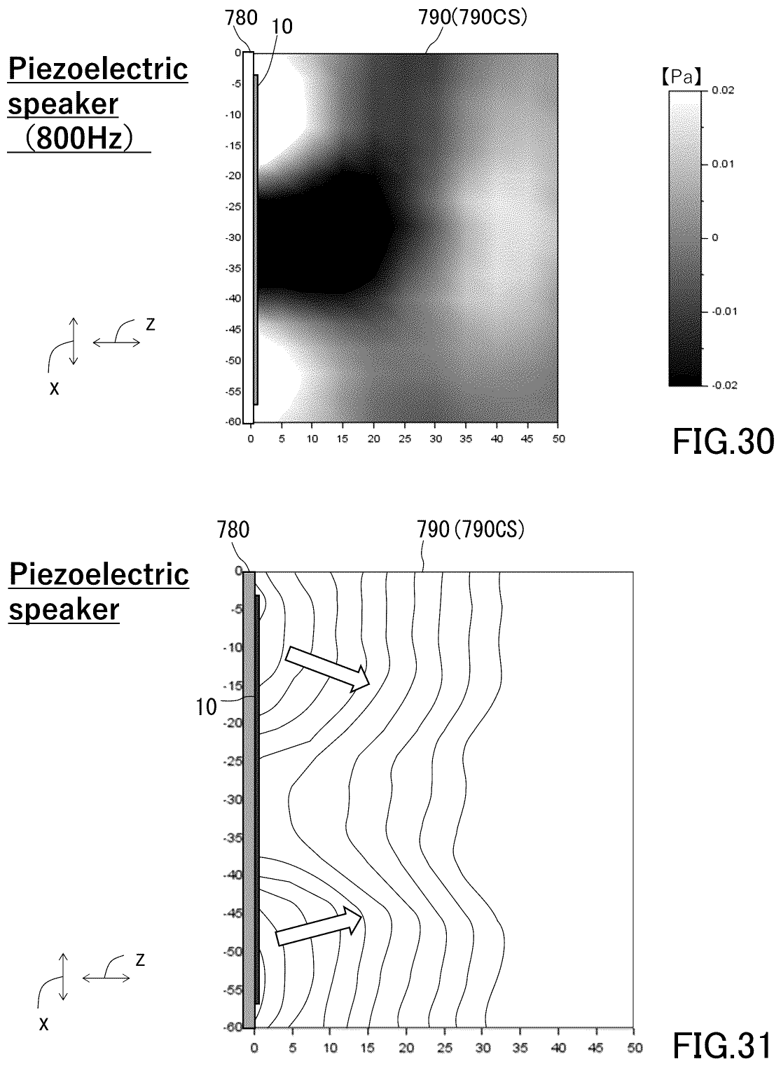

In FIG. 25, the lines in the series of lines represent respective positions of the “certain wave front” as of different times. In general, in FIG. 25, one of two adjacent lines that is further away from the partition 780 than the other is indicates the “certain wave front” as of a more advanced time. Block arrows in FIG. 25 represent the propagation directions of the wave fronts. The same descriptions of the series of lines and the block arrows apply to FIG. 27, FIG. 29, FIG. 31, FIG. 33, FIG. 35, FIG. 37, and FIG. 39.

FIG. 25 was prepared by the following procedure. First, a plurality of sound pressure distribution maps based on actual measurements relating to different times, similar to that in FIG. 24, were obtained. Next, in each of the plurality of sound pressure distribution maps, a line corresponding to the certain wave front was manually drawn. Then, the plurality of sound pressure distribution maps on which the lines have been drawn were overlapped each other. Thus, the diagram shown in FIG. 25 was obtained in which the series of lines representing propagation of the wave fronts were drawn. The same description of the drawing procedure applies to FIG. 27, FIG. 29, FIG. 31, FIG. 33, FIG. 35, FIG. 37, and FIG. 39.

FIG. 24 to FIG. 27 show that diffraction occurs at end portions of the partition 780 that face each other. FIG. 24 to FIG. 27 also show that wave fronts generated by diffraction at these end portions propagate so as to go around behind the partition 780. Specifically, FIG. 24 to FIG. 27 show that the wave fronts generated by diffraction at these end portions propagate so as to approach an axis passing through the center of the partition 780 and extending in the z direction. Wave front propagation shown in FIG. 24 to FIG. 27 occurs in a manner similar to that in FIG. 2A to FIG. 2C.

### Second Reference Example: Measurement of Sound Output from Piezoelectric Speaker 10

In a state where the noise source 700 radiated a sine wave as in the first reference example, the controller 710 was used to vibrate the piezoelectric speaker 10 thereby to cause the piezoelectric speaker 10 to generate a sound wave for sound reduction. At this time, a control signal to be transmitted to piezoelectric speaker 10 was stored in the controller 710. Then, in a state where the noise source 700 radiated no sound, the controller 710 was caused to transmit the stored control signal to the piezoelectric speaker 10. In this manner, vibration of the piezoelectric speaker 10 was reproduced in the state where the noise source 700 radiated no sound, and sound pressures at the 176 measurement points on the measurement cross section 790CS were measured for mapping. FIG. 28 to FIG. 31 show the sound pressure distributions obtained by the mapping.

Specifically, FIG. 28 shows the sound pressure distribution derived from the piezoelectric speaker 10 relating to a certain time for the case where the frequency of the sine wave radiated from the noise source 700 is 500 Hz. A series of lines in FIG. 29 represent propagation over time of a certain wave front generated by the piezoelectric speaker 10 for the case where the frequency of the sine wave radiated from the noise source 700 is 500 Hz. FIG. 30 shows the sound pressure distribution derived from the piezoelectric speaker 10 relating to a certain time for the case where the frequency of the sine wave radiated from the noise source 700 is 800 Hz. A series of lines in FIG. 31 represent propagation over time of a certain wave front generated by the piezoelectric speaker 10 for the case where the frequency of the sine wave radiated from the noise source 700 is 800 Hz.

FIG. 28 to FIG. 31 show that the wave front propagates, from two outer regions of the radiation surface 15 of the piezoelectric speaker 10 with a center region sandwiched therebetween so as to approach an axis passing through the center region and extending in the z direction. Wave front propagation shown in FIG. 28 to FIG. 31 occurs in a manner similar to that in FIG. 3A to FIG. 3C. Specifically, a wave front of a diffracted wave generated by diffraction of noise from the noise source 700 at the partition 780 and the wave front derived from the piezoelectric speaker 10 have a common point that the both wave fronts propagate while approaching the above axis. The piezoelectric speakers 10A and 10B are expected to form similar wave fronts as well in Example 1 described later.

Further, from FIG. 24 to FIG. 27, it is understood that diffraction at the partition 780 causes appearance of a period during which the sound wave in the first region 15a and the sound wave in the second region 15b have the same phase in terms of whether positive or negative, the sound wave in the first region 15a and the sound wave in the third region 15c have the phases opposite to each other in terms of whether positive or negative, and the sound wave in the second region 15b and the sound wave in the third region 15c have the phases opposite to each other in terms of whether positive or negative (see FIG. 1A to FIG. 3C and related descriptions for the regions 15a, 15b and 15c). From FIG. 28 to FIG. 31, it is understood that the piezoelectric speaker 10 causes appearance of a period during which the first sound wave and the second sound wave have the same phase in terms of whether positive or negative, the first sound wave and the third sound wave have the phases opposite to each other in terms of whether positive or negative, and the second sound wave and the third sound wave have the phases opposite to each other in terms of whether positive or negative (see the description given with reference to FIG. 1A to FIG. 3C for the first sound wave, the second sound wave and the third sound wave). The phase distribution in the first region 15a, the second region 15b, and the third region 15c is also common to noise derived from the noise source 700 and sound derived from the piezoelectric speaker 10. The piezoelectric speakers 10A and 10B are expected to form similar phase distributions as well in Example 1 described later.

### Third Reference Example: Measurement of Sound Output from Dynamic Speaker 610

The piezoelectric speaker 10 of the second reference example was replaced with the dynamic speaker 610. This dynamic speaker 610 is Fostex P650K manufactured by Foster Electric Company, Limited. In the same manner as that in the second reference example except this replacement, sound pressures derived from the dynamic speaker 610 at the 176 measurement points on the measurement cross section 790CS were measured for mapping. FIG. 32 to FIG. 35 show the sound pressure distributions obtained by the mapping. The dynamic speaker 610 is embedded in the partition 780.

Specifically, FIG. 32 shows the sound pressure distribution derived from the dynamic speaker 610 relating to a certain time for the case where the frequency of the sine wave radiated from the noise source 700 is 500 Hz. A series of lines in FIG. 33 represent propagation over time of a certain wave front generated by the dynamic speaker 610 for the case where the frequency of the sine wave radiated from the noise source 700 is 500 Hz. FIG. 34 shows the sound pressure distribution derived from the dynamic speaker 610 relating to a certain time for the case where the frequency of the sine wave radiated from the noise source 700 is 800 Hz. A series of lines in FIG. 35 represent propagation over time of a certain wave front generated by the dynamic speaker 610 for the case where the frequency of the sine wave radiated from the noise source 700 is 800 Hz.

FIG. 32 to FIG. 35 show that a substantially hemispherical wave is radiated from the radiation surface of the dynamic speaker 610, and the substantially hemispherical wave has also a substantially hemispherical wave front. Wave front propagation shown in FIG. 32 to FIG. 35 occurs in a manner similar to that in FIG. 4.

### Fourth Reference Example: Measurement of Sound Output from Plane Speaker 620

The piezoelectric speaker 10 of the second reference example was replaced with the plane speaker 620. This plane speaker 620 is FPS2030M3P1R manufactured by FPS Inc. In the same manner as that in the second reference example except this replacement, sound pressures derived from the plane speaker 620 at the 176 measurement points on the measurement cross section 790CS were measured for mapping. FIG. 36 to FIG. 39 show the sound pressure distributions obtained by the mapping.

Specifically, FIG. 36 shows the sound pressure distribution derived from the plane speaker 620 relating to a certain time for the case where the frequency of the sine wave radiated from the noise source 700 is 500 Hz. A series of lines in FIG. 37 represent propagation over time of a certain wave front generated by the plane speaker 620 for the case where the frequency of the sine wave radiated from the noise source 700 is 500 Hz. FIG. 38 shows the sound pressure distribution derived from the plane speaker 620 relating to a certain time for the case where the frequency of the sine wave radiated from the noise source 700 is 800 Hz. A series of lines in FIG. 39 represent propagation over time of a certain wave front generated by the plane speaker 620 for the case where the frequency of the sine wave radiated from the noise source 700 is 800 Hz.

FIG. 36 to FIG. 39 show that a substantially plane wave is radiated from the radiation surface of the plane speaker 620, and the substantially plane wave also has a substantially plane wave front. Wave front propagation shown in FIG. 36 to FIG. 39 occurs in a manner similar to that in FIG. 5.

(Sound Reducing Effect)

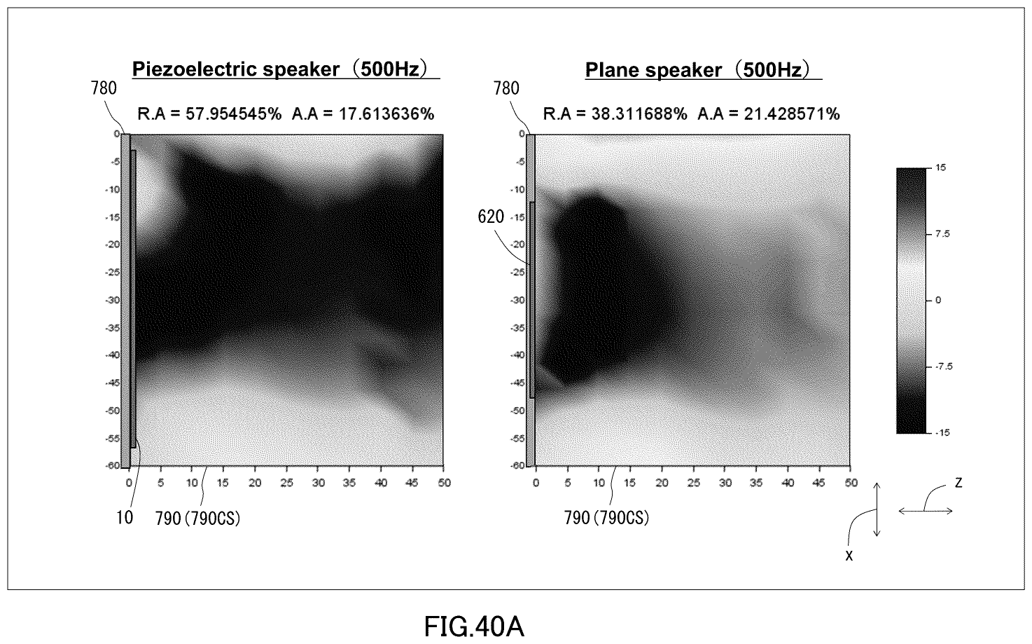

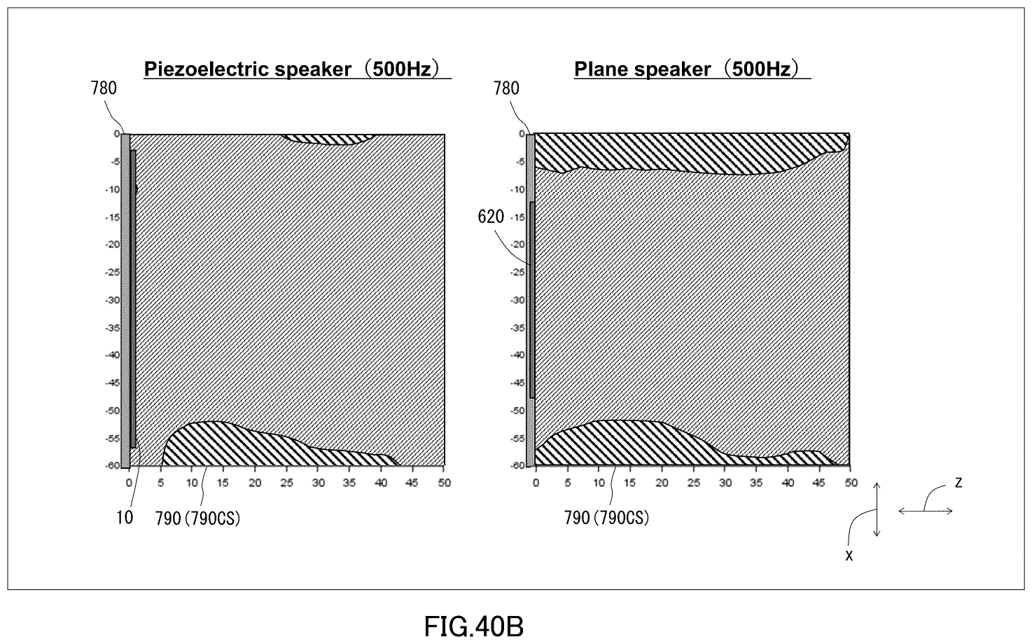

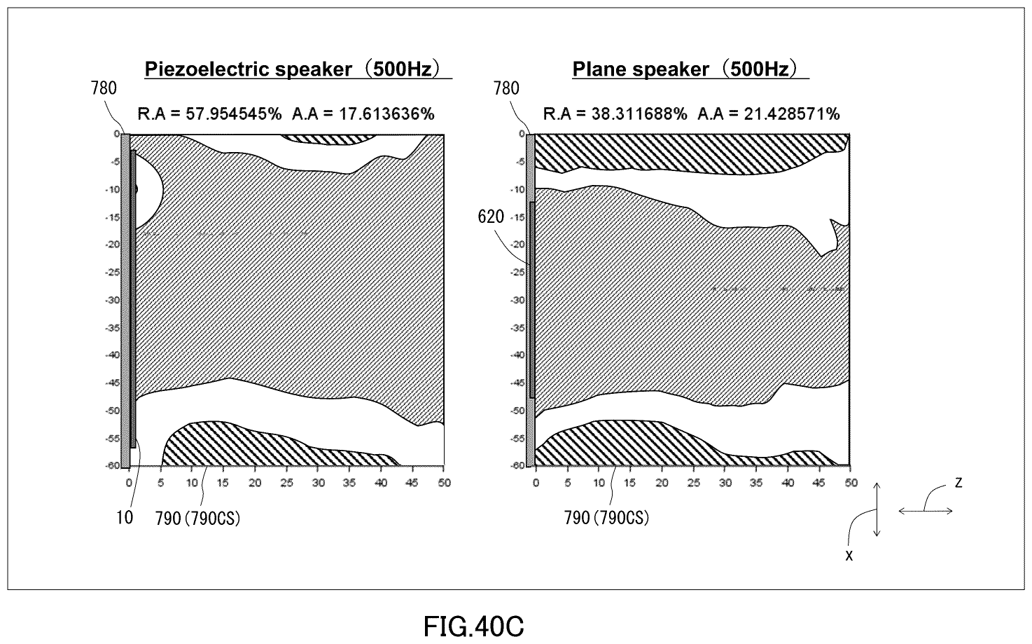

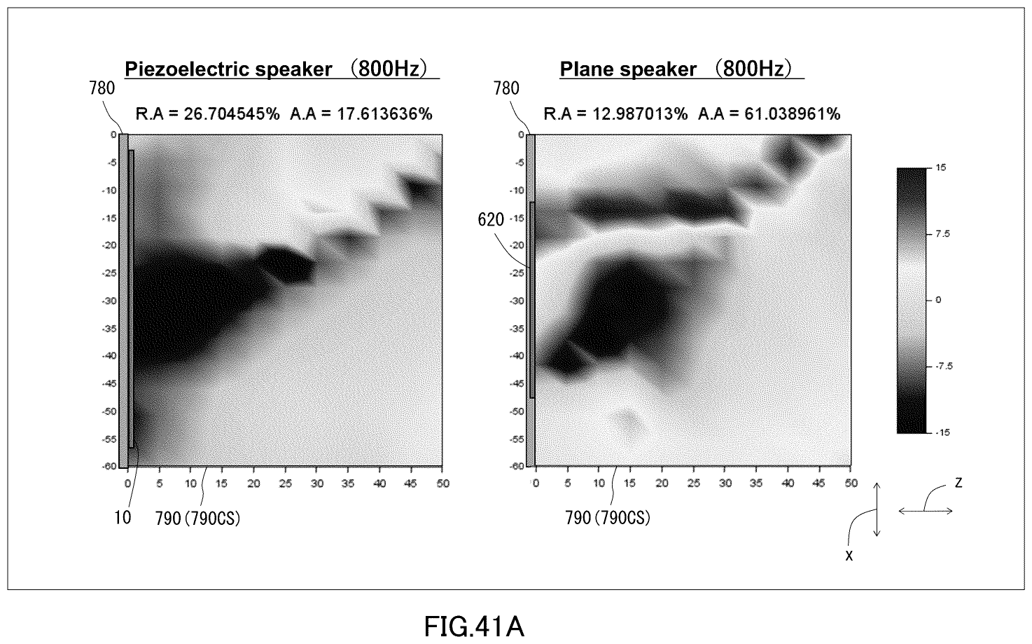

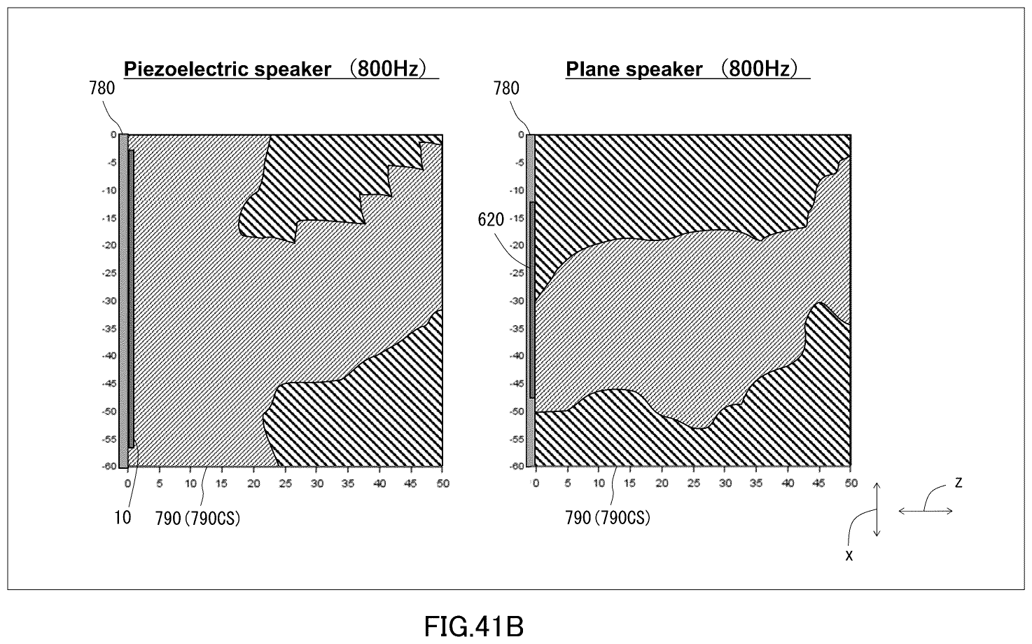

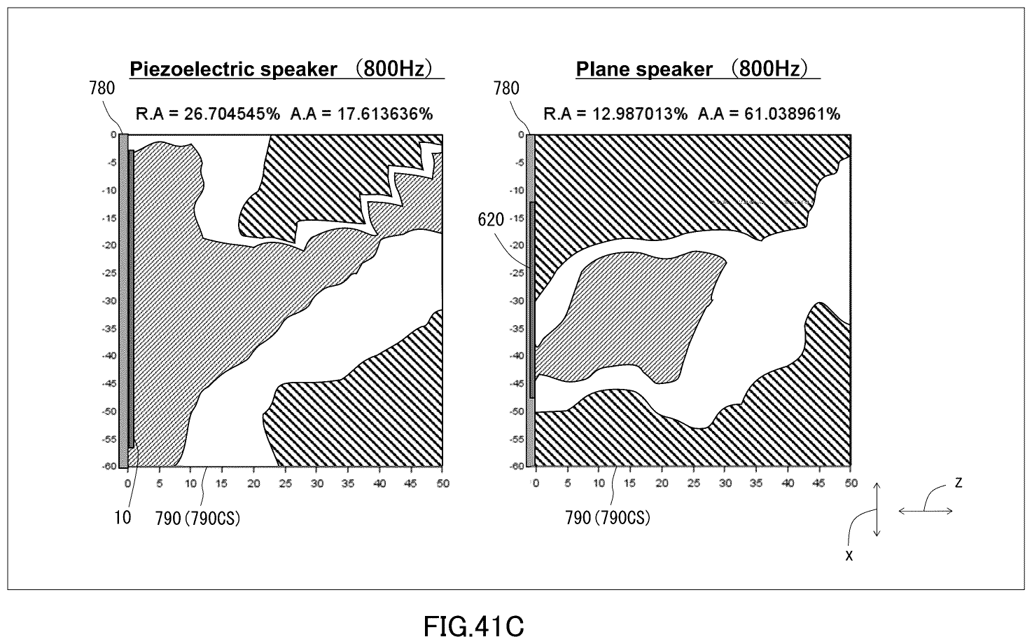

The difference in sound reducing effect between the second reference example and the fourth reference example will be described with reference to FIG. 40A to FIG. 41C. In the following description, terms “speaker ON time” and “speaker OFF time” may be used. A speaker ON time indicates a time during which sound for sound reduction is radiated from the speaker. A speaker OFF time indicates a time during which sound for sound reduction is not radiated from the speaker.

Color maps of FIG. 40A and FIG. 41A show sound reducing states as of a certain time at which a sine wave is radiated from the noise source 700. In FIG. 40A and FIG. 41A, the color maps on the left show the sound reducing states by the piezoelectric speaker 10 of the second reference example, and the color maps on the right show the sound reducing states by the plane speaker 620 of the fourth reference example. FIG. 40A shows a sound pressure distribution as of the certain time for the case where the frequency of the sine wave radiated from the noise source 700 is 500 Hz. FIG. 41A shows a sound pressure distribution as of the certain time for the case where the frequency of the sine wave radiated from the noise source 700 is 800 Hz.

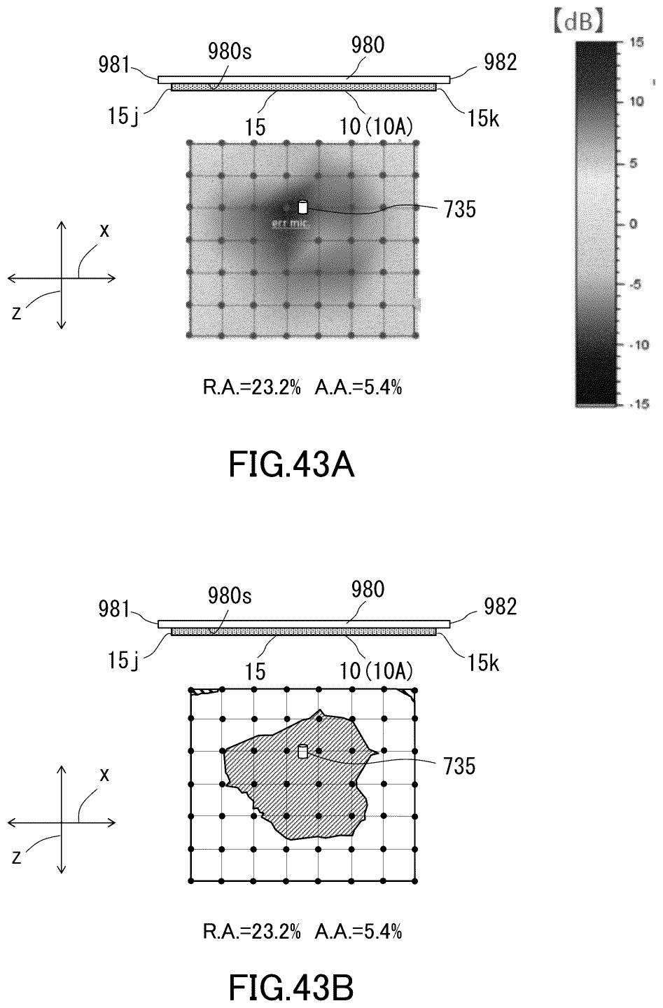

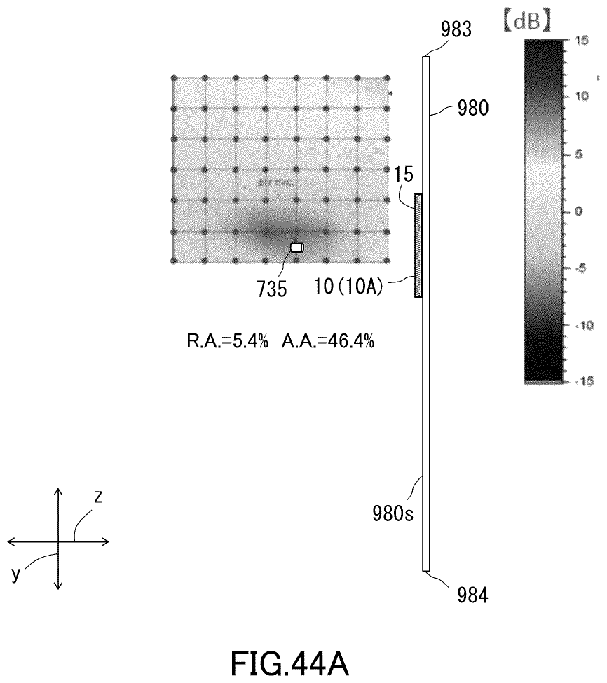

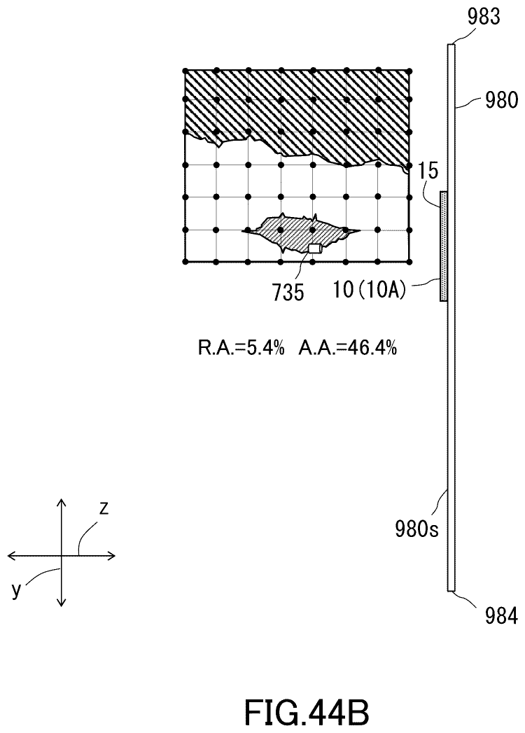

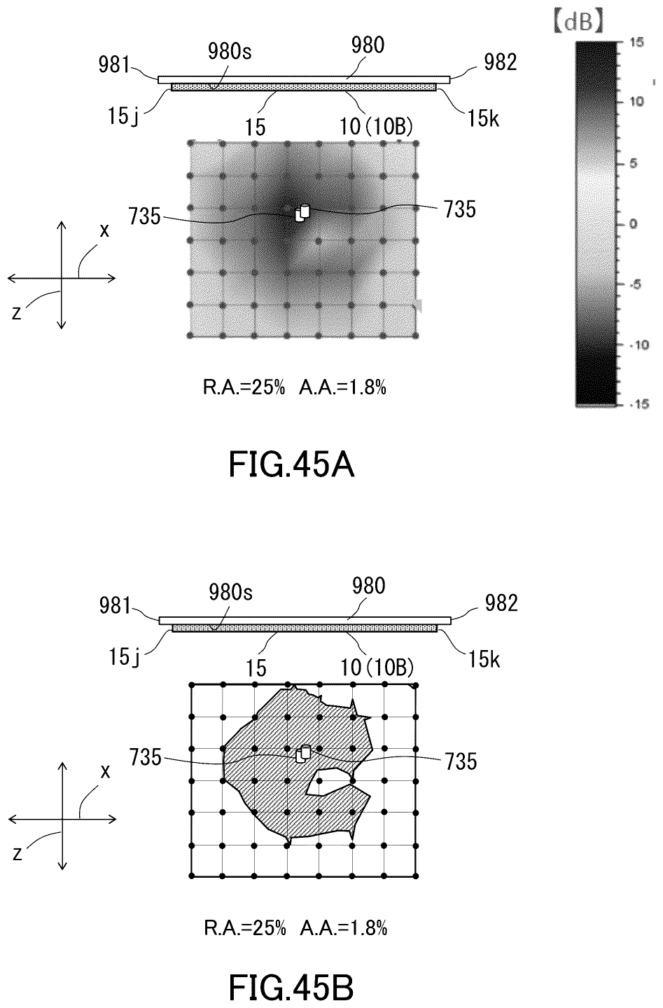

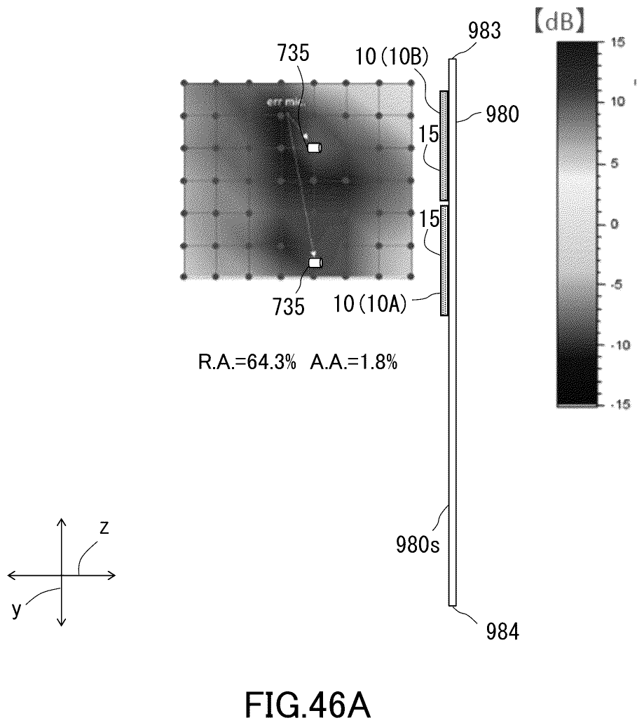

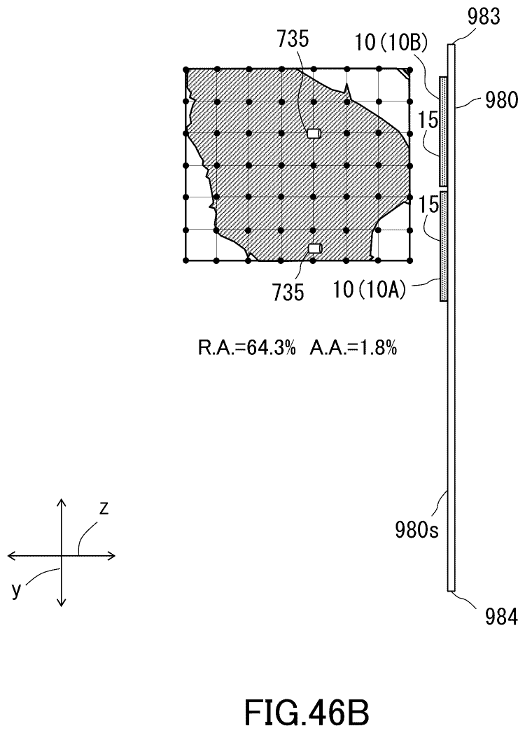

In FIG. 40A and FIG. 41A, numerical values on the right side of color bars indicate the amplification factor in units of dB. The amplification factor being X represents that a sound pressure is amplified by X dB at a speaker ON time with reference to a speaker OFF time. The amplification factor being negative indicates that a sound reducing effect is exhibited. In contrast, the amplification factor being positive indicates that noise is amplified. Reduction area (R.A) indicates the ratio of an area where the amplification factor is −6 dB or less (i.e., area where the sound reducing effect is exhibited well) on the measurement cross section 790CS. Amplification area (A.A) indicates the ratio of an area where the amplification factor is more than 0 dB (i.e., area where the noise is amplified) on the measurement cross section 790CS. The same descriptions of the color bar, the reduction area, and the amplification area apply to FIG. 43A, FIG. 44A, FIG. 45A, and FIG. 46A described later.

FIG. 40B shows a finely hatched region where the amplification factor in FIG. 40A is less than 0 dB and a coarsely hatched region where the amplification factor is more than 0. FIG. 41B shows a finely hatched region where the amplification factor in FIG. 41A is less than 0 dB and a coarsely hatched region where the amplification factor is more than 0. That is, in FIG. 40B and FIG. 41B, the regions where noise is reduced are finely hatched and the amplification areas are coarsely hatched. The hatching in FIG. 40B and FIG. 41B is roughly done manually on the basis of the visual observation of FIG. 40A and FIG. 41A. The manual hatching based on the visual observation is also true for 40C, FIG. 41C, FIG. 43B, FIG. 44B, FIG. 45B, and FIG. 46B described later.

FIG. 40C shows a finely hatched region where the amplification factor in FIG. 40A is −6 dB or less and a coarsely hatched region where the amplification factor is more than 0. FIG. 41C shows a finely hatched region where the amplification factor in FIG. 41A is −6 dB or less and a coarsely hatched region where the amplification factor is more than 0. That is, in FIG. 40C and FIG. 41C, the reduction regions are finely hatched and the amplification areas are coarsely hatched. The same applies to FIG. 43B, FIG. 44B, FIG. 45B, and FIG. 46B described later.

As shown in FIG. 40A to FIG. 41C, in the case where the piezoelectric speaker 10 of the second reference example is used, the area where the noise is reduced and the reduction area are large and the amplification area is small compared to the case where the plane speaker 620 of the fourth reference example is used.

Specifically, in the use case of the piezoelectric speaker 10 of the second reference example, in the case where the frequency of the sine wave radiated from the noise source 700 is 500 Hz, the reduction area covers about 58% and the amplification area covers about 18%. In the case where the frequency of the sine wave radiated from the noise source 700 is 800 Hz, the reduction area covers about 27% and the amplification area covers about 18%.

On the other hand, in the use case of the plane speaker 620 of the fourth reference example, in the case where the frequency of the sine wave radiated from the noise source 700 is 500 Hz, the reduction area covers about 38% and the amplification area covers about 21%. In the case where the frequency of the sine wave radiated from the noise source 700 is 800 Hz, the reduction area covers about 13% and the amplification area covers about 61%.

FIG. 40A to FIG. 41C demonstrate that the advantage of the sound reducing effect of the piezoelectric speaker 10 with respect to the plane speaker 620 is exhibited more prominently when the frequency of the sine wave radiated from the noise source 700 is 800 Hz than when the frequency is 500 Hz.

It is expected that in the case where the dynamic speaker 610 of the third reference example is used, the area where the noise is reduced and the reduction area are small and the amplification is large compared to the case where the plane speaker 620 of the fourth reference example is used.

[Evaluation of Sound Reduction with Respect to Horizontal Plane and Sagittal Plane in ANC System]

In the reference ANC evaluation system 800 described with reference to FIG. 23 to FIG. 41C, good sound reduction can be achieved with respect to the measurement cross section 790CS extending in the x direction and the z direction, as described above. However, according to the study by the present inventors, it is not easy, in the reference ANC evaluation system 800, to achieve good sound reduction with respect to a plane extending in the y direction and the z direction, namely, a plane orthogonal to the measurement cross section 790CS. According to the further study by the present inventors, it is effective to use a plurality of piezoelectric speakers to achieve good sound reduction with respect to the plane orthogonal to the measurement cross section 790CS. This point will be described below with use of Comparative Example 1 and Example 1.

In Comparative Example 1 and Example 1, the x direction is the right-left direction, and the y direction is the up-down direction. A plane extending in the x direction and the z direction is a horizontal plane. A measurement cross section that is a horizontal plane is referred to also as a measurement horizontal cross section. A measurement cross section that is a plane perpendicular to this horizontal plane (a plane extending in the y direction and the z direction) is a cross section taken with respect to the combination of the partition and the piezoelectric speaker in a laterally symmetrical manner. Accordingly, the measurement cross section, which is the perpendicular plane, is referred to also as a measurement sagittal cross section.

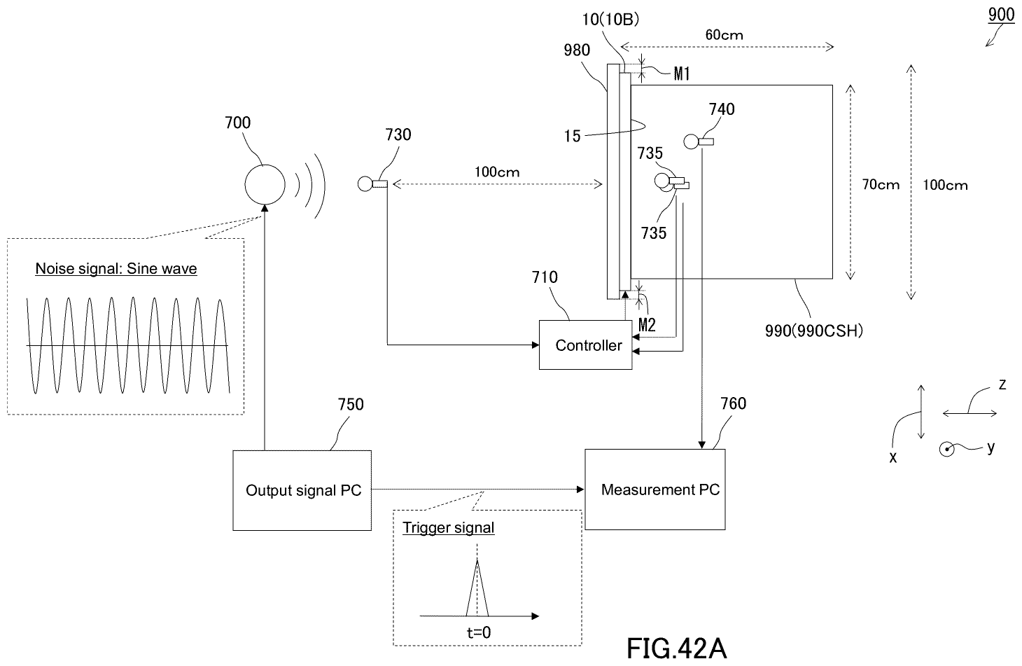

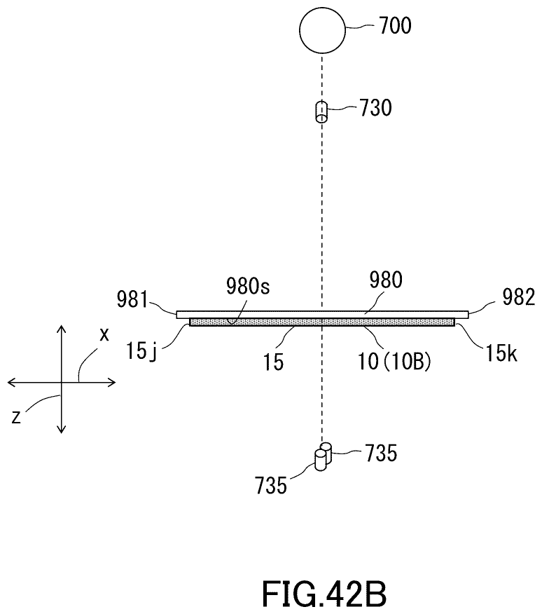

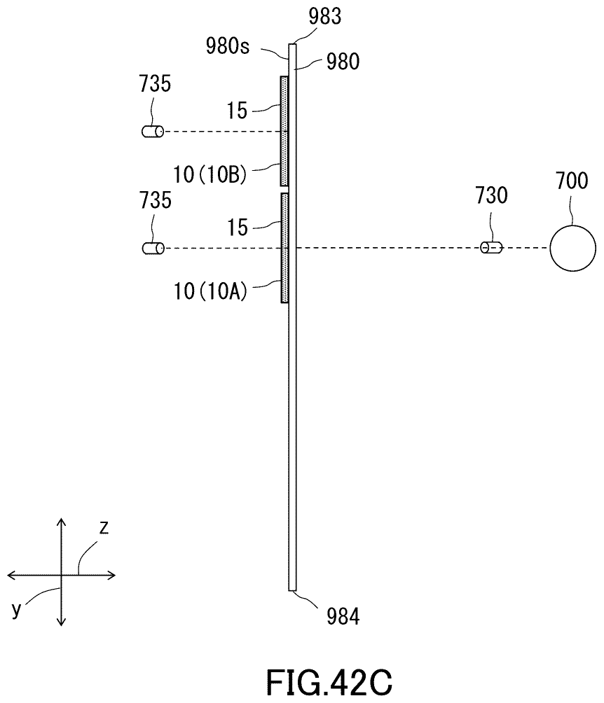

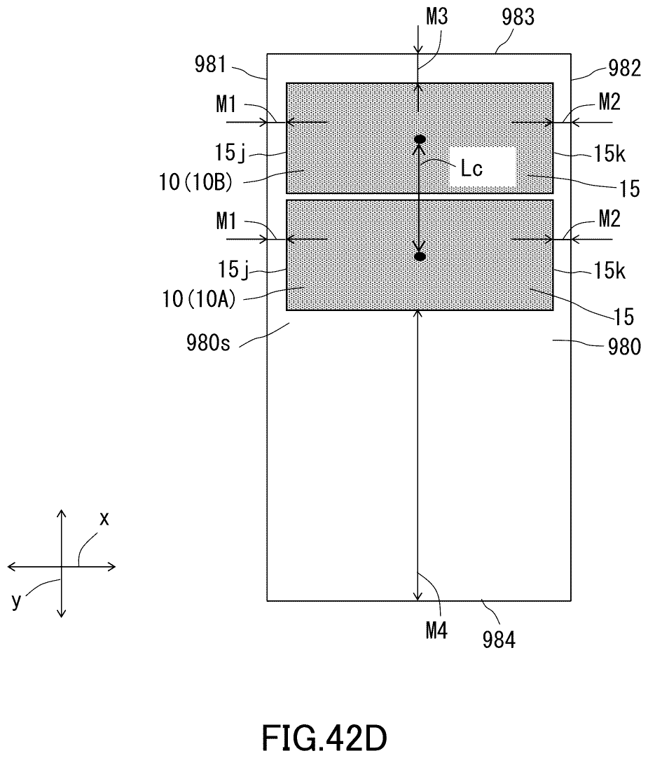

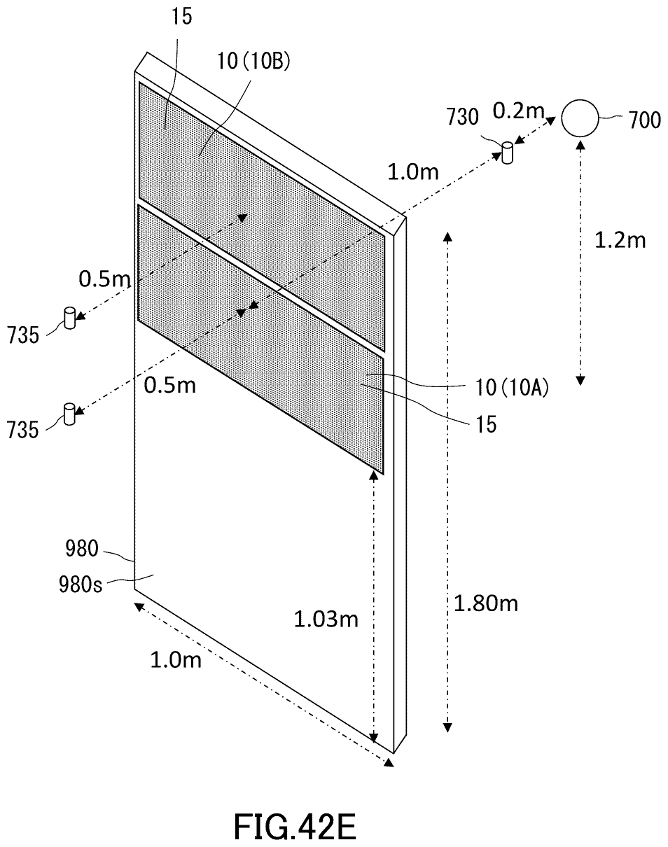

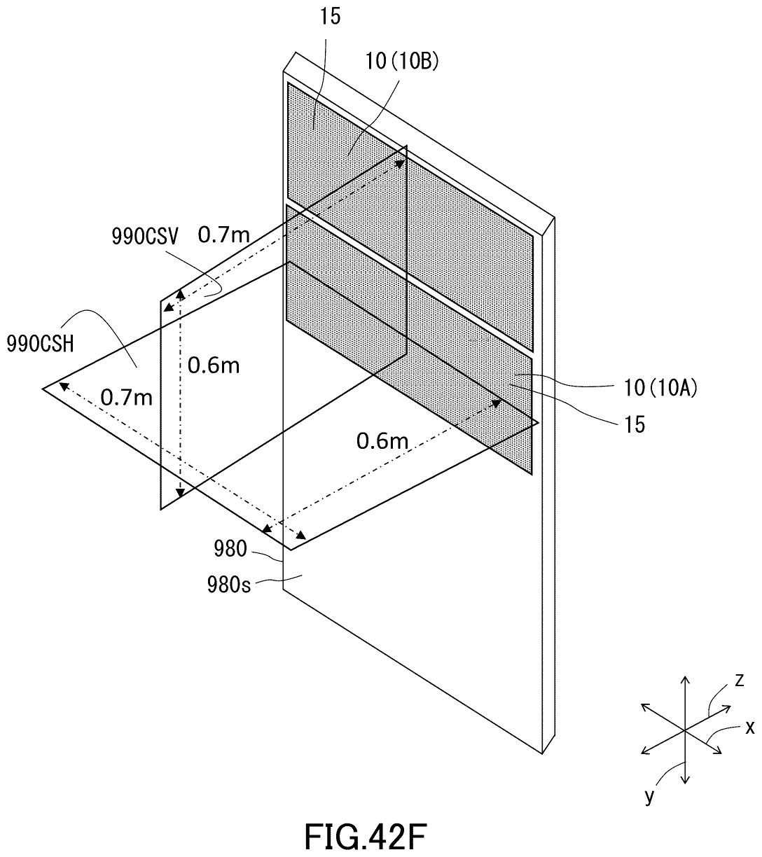

In Example 1, an ANC evaluation system 900 was configured as shown in FIG. 42A to FIG. 42F. From the ANC evaluation system 900 of Example 1, the piezoelectric speaker 10B and the error microphone 735 associated with the piezoelectric speaker 10B were excluded, and thus an ANC evaluation system of Comparative Example 1 was obtained. Comparative Example 1 and Example 1 will be described below in detail with reference to FIG. 42A to FIG. 42F.

### Comparative Example 1

In the ANC evaluation system of Comparative Example 1, a piezoelectric speaker 10 that is the same as the piezoelectric speaker 10 of Sample E1 was used except that the plan view dimensions of the piezoelectric speaker 10 were set to 80 cm in the lateral direction and 34 cm in the longitudinal direction. The number of the piezoelectric speakers 10 used in the ANC evaluation system of Comparative Example 1 is one. In Comparative Example 1, this piezoelectric speaker 10 is referred to as a piezoelectric speaker 10A.

A partition 980 was disposed so that its lower end portion 984 was in contact with the floor. The piezoelectric speaker 10A was attached to a surface 980s of the partition 980. The noise source 700 was disposed 120 cm away from the floor. The noise source 700, the reference microphone 730, the partition 980, the piezoelectric speaker 10A, and the error microphone 735 were disposed so that the noise source 700, the reference microphone 730, the partition 980, the center of the piezoelectric speaker 10A, and the error microphone 735 were arranged in this order on a straight line. A control region 990 was set on the piezoelectric speaker 10A side when viewed from the partition 980. The measurement microphone 740 was disposed in the control region 990.

In FIG. 42A to FIG. 42F, the x direction is the lateral direction of the control region 990, the y direction is the longitudinal direction of the control region 990, and the z direction is the depth direction of the control region 990. The x direction, the y direction, and the z direction are directions orthogonal to each other.

The z direction is also the direction along which the noise source 700, the reference microphone 730, the partition 980, the center of the piezoelectric speaker 10A, and the error microphone 735 are arranged. The z direction is further the direction in which the radiation surface 15 of the piezoelectric speaker 10A faces.

The partition 980 is an experimental prototype. The noise source 700, the reference microphone 730, the error microphone 735, and the measurement microphone 740 are the same as those used in the reference ANC evaluation system 800.

The distance between the noise source 700 and the reference microphone 730 is 20 cm. The distance between the reference microphone 730 and the partition 980 is 100 cm. The distance between the radiation surface 15 of the piezoelectric speaker 10A and the error microphone 735 is 50 cm. These distances are the dimensions in the z direction.

The partition 980 has a rectangular plate-like shape in plan view. The partition 980 has a dimension of 100 cm in the lateral direction, a dimension of 180 cm in the longitudinal direction, and a dimension of 5 cm in the thickness direction. The control region 990 has a dimension of 70 cm in the lateral direction, a dimension of 70 cm in longitudinal direction, and a dimension of 60 cm in the depth direction. These lateral directions are the x direction. These longitudinal directions are the y direction. These thickness direction and depth direction are the z direction. One end of the partition 980 in the y direction is in contact with the floor.

Further, the lateral direction of the piezoelectric speaker 10A, namely, the direction along the 80-cm length of the piezoelectric speaker 10A is the x direction. The longitudinal direction of the piezoelectric speaker 10A, namely, the direction along the 34-cm length of the piezoelectric speaker 10A is the y direction. The thickness direction of the piezoelectric speaker 10A is the z direction.

The left margin M1 is 10 cm, and the right margin M2 is 10 cm. The margins M1 and M2 are the dimensions in the x direction.

The center of the piezoelectric speaker 10A in the y direction is positioned 120 cm above the lower end portion 84 of the partition 980. The lower margin M4 is 103 cm. The lower margin M4 is the dimension in the y direction.

In the ANC evaluation system of Comparative Example 1, as in the reference ANC evaluation system 800, the output signal PC 750, the measurement PC 760, and the controller 710 were used. The output signal PC 750 was connected to the noise source 700 and the measurement PC 760.

The operations of the reference microphone 730, the error microphone 735, the output signal PC 750, the measurement PC 760, and the controller 710 in the ANC evaluation system of Comparative Example 1 are the same as those in the reference ANC evaluation system 800.

As can be understood from FIG. 42F, the control region 990 has a measurement horizontal cross section 990CSH and a measurement sagittal cross section 990CSV. The measurement horizontal cross section 990CSH extends in the x direction and the z direction. The measurement sagittal cross section 990CSV extends in the y direction and the z direction.

In the ANC evaluation system of Comparative Example 1, 56 measurement points are provided on the measurement horizontal cross section 990CSH. Specifically, the measurement horizontal cross section 990CSH is divided equally into eight pieces in the x direction and is divided equally into seven pieces in the z direction. The number of measurement points, 56, is the product of 8, which is the number of divisions in the x direction and 7, which is the number of divisions in the z direction. The position of the measurement horizontal cross section 990CSH in the y direction is the same as the center position of the radiation surface 15 of the piezoelectric speaker 10A in the y direction.

In the ANC evaluation system of Comparative Example 1, 56 measurement points are provided on the measurement sagittal cross section 990CSV. Specifically, the measurement sagittal cross section 990CSV is divided equally into seven pieces in the y direction and is divided equally into eight pieces in the z direction. The number of measurement points, 56, is the product of 7, which is the number of divisions in the y direction and 8, which is the number of divisions in the z direction. The position of the measurement horizontal cross section 990CSH in the x direction is the same as the center position of the radiation surface 15 of the piezoelectric speaker 10A in the x direction.

The error microphone 735 is provided at a portion where the measurement horizontal cross section 990CSH and the measurement sagittal cross section 990CSV intersect with each other.

In the ANC evaluation system of Comparative Example 1, the measurement microphone 740 is successively moved to the 56 measurement points on the measurement horizontal cross section 990CSH. Thus, in cooperation with the measurement PC 760, the microphone 740 measures the sound pressure at the 56 measurement points on the measurement horizontal cross section 990CSH. Specifically, the measurement PC 760 maps the distribution of the sound pressure at these measurement points. This mapping visualizes the sound field of the measurement horizontal cross section 990CSH extending in the x-z directions.

In the ANC evaluation system of Comparative Example 1, the measurement microphone 740 is successively moved to the 56 measurement points on the measurement sagittal cross section 990CSV. Thus, in cooperation with the measurement PC 760, the microphone 740 measures the sound pressure at the 56 measurement points on the measurement sagittal cross section 990CSV. Specifically, the measurement PC 760 maps the distribution of the sound pressure at these measurement points. This mapping visualizes the sound field of the measurement sagittal cross section 990CSV extending in the y-z directions.

A description will be given below of the sound reducing effect with respect to the measurement horizontal cross section 990CSH and the measurement sagittal cross section 990CSV with reference to FIG. 43A to FIG. 44B. FIG. 43A to FIG. 44B show a portion of the measurement horizontal cross section 990CSH and a portion of the measurement sagittal cross section 990CSV.

The color map in FIG. 43A shows the sound pressure distribution with respect to the measurement horizontal cross section 990CSH. The color map in FIG. 44A shows the sound pressure distribution with respect to the measurement sagittal cross section 990CSV. Specifically, the color maps in FIG. 43A and FIG. 44A show the sound pressure distribution as of a certain time at which noise is emitted from the noise source 700. Specifically, this noise is generated by passing white noise through a 150 to 650 Hz band-limiting filter. More specifically, the white noise which has passed through the band-limiting filter substantially equally contains frequency components of 150 to 650 Hz.

As shown in FIG. 43A to FIG. 44B, on the measurement horizontal cross section 990CSH, the reduction area is large and the amplification area is small. Specifically, the reduction area covers 23.2% and the amplification area covers 5.4%. On the other hand, on the measurement sagittal cross section 990CSV, the reduction area is small and the amplification area is large. Specifically, the reduction area covers 5.4% and the amplification area covers 46.4%.

### Example 1: ANC Evaluation System 900

The ANC evaluation system 900 was configured as shown in FIG. 42A to FIG. 42E. The ANC evaluation system 900 was configured by adding the piezoelectric speaker 10B and the error microphone 735 associated with the piezoelectric speaker 10B to the ANC evaluation system of Comparative Example 1. Thus, the number of the piezoelectric speakers 10 in the ANC evaluation system 900 is two. Further, the number of the error microphones 735 in the ANC evaluation system 900 is two.

In FIG. 42A and FIG. 42B, two error microphones 735 are drawn to illustrate that the number of the error microphones 735 used is two. In fact, the positions in the x direction and the z direction of the two error microphones 73 are the same. The same applies to FIG. 45A and FIG. 45B described later.

The piezoelectric speaker 10B is the same piezoelectric speaker as the piezoelectric speaker 10A. The piezoelectric speaker 10B was attached to the partition 980 so as to face the z direction. The error microphone 735 associated with the piezoelectric speaker 10B is the same as the error microphone 735 associated with the piezoelectric speaker 10A. The partition 980, the piezoelectric speaker 10B, and the error microphone 735 associated with the piezoelectric speaker 10B were disposed so that the partition 980, the center of the piezoelectric speaker 10B, and the error microphone 735 were arranged in this order on a straight line in the z direction.

As described above, the distance between the radiation surface 15 of the piezoelectric speaker 10A and the error microphone 735 associated with the piezoelectric speaker 10A is 50 cm. Similarly, the distance between the radiation surface 15 of the piezoelectric speaker 10B and the error microphone 735 associated with the piezoelectric speaker 10B is 50 cm. These distances are the dimensions in the z direction.

As in the piezoelectric speaker 10A, the lateral direction of the piezoelectric speaker 10B, namely, the direction along the 80-cm length of the piezoelectric speaker 10B is the x direction. The longitudinal direction of the piezoelectric speaker 10B, namely, the direction along the 34-cm length of the piezoelectric speaker 10B is the y direction. The thickness direction of the piezoelectric speaker 10B is the z direction.

The left margin M1 between the end portion of the piezoelectric speaker 10B and the partition 980 is 10 cm. The right margin M2 between the end portion of the piezoelectric speaker 10B and the partition 980 is 10 cm. The margins M1 and M2 are the dimensions in the x direction.

The center of the piezoelectric speaker 10B in the y direction is positioned 22 cm under the upper end portion 83 of the partition 980. The upper margin M3 is 5 cm. The upper margin M3 is the dimension in the y direction.

The interval Lc between the center of the radiation surface 15 of the piezoelectric speaker 10A and the center of the radiation surface 15 of the piezoelectric speaker 10B is 40 cm

The ANC evaluation system 900 has the measurement horizontal cross section 990CSH and the measurement sagittal cross section 990CSV at the same positions as those in the ANC evaluation system of Comparative Example 1 (see FIG. 42F). In Example 1, the sound pressure distributions with respect to the measurement horizontal cross section 990CSH and the measurement sagittal cross section 990CSV were obtained in the same manner as that in Comparative Example 1.

A description will be given below of the sound reducing effect with respect to the measurement horizontal cross section 990CSH and the measurement sagittal cross section 990CSV with reference to FIG. 45A to FIG. 46B. FIG. 45B and FIG. 46B show the respective reduction areas in FIG. 45A and FIG. 46A with fine hatching and show the respective amplification areas in FIG. 45A and FIG. 46A with coarse hatching.

The color map in FIG. 45A shows the sound pressure distribution with respect to the measurement horizontal cross section 990CSH. The color map in FIG. 46A shows the sound pressure distribution with respect to the measurement sagittal cross section 990CSV. Specifically, the color maps in FIG. 45A and FIG. 46A show the sound pressure distributions as of a certain time at which noise is emitted from the noise source 700. Specifically, this noise is generated by passing white noise through a 150 to 650 Hz band-limiting filter. More specifically, the white noise which has passed through the band-limiting filter substantially equally contains frequency components of 150 to 650 Hz.

As shown in FIG. 45A to FIG. 46B, on both the measurement horizontal cross section 990CSH and the measurement sagittal cross section 990CSV, the reduction area is large and the amplification area is small. Specifically, on the measurement horizontal cross section 990CSH, the reduction area covers 25% and the amplification area covers 1.8%. On the measurement sagittal cross section 990CSV, the reduction area covers 64.3% and the amplification area covers 1.8%.

[Supporting Structure for Piezoelectric Film and Degree of Freedom of Vibration]

The following refers to an example of a supporting structure for the piezoelectric speaker according to the present invention. As can be understood from FIG. 6A, FIG. 9, FIG. 11, and FIG. 12 and the descriptions relating to these figures, in the piezoelectric speaker 10, the entire surface of the piezoelectric film 35 is fixed to the structure 80 with the joining layers 51 and 52 and the interposed layer 40 therebetween.

It is also conceivable that a portion of the piezoelectric film 35 is supported to be spaced away from the structure 80 in order to prevent the structure 80 from hindering vibration of the piezoelectric film 35. An exemplary supporting structure based on this design concept is shown in FIG. 6B. In a hypothetical piezoelectric speaker 108 shown in FIG. 6B, a frame 88 supports a peripheral portion of the piezoelectric film 35 at a position distant from the structure 80.

It is easy to ensure a sufficient volume of sound emitted from a piezoelectric film already curved and fixed in one direction. Accordingly, it is conceivable that, for example, in the piezoelectric speaker 108, a nonuniformly thick interposed object having a convex upper surface is disposed in a space 48 surrounded by the piezoelectric film 35, the frame 88, and the structure 80 and a central portion of the piezoelectric film 35 is pushed upward. However, such an interposed object is not joined to the piezoelectric film 35 so as not to hinder vibration of the piezoelectric film 35. Accordingly, even with the interposed object disposed in the space 48, it is only the frame 88 that supports the piezoelectric film 35 so as to determine vibration of the piezoelectric film 35.

As described above, the piezoelectric speaker 108 shown in FIG. 6B employs the supporting structure locally supporting the piezoelectric film 35. On the other hand, the piezoelectric film 35 of the piezoelectric speaker 10 as in FIG. 6A and the like is not supported at a particular portion. Unexpectedly, the piezoelectric speaker 10 exhibits practical acoustic characteristics in spite of the fact that the entire surface of the piezoelectric film 35 is fixed to the structure 80. Specifically, in the piezoelectric speaker 10, even a peripheral portion of the piezoelectric film 35 possibly vibrates up and down.

The piezoelectric film 35 can vibrate up and down as a whole. Accordingly, compared with the piezoelectric speaker 108, the piezoelectric speaker 10 has a higher degree of freedom of vibration and is relatively advantageous in achieving good sound emission characteristics.

As described with reference to FIG. 6A, the high degree of freedom of vibration may contribute to formation of the first wave front 16a and the second wave front 16b. In FIG. 6A, the case where the speaker 10 is the piezoelectric speaker 10 shown in FIG. 9 is illustrated. In FIG. 6A, the first joining layer 51 and the second joining layer 52 are not shown. A high degree of freedom of vibration can be obtained also in the case where the speaker 10 is the piezoelectric speaker 110 shown in FIG. 11.

According to the studies by the present inventors, the interposed layer being a porous body layer and/or a resin layer is suitable for achieving the degree of freedom of vibration. In fact, in Samples E1 to E17 in which the interposed layer is a porous body layer and/or a resin layer, practical acoustic characteristics are exhibited in spite of the fact that the entire surface of the piezoelectric film 35 is fixed to the supporting member 680. It is considered that even in the case where the piezoelectric speaker 10 in the ANC evaluation system 900 is changed from a different size product of Sample E1 to different size products of Samples E2 to E17, a sound pressure distribution with a tendency similar to that in FIG. 45A to FIG. 46B appears.

1. An active noise control system comprising:
a structure; and
a plurality of piezoelectric speakers disposed on a surface of the structure, wherein
the piezoelectric speakers each have a radiation surface extending along a first direction and a second direction orthogonal to the first direction, the first direction being a direction along which centers of the radiation surfaces of the piezoelectric speakers are arranged so that the piezoelectric speakers are adjacent to each other, and
the radiation surface of each of the piezoelectric speakers is shorter in a dimension in the first direction than in a dimension in the second direction.

2. The active noise control system according to claim 1, wherein
the radiation surface of each of the piezoelectric speakers has a first region,
the first regions of the adjacent piezoelectric speakers are adjacent to each other along the first direction, and
when a sound wave in the first region formed by each of the piezoelectric speakers is defined as a first sound wave,
a period appears during which the first sound waves of the adjacent piezoelectric speakers have phases opposite to each other in terms of whether positive or negative.

3. The active noise control system according to claim 1, wherein
the radiation surface of each of the piezoelectric speakers has a first region, a third region, and a second region in this order along the second direction,
the first regions of the adjacent piezoelectric speakers are adjacent to each other along the first direction,
the second regions of the adjacent piezoelectric speakers are adjacent to each other along the first direction,
the third regions of the adjacent piezoelectric speakers are adjacent to each other along the first direction, and
when a sound wave in the first region formed by each of the piezoelectric speakers is defined as a first sound wave, a sound wave in the second region formed by each of the piezoelectric speakers is defined as a second sound wave, and a sound wave in the third region formed by each of the piezoelectric speakers is defined as a third sound wave,
a period appears during which the first sound waves of the adjacent piezoelectric speakers have phases opposite to each other in terms of whether positive or negative, the second sound waves of the adjacent piezoelectric speakers have phases opposite to each other in terms of whether positive or negative, and the third sound waves of the adjacent piezoelectric speakers have phases opposite to each other in terms of whether positive or negative.

4. The active noise control system according to claim 1, wherein
the radiation surface of each of the piezoelectric speakers has a first region, a third region, and a second region in this order along the second direction,
the first regions of the adjacent piezoelectric speakers are adjacent to each other along the first direction,
the second regions of the adjacent piezoelectric speakers are adjacent to each other along the first direction,
the third regions of the adjacent piezoelectric speakers are adjacent to each other along the first direction, and
when a sound wave in the first region formed by each of the piezoelectric speakers is defined as a first sound wave, a sound wave in the second region formed by each of the piezoelectric speakers is defined as a second sound wave, and a sound wave in the third region formed by each of the piezoelectric speakers is defined as a third sound wave,
a period appears, in each of the piezoelectric speakers, during which the first sound wave and the second sound wave have the same phase in terms of whether positive or negative, the first sound wave and the third sound wave have phases opposite to each other in terms of whether positive or negative, and the second sound wave and the third sound wave have the phases opposite to each other in terms of whether positive or negative.

5. The active noise control system according to claim 1, wherein
the radiation surface of each of the piezoelectric speakers has a first region, a third region, and a second region in this order along the second direction, and
in each of the piezoelectric speakers, when an axis passing through the third region and extending away from the radiation surface is defined as a reference axis, each of the piezoelectric speakers forms a first wavefront propagating from the first region so as to approach the reference axis and a second wavefront propagating from the second region so as to approach the reference axis.

6. The active noise control system according to claim 1, wherein
the centers of the radiation surfaces of the adjacent piezoelectric speakers are arranged at an interval of 160 mm to 3760 mm.

7. An active noise control system comprising:
a structure; and
a plurality of piezoelectric speakers disposed on a surface of the structure, wherein
centers of radiation surfaces of the piezoelectric speakers are arranged at an interval of 160 mm to 3760 mm so that the piezoelectric speakers are adjacent to each other.

8. The active noise control system according to claim 6, wherein
the interval is 660 mm or less.

9. The active noise control system according to claim 1, wherein
the radiation surface of each of the piezoelectric speakers extends along a first direction and a second direction orthogonal to the first direction, the first direction being a direction along an interval at which the centers of the radiation surfaces of the adjacent piezoelectric speakers are arranged, and
the radiation surface of each of the piezoelectric speakers has a dimension in the second direction longer than the interval.

10. The active noise control system according to claim 1, wherein
the radiation surface of each of the piezoelectric speakers has a dimension of 160 mm to 3760 mm in a first direction along an interval at which the centers of the radiation surfaces of the adjacent piezoelectric speakers are arranged.

11. The active noise control system according to claim 1, comprising:
a plurality of error microphones; and
a controller, wherein
the controller controls sound to be output from the piezoelectric speakers by using the error microphones.

12. The active noise control system according to claim 11, wherein
the piezoelectric speakers and the error microphones are associated one-to-one with each other, and
the controller controls sound to be output from each of the piezoelectric speakers by using the error microphone associated with the piezoelectric speaker.

13. The active noise control system according to claim 1, comprising a controller, wherein
the controller has a plurality of noise control filters,
the piezoelectric speakers and the noise control filters are associated one-to-one with each other, and
the controller controls sound to be output from each of the piezoelectric speakers by using the noise control filter associated with the piezoelectric speaker.

14. The active noise control system according to claim 1, comprising:
at least one reference microphone; and
a controller, wherein
the controller controls sound to be output from each of the piezoelectric speakers by using the at least one reference microphone.

15. The active noise control system according to claim 1, wherein
the piezoelectric speakers each have:
a piezoelectric film; and
an interposed layer disposed between the piezoelectric film and the structure, and
the interposed layer is a porous body layer and/or a resin layer.

16. The active noise control system according to claim 1, being configured to have an upper frequency limit that is an upper limit for a frequency of sound to be output from the piezoelectric speakers, wherein
the upper frequency limit is higher than a frequency of sound having a wavelength that is twice as long as an interval at which the centers of the radiation surfaces of the adjacent piezoelectric speakers are arranged.
